(19) United States
(12) Patent Application Publication
(10) Pub. No.: US 2011/0052087 A1
(43) Pub. Date: Mar. 3, 2011

(54) METHOD AND SYSTEM FOR CODING IMAGES

(76) Inventor: Debargha Mukherjee, Sunnyvale, CA (US)

(21) Appl. No.: 12/548,735

(22) Filed: Aug. 27, 2009

(51) Int. Cl. G06K 9/36

(52) U.S. Cl. 382/248

(57) ABSTRACT

Embodiments of the present invention are directed to efficient encoding of digital data using combinations of encoding techniques. In certain embodiments of the present invention, images or other data are encoded using both source coding and channel coding. Memoryless-closet-based encoding is used to generate symbol planes, the least significant of which is block-by-block entropy coded, and the remaining of which are channel coded, in their entirety, for each of a number of block classes. A prefix code is used to entropy code least-significant symbol-plane blocks. Coding parameters are obtained by optimization, using statistics collected for each block class, and coded for inclusion in the output bitstream of the encoding methods.

### TECHNICAL FIELD

The present invention is related to data compression and data transmission and, in particular, to efficient encoding of digital data using combinations of encoding techniques.

### BACKGROUND

Data compression has become an increasingly important tool for enabling efficient storage and transmission of digitally encoded data for a variety of purposes, including, for example, servicing a huge market for digitally encoded audio and video data, often stored and distributed on CDs and DVDs, distributed through the Internet for storage within personal computers, and more recently distributed through the Internet for storage on, and rendering by, small, portable, audio-and-video-rendering devices, such as the Apple iPod™. The ability to store hours of recorded music and recorded video on removable media and to transmit recorded audio and video data over the Internet depends on robust and efficient compression techniques that compress huge amounts of digitally encoded information into much smaller amounts of compressed data.

Data compression relies on many different complex and sophisticated mathematical encoding techniques. For example, MPEG-audio compression involves perceptual encoding, Fourier or DCT transforms, and entropy encoding, and MPEG-video encoding involves both spatial and temporal encoding, Fourier and DCT transforms, and entropy encoding. Significant research and development efforts continue to be allocated to improving existing compression techniques and devising new, alternative compression techniques in order to achieve maximum possible reduction in the sizes of compressed files under the constraints of desired levels of fidelity and robustness in decoding and rendering of the compressed digital data. Although many different encoding techniques of various types have been devised, and are well known, robustly implemented, and frequently used, application of the techniques in real problem domains may not provide encoding rates and distortion as low that have been determined to be theoretically possible. Manufacturers, vendors, and users of compressed digital data continue to seek new and improved compression methods that approach theoretically possible and desirable low encoding rates and distortion.

### BRIEF DESCRIPTION OF THE DRAWINGS

FIG. 1 illustrates general digital-data encoding and decoding.

FIG. 2 illustrates spatial encoding of an 8×8 block extracted from a video frame.

FIG. 3 illustrates calculation of the entropy associated with a symbol string and entropy-based encoding of the symbol string.

FIG. 4 illustrates joint and conditional entropies for two different symbol strings generated from two different random variables X and Y.

FIG. 5 illustrates lower-bound transmission rates, in bits per symbol, for encoding and transmitting symbol string Y followed by symbol string X.

FIG. 6 illustrates one possible encoding method for encoding and transmitting symbol string X, once symbol string Y has been transmitted to the decoder.

FIG. 7 illustrates the Slepian-Wolf theorem.

FIG. 8 illustrates the Wyner-Ziv theorem.

FIG. 9 illustrates the random variable X and probability distribution function f_{X}(x).

FIG. 10 illustrates the probability density function f_{Z}(z) for the random variable Z.

FIG. 11 illustrates, using discrete histogram-like representations of the continuous probability density functions, f_{X}(x), f_{Z}(z), f_{Y}(y), and f_{X/Y=0}(x).

FIGS. 12 and 13 illustrate quantization of the continuous transform values represented by sampling random variable X.

FIG. 14 illustrates closet indices corresponding to quantization indices generated by two different closet-index-producing functions.

FIG. 15 illustrates computation of the probability P_{Q}(q=−2) based on the exemplary probability density function f_{X}(x) shown in FIG. 13.

FIG. 16 illustrates computation of the probability P_{C}(0) based on the exemplary probability density function f_{X}(x) shown in FIG. 13 and in FIG. 15.

FIG. 17 illustrates the minimum MSE reconstruction function \hat{X}_{YC}(y, c).

FIG. 18 illustrates five different encoding techniques for which expected rates and expected distortions are derived.

FIGS. 19 and 20 show constant-M rate/distortion curves and constant QP rate/distortion curves for memoryless-closet-based encoding of transform coefficients using the deadzone quantizer discussed above and the circular-modulus-based closet-index-generation function discussed above.

FIGS. 21A-26 illustrate a method for determining the M and QP parameters for memoryless closet encoding that provides coding efficiencies better than those obtained by non-distributed regular encoding with side information.

FIG. 27 is a control-flow diagram illustrating preparation of a lookup table that includes the QPᵢ/Mᵢ, QPᵢ₊₁/Mᵢ₊₁, α values for each target distortion Dₜ or corresponding QP parameter QPₜ for a particular source and noise model.

FIG. 28 is a control-flow diagram for the routine called, in step 2705 of FIG. 27, for constructing a Parental-Optimal set P.

FIG. 29 is a control-flow diagram for the routine, called in step 2706 in FIG. 27, for determining the convex-hull set H.

FIG. 30 is a control-flow diagram for the routine, called in step 2707 in FIG. 27, for producing a lookup table.

FIGS. 31-32 are control-flow diagrams that illustrate a combination-memoryless-closet-based-coding method.

FIG. 33 is a control-flow diagram that generally illustrates a second combination-encoding method for optimally encoding a sequence of samples using existing source-coding and channel-coding techniques.

FIGS. 34-35G illustrate symbol-plane-by-symbol-plane encoding concepts.

FIG. 36 is a control-flow diagram that illustrates a symbol-plane-by-symbol-plane-based combination encoding method.

FIG. 37 illustrates a decoding method corresponding to the encoding method illustrated in FIG. 36.

FIG. 38 shows a modified symbol-plane-by-symbol-plane-based combination-encoding method.

FIG. 39 illustrates the decoding process that corresponds to the encoding process described in FIG. 38.

FIGS. 40A-B show Tables 9 and 10.

FIG. 41 shows rate/distortion curves for ideal distributed coding vs. memoryless coding and practical finite memory coding with source and channel coded planes, for Laplacian source with σₓ=1, and Z Gaussian with σ_{z}=0.5.

FIGS. 42A-B provide a control-flow diagram for a combined-coding routine that represents one embodiment of the present invention.

FIGS. 43-45 illustrate steps 4202-4210 of FIG. 42A.

FIG. 46 shows the decomposition of the quantized transformed-block coefficients Q into corresponding symbol planes Q₀, Q₁, . . . Q_{S-1}.

FIG. 47 illustrates step 4219 of FIG. 42B.

FIG. 48 illustrates channel coding of the non-least-significant symbol planes Q₁, . . . , Q_{S-1}.

FIGS. 49A-B provide control-flow diagrams for a method for decoding an encoded image that presents one embodiment of the present invention.

FIG. 50 illustrates principles of the block closet entropy coder that represents one embodiment of the present invention.

FIG. 51 illustrates additional principals of the block-closet-entropy coder used to code Q₀ closet blocks in step 4219 of FIG. 42B and that represents one embodiment of the present invention.

FIG. 52 provides cyclic-graph, or tree, representations of encodings produced by the routine “CodeTermTree” for values of x when k equals 2 and M=3 and 5, according to one embodiment of the present invention.

### DETAILED DESCRIPTION OF THE INVENTION

The present invention is directed to methods and systems for efficient compression of digitally encoded information. In the following subsections, overviews of coding and coding methods are first provided, to provide a basis for understanding the discussion of embodiments of the present invention provided in a final subsection.

### Data Encoding and Compression, Entropy, and the Slepian-Wolfe and Wyner-Ziv Theorems

### Data Encoding and Decoding

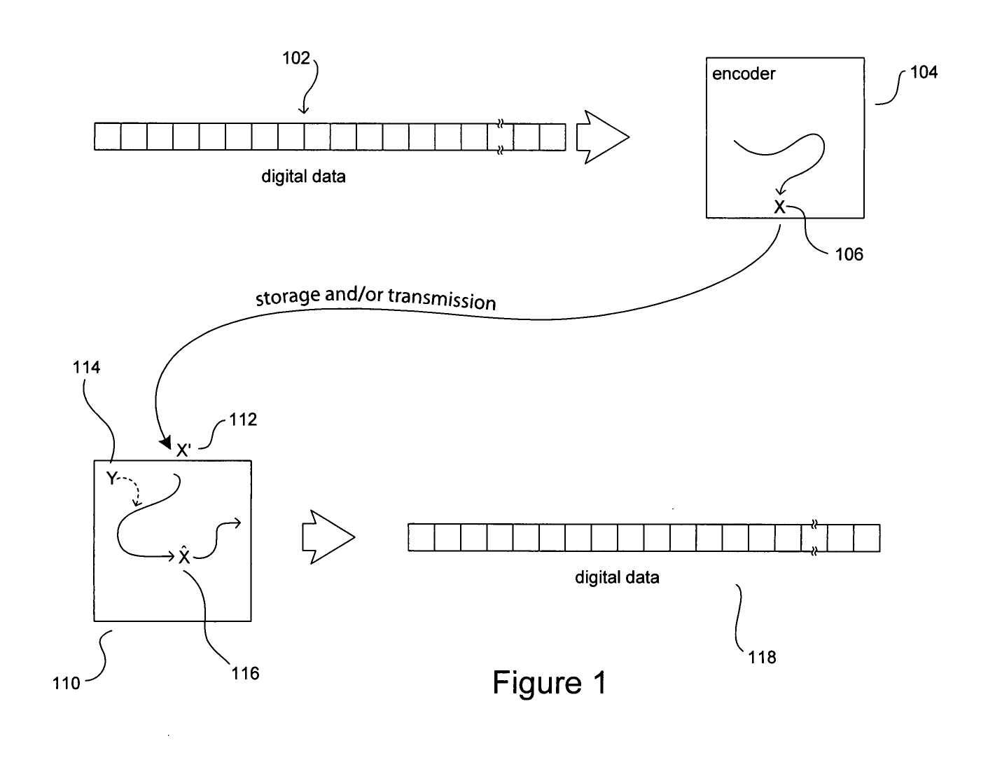

FIG. 1 illustrates general digital-data encoding and decoding. The encoding/decoding process involves an original digital-data sample 102, such as a portion of a digitally encoded image or audio recording. In certain cases, the source data 102 may be initially captured as a digital signal, while in other cases, analog or other non-digital data, such as a photographic image, is first digitally encoded in order to produce the digital source data 102. The source data is then input into an encoder 104 that employs any or a combination of various encoding techniques to produce an encoded signal x 106. The encoded signal x is then stored in, or transmitted through, electronic medium 108 and received from, or extracted from, the electronic medium by a decoder 110 as a received encoded signal x′ 112. In certain cases, x′ may be identical to x, when no errors are introduced into the signal by the storage, transmission, and/or encoding process. In other cases, x′ may differ from x. The decoder uses one or a combination of decoding techniques, and may additionally use side information y 114 related to the source data, error types and frequencies, and other such information, to produce a reconstructed digital signal x 116 that can then be fully decoded to produce a result digital data signal 118 identical to, or differing by less than a threshold difference from, the source digital data signal 102.

Data encoding/decoding may be used for a variety of different purposes. One purpose is for data compression. A relatively large data file may be encoded to produce a much smaller, compressed data file for storage and transmission. When the compressed data is received or used, the compressed data is decoded to produce uncompressed data that is either identical to the original data or differs from the original data by less than a threshold amount. Compression is used, for example, to compress enormous video-data files to smaller, compressed video-data files that can be stored and distributed on storage media such as DVDs. Encoding of digital data for compression purposes can be either lossy or lossless. In lossy compression, information is lost in the compression process, resulting in lower resolution and/or distortion when the compressed data is decompressed in subsequent use. In lossless encoding, decompressed data is theoretically identical to the compressed data. In general, lossy compression provides for greater compression. Source coding techniques are often employed for data compression, such as entropy coding.

Encoding and decoding may also be used in order to achieve robust transmission of data through noisy channels. For this purpose, channel coding techniques, such as linear block coding, is used to add redundant information systematically to the digital signal so that the digital signal can be transmitted through a noisy channel without loss of information or distortion. In these cases, the encoded data may have a greater size than the source data, due to the redundant information systematically included within the source data to allow the source data to be communicated faithfully despite errors introduced into the data by the noisy channel.

In many situations, both source coding and channel coding are employed. For example, in many data transmission environments, it is desirable to both reduce the size of the data transmitted, for efficiency reasons, as well as to introduce systematic redundant data in order to subsequently remove noise introduced during data transmission and data compression. In certain cases, both source coding and channel coding may be used for compression-only purposes. In these cases, the systematically introduced redundant information may be used, alone, as side information by a decoder to allow increased encoding efficiency.

### An Example Compression Method

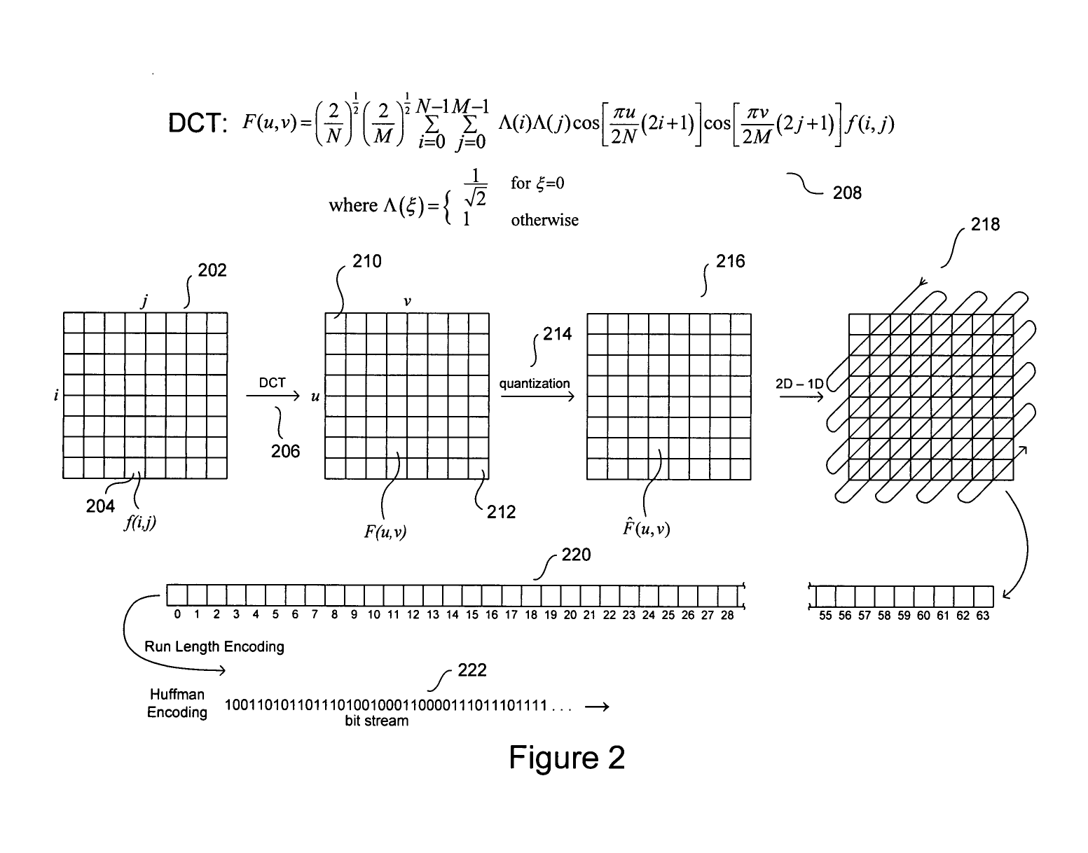

As a specific example of a compression method, the process by which 8×8 blocks of video-frame data are encoded by the MPEG encoding process is next described. FIG. 2 illustrates spatial encoding of an 8×8 block of pixel intensities extracted from a video frame. Each cell or element of the 8×8 block 202, such as cell 204, contains a luminance or chrominance value f(i,j), where i and j are the row and column coordinates, respectively, of the cell. The cell is transformed 206, in many cases using a discrete cosign transform (“DCT”), from the spatial domain represented by the array of intensity values f(i,j) to the frequency domain, represented by a two-dimensional 8×8 array of frequency-domain coefficients F(u, v). An expression for an exemplary DCT 208 is shown at the top of FIG. 2. The coefficients in the frequency domain indicate spatial periodicities in the vertical, horizontal, and both vertical and horizontal directions within the spatial domain. The F_{(0,0)} coefficient 210 is referred to as the “DC” coefficient, and has a value proportional to the average intensity within the 8×8 spatial-domain block 202. The periodicities represented by the frequency-domain coefficients increase in frequency from the lowest-frequency coefficient 210 to the highest-frequency coefficient 212 along the diagonal interconnecting the DC coefficient 210 with the highest-frequency coefficient 212.

Next, the frequency-domain coefficients are quantized 214 to produce an 8×8 block of quantized frequency-domain coefficients 216. Because lower-frequency coefficients generally have larger magnitudes, and generally contribute more to a perceived image than higher-frequency coefficients, the result of quantization is that many of the higher-frequency quantized coefficients, in the lower right-hand triangular portion of the quantized-coefficient block 216, are forced to zero. Next, the block of quantized coefficients 218 is traversed, in zig-zig fashion, to create a one-dimensional vector of quantized coefficients 220. The one-dimensional vector of quantized coefficients is then encoded using various entropy-encoding techniques, generally run-length encoding followed by Huffman encoding, to produce a compressed bit stream 222. Entropy-encoding techniques take advantage of a non-uniform distribution of the frequency of occurrence of symbols within a symbol stream to compress the symbol stream. A final portion of the one-dimensional quantized-coefficient vector 220 with highest indices often contains only zero values. Run-length encoding can represent a long, consecutive sequence of zero values by a single occurrence of the value “0” and the length of the subsequence of zero values. Huffman encoding uses varying-bit-length encodings of symbols, with shorter-length encodings representing more frequently occurring symbols, in order to compress a symbol string.

### Brief Introduction to Certain Concepts in Information Science and Coding Theory and the Slepian-Wolf and Wyner-Ziv Theorems

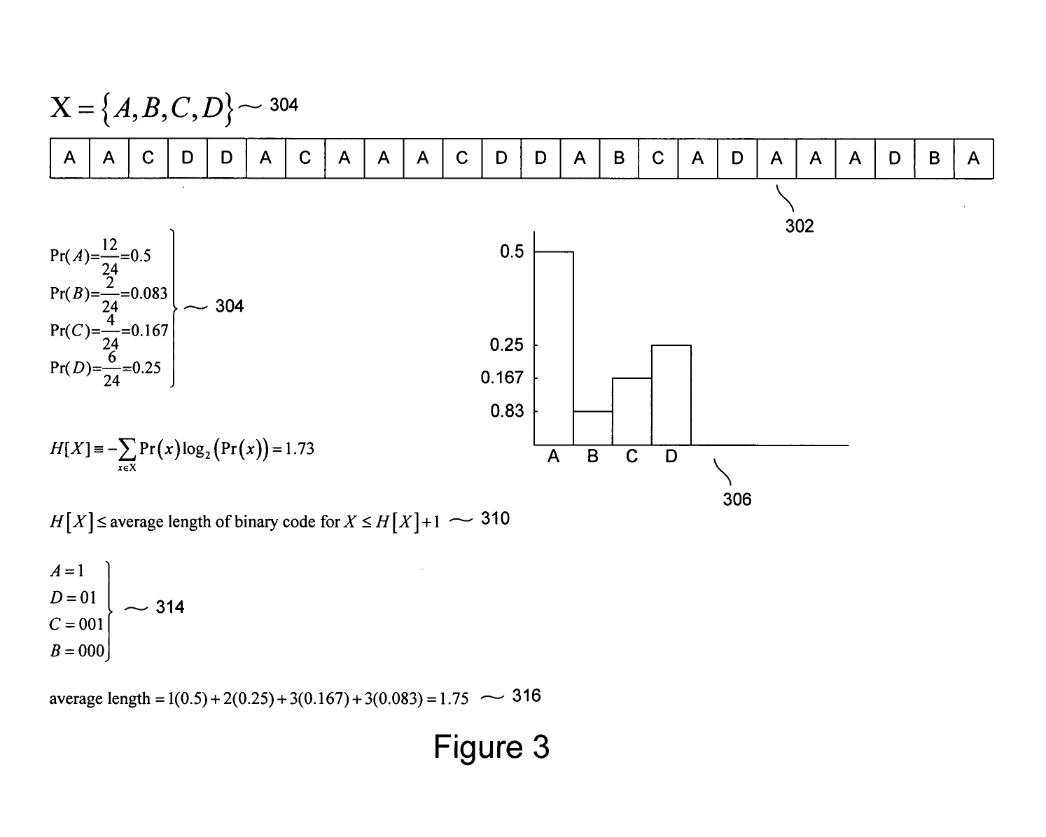

Next, entropy, conditional entropy, and the Slepian-Wolfe and Wyner-Ziv theorems are discussed. FIG. 3 illustrates calculation of the entropy associated with a symbol string and entropy-based encoding of the symbol string. In FIG. 3, a 24-symbol string 302 is shown. The symbols in the 24-symbol string are selected from the set of symbols X that include the symbols A, B, C, and D 304. The probability of occurrence of each of the four different symbols at a given location within the symbol string 302, considering the symbol string to be the product of sampling of a random variable X that can have, at a given point in time, one of the four values A, B, C, and D, can be inferred from the frequencies of occurrence of the four symbols in the symbol string 302, as shown in equations 304. A histogram 306 of the frequency of occurrence of the four symbols is also shown in FIG. 3. The entropy of the symbol string, or of the random variable X used to generate the symbol string, is computed as:

$$H [ X ] ≡ - {\sum }_{x ∈ X} Pr ( x ) {log}_{2} ( Pr ( x ) )$$

The entropy His always positive, and, in calculating entropies, log₂(0) is defined as 0. The entropy of the 24-character symbol string can be calculated from the probabilities of occurrence of symbols 304 to be 1.73. The smaller the entropy, the greater the predictability of the outcome of sampling the random variable X For example, if the probabilities of obtaining each of the four symbols A, B, C, and D in sampling the random variable X are equal, and each is therefore equal to 0.25, then the entropy for the random variable X, or for a symbol string generated by repeatedly sampling the random variable X, is 2.0. Conversely, if the random variable were to always produce the value A, and the symbol string contained only the symbol A, then the probability of obtaining A from sampling the random variable would equal 1.0, and the probability of obtaining any of the other values B, C, D would be 0.0. The entropy of the random variable, or of an all-A-containing symbol string, is calculated by the above-discussed expression for entropy to be 0. An entropy of zero indicates no uncertainty.

Intermediate values of the entropy between 0 and 2.0, for the above considered 4-symbol random variable of symbol string, also referred to as string X, correspond to a range of increasing uncertainty. For example, in the symbol-occurrence distribution illustrated in the histrogram 306 and the probability equations 304, one can infer that it is as likely that a sampling of the random variable X returns symbol A as any of the other three symbols B, C, and D. Because of the non-uniform distribution of symbol-occurrence frequencies within the symbol string, there is a greater likelihood of any particular symbol in the symbol string to have the value A than any one of the remaining three values B, C, D. Similarly, there is a greater likelihood of any particular symbol within the symbol string to have the value D than either of the two values B and C. This intermediate certainty, or knowledge gleaned from the non-uniform distribution of symbol occurrences, is reflected in the intermediate value of the entropy H[X] for the symbol string 302.

The entropy of a random variable or symbol string is associated with a variety of different phenomena. For example, as shown in the formula 310 in FIG. 3, the average length of the binary code needed to encode samplings of the random variable X, or to encode symbols of the symbol string 302, is greater than or equal to the entropy for the random variable or symbol string and less than or equal to the entropy for the random variable or symbol string plus one. Huffman encoding of the four symbols 314 produces an encoded version of the symbol string with an average number of bits per symbol, or rate, equal to 1.75 316, which falls within the range specified by expression 310.

One can calculate the probability of generating any particular n-symbol symbol string with the symbol-occurrence frequencies of the symbol string shown in FIG. 3 as follows:

$$\begin{matrix}Pr ( {S}_{n} ) = {Pr ( A )}^{nPr ( A )} {Pr ( A )}^{nPr ( B )} {Pr ( A )}^{nPr ( C )} {Pr ( A )}^{nPr ( D )} \\ = {{{[ {2}^{{log}_{2} Pr ( A )} ]}^{nPr ( A )} [ {2}^{{log}_{2} Pr ( B )} ]}^{nPr ( B )} [ {2}^{{log}_{2} Pr ( C )} ]}^{nPr ( C )} \\ {[ {2}^{{log}_{2} PR ( D )} ]}^{nPr ( D )} \\ = {2}^{n [ Pr ( A ) {log}_{2} Pr ( A ) + Pr ( B ) {log}_{2} Pr ( B ) + Pr ( C ) {log}_{2} Pr ( C ) + Pr ( D ) {log}_{2} Pr ( D ) ]} \\ = {2}^{- nH [ X ]}\end{matrix}$$

Thus, the number of typical symbol strings, or symbol strings having the symbol-occurrence frequencies shown in FIG. 3, where n=24, can be computed as:

$$\frac{1}{{2}^{- 24 ( 1.73 )}} = \frac{1}{3.171 \times {10}^{- 13}} = 3.153 \times {10}^{12}$$

If one were to assign a unique binary integer value to each of these typical strings, the minimum number of bits needed to express the largest of these numeric values can be computed as:

log₂(3.153×10¹²)=41.521

The average number of bits needed to encode each character of each of these typical symbol strings would therefore be:

$$\frac{41.521}{24} = 1.73 = H [ X ]$$

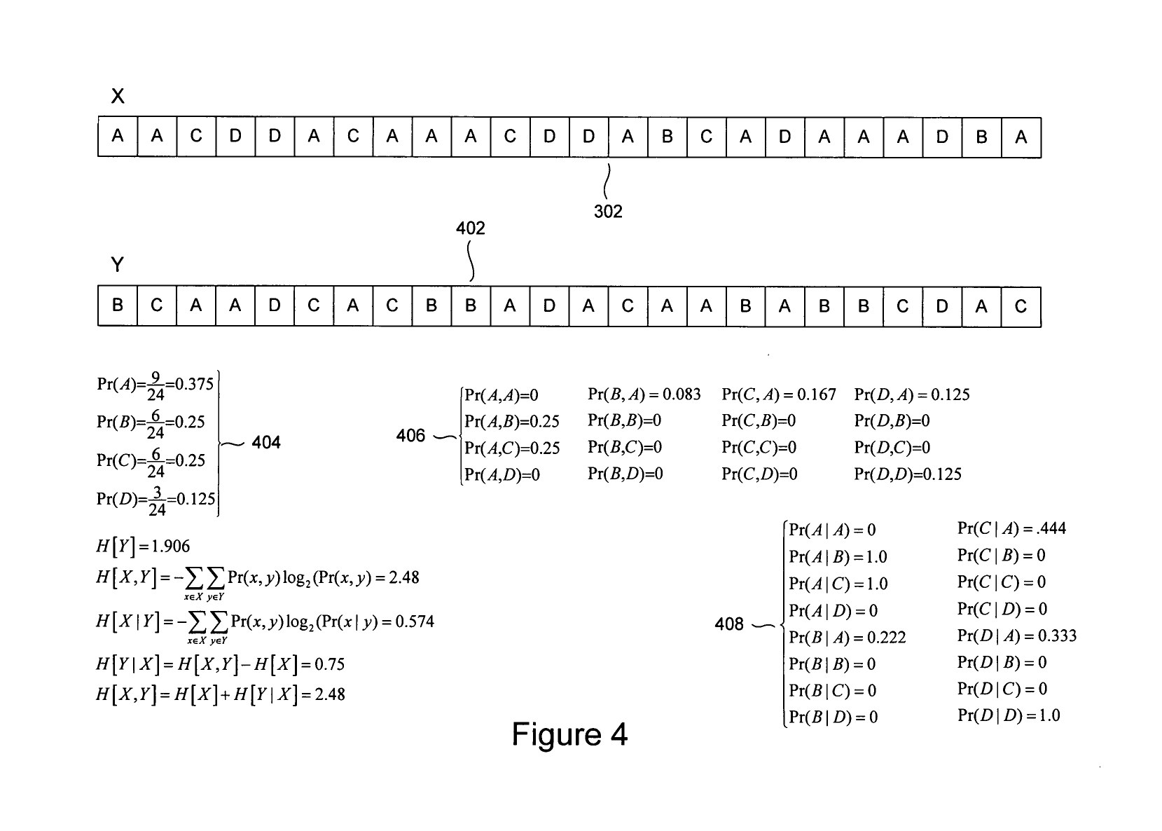

FIG. 4 illustrates joint and conditional entropies for two different symbol strings generated from two different random variables X and Y. In FIG. 4, symbol string 302 from FIG. 3 is shown paired with symbol string 402, also of length 24, generated by sampling a random variable Y that returns one of symbols A, B, C, and D. The probabilities of the occurrence of symbols A, B, C, and D in a given location within symbol string Y are computed in equations 404 in FIG. 4. Joint probabilities for the occurrence of symbols at the same position within symbol string X and symbol string Y are computed in the set of equations 406 in FIG. 4, and conditional probabilities for the occurrence of symbols at a particular position within symbol string X, given that the fact that a particular symbol occurs at the corresponding position in symbol string Y, are known in equations 408. The entropy for symbol string Y, H[Y], can be computed from the frequencies of symbol occurrence in string Y 404 as 1.906. The joint entropy for symbol strings X and Y, H[X,Y], is defined as:

$$H [ X , Y ] = - {\sum }_{x ∈ X} {\sum }_{y ∈ Y} Pr ( x , y ) {log}_{2} ( Pr ( x , y ) )$$

and, using the joint probability values 406 in FIG. 4, can be computed to have the value 2.48 for the strings X and Y. The conditional entropy of symbol string X, given symbol string Y, H[X\Y] is defined as:

$$H [ X \vert Y ] = - {\sum }_{x ∈ X} {\sum }_{y ∈ Y} Pr ( x , y ) {log}_{2} ( Pr ( x \vert y ) )$$

and can be computed using the joint probabilities 406 in FIG. 4 and conditional probabilities 408 in FIG. 4 to have the value 0.574. The conditional probability H[Y\X] can be computed from the joint entropy and previously computed entropy of symbol string X as follows:

H[Y|X]=H[X,Y]−H[X]

and, using the previously calculated values for H[X,Y] and H[X], can be computed to be 0.75.

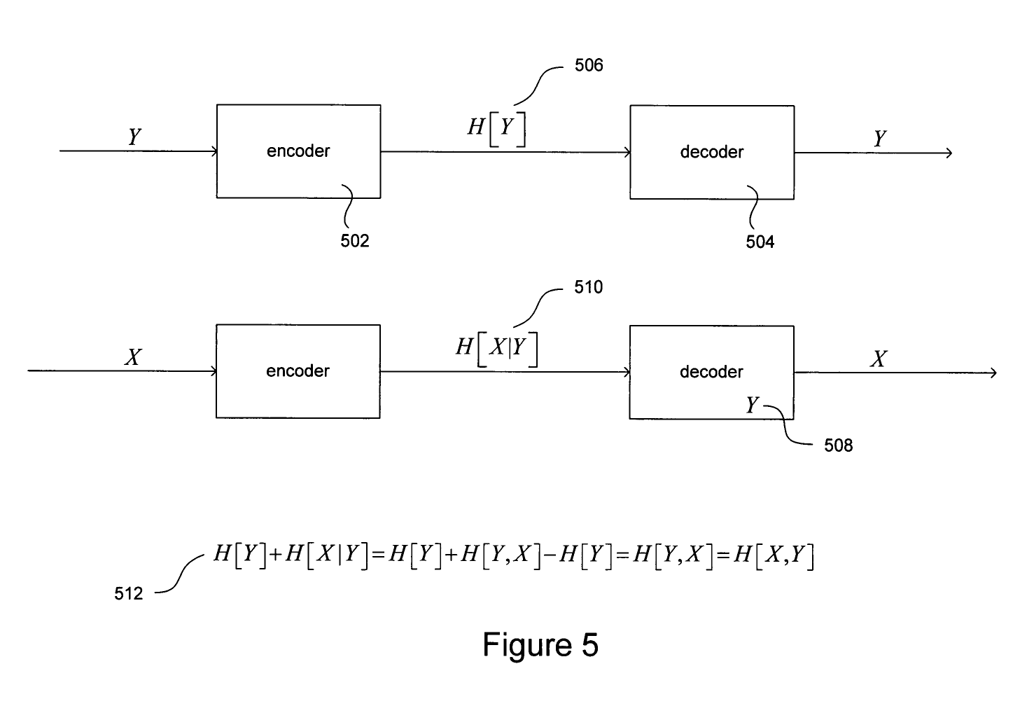

FIG. 5 illustrates lower-bound transmission rates, in bits per symbol, for encoding and transmitting symbol string Y followed by symbol string X. Symbol string Y can be theoretically encoded by an encoder 502 and transmitted to a decoder 504 for perfect, lossless reconstruction at a bit/symbol rate of H[Y] 506. If the decoder keeps a copy of symbol string Y 508, then symbol string X can theoretically be encoded and transmitted to the decoder with a rate 510 equal to H[X|Y]. The total rate for encoding and transmission of first symbol string Y and then symbol string X is then:

H[Y]+H[X|Y]=H[Y]+H[Y,X]−H[Y]=H[Y,X]=H[X,Y]

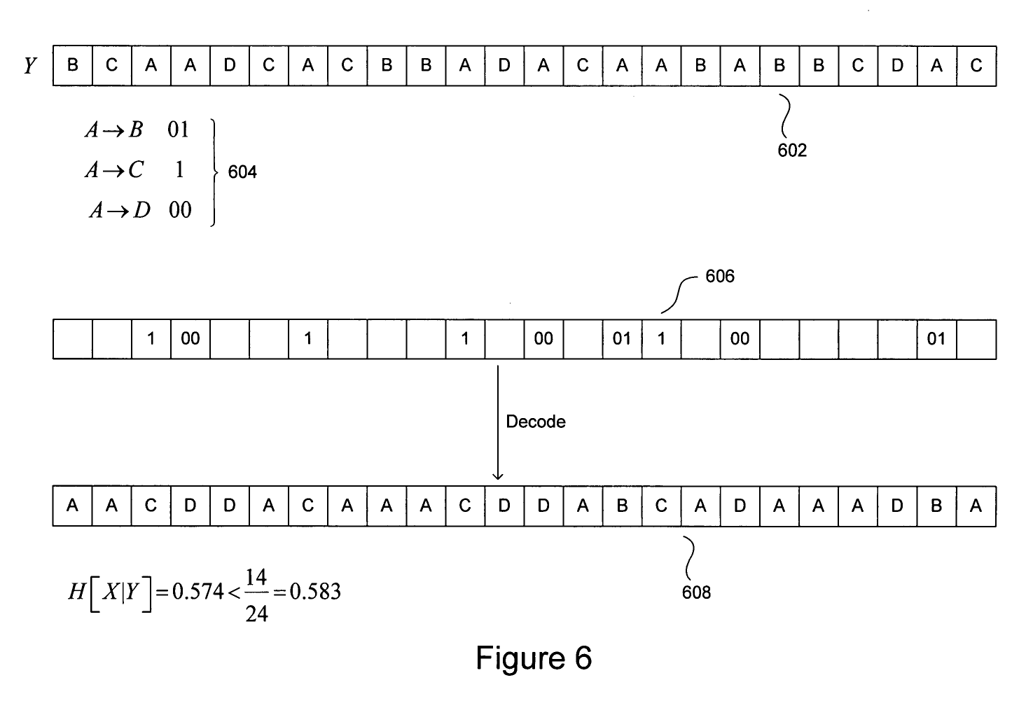

FIG. 6 illustrates one possible encoding method for encoding and transmitting symbol string X, once symbol string Y has been transmitted to the decoder. As can be gleaned by inspection of the conditional probabilities 408 in FIG. 4, or by comparing the aligned symbol strings X and Y in FIG. 4, symbols B, C, and D in symbol string Y can be translated, with certainty, to symbols A, A, and D, respectively, in corresponding positions in symbol string X. Thus, with symbol string Y in hand, the only uncertainty in translating symbol string Y to symbol string X is with respect to the occurrence of symbol A in symbol string Y. One can devise a Huffman encoding for the three translations 604 and encode symbol string X by using the Huffman encodings for each occurrence of the symbol A in symbol string Y. This encoding of symbol string X is shown in the sparse array 606 in FIG. 6. With symbol string Y 602 in memory, and receiving the 14 bits used to encode symbol string X 606 according to Huffman encoding of the symbol A translations 604, symbol string X can be faithfully and losslessly decoded from symbol string Y and the 14-bit encoding of symbol string X 606 to obtain symbol string X 608. Fourteen bits used to encode 24 symbols represents a rate of 0.583 bits per symbol, which is slightly greater than the theoretical minimum bit rate H[X\Y]=0.574. However, while theoretical minimum bit rates are useful to understand the theoretical limits for encoding efficiency, they do not generally provide indications of how the theoretical limits may be achieved. Also, a variety of assumptions are made in developing the theorems that cannot be made in real-world situations.

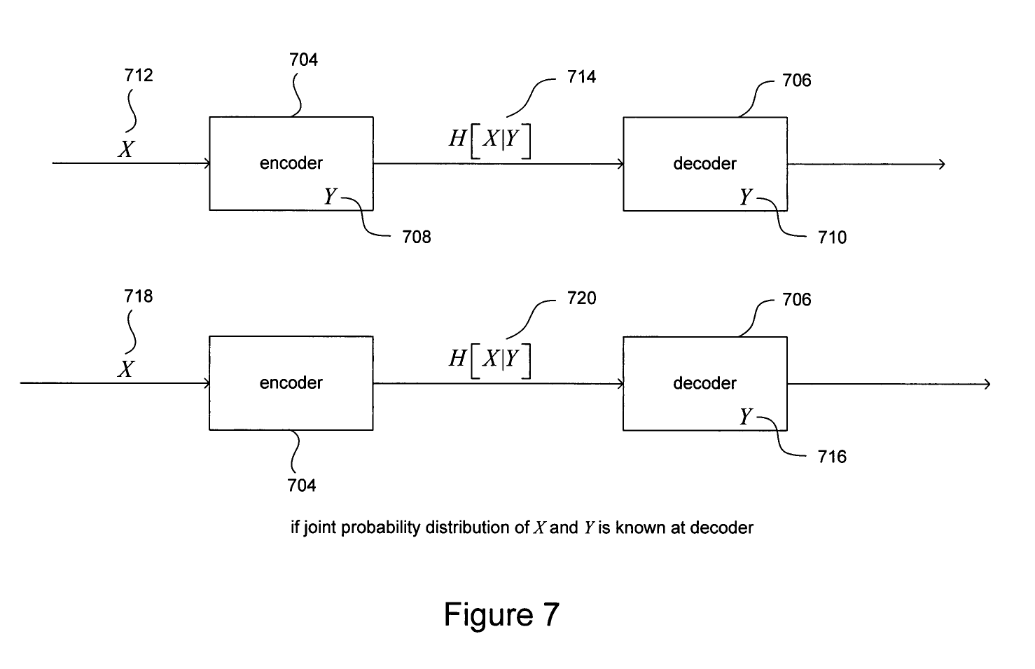

FIG. 7 illustrates the Slepian-Wolf theorem. As discussed with reference to FIGS. 5 and 6, if both the encoder and decoder of an encoder/decoder pair maintain symbol string Y in memory 708 and 710 respectively, then symbol string X 712 can be encoded and losslessly transmitted by the encoder 704 to the decoder 706 at a bit-per-symbol rate of greater than or equal to the conditional entropy H[X\Y] 714. Slepian and Wolf showed that, if the joint probability distribution of symbols in symbol strings X and Y is known at the decoder, but only the decoder has access to symbol string Y 716 then, nonetheless, symbol string X 718 can be encoded and transmitted by the encoder 704 to the decoder 706 at a bit rate of H[X\Y] 720. In other words, when the decoder has access to side information, in the current example represented by symbol string Y, and knows the joint probability distribution of the symbol string to be encoded and transmitted and the side information, the symbol string can be transmitted at a bit rate equal to H[X\Y].

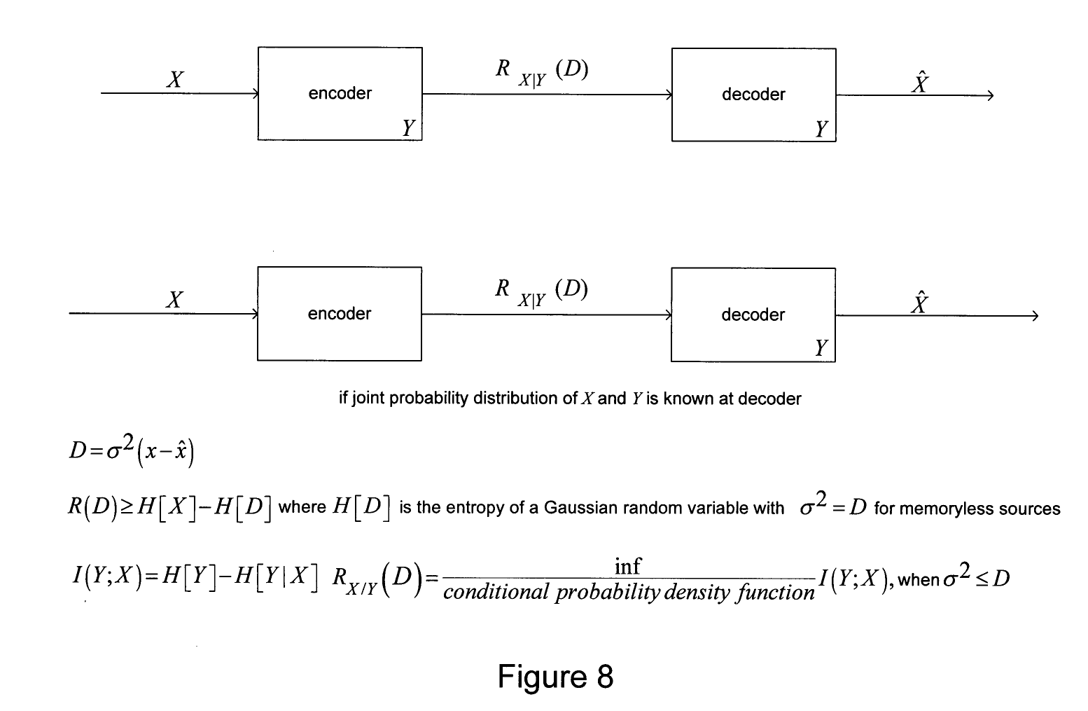

FIG. 8 illustrates the Wyner-Ziv theorem. The Wyner-Ziv theorem relates to lossy compression/decompression, rather than lossless compression/decompression. However, as shown in FIG. 8, the Wyner-Ziv theorem is similar to the Slepian-Wolf theorem, except that the bit rate that represents the lower bound for lossy encoding and transmission is the conditional rate-distortion function R_{X|Y}(D) which is computed by a minimization algorithm as the minimum bit rate for transmission with lossy compression/decompression resulting in generating a distortion less than or equal to the threshold value D, where the distortion is defined as the variance of the difference between the original symbol string, or signal X, and the noisy, reconstructed symbol string or signal \hat{X}:

$$D = {σ}^{2} ( x - \hat{x} )$$

$$I ( Y ; X ) = H [ Y ] - H [ Y \vert X ]$$

$${R}_{X \vert Y} ( D ) = \frac{inf}{conditional probability density function} I ( Y ; X ) , \\ when {σ}^{2} \leq D$$

This bit rate can be achieved even when the encoder cannot access the side information Y if the decoder can both access the side information Y and knows the joint probability distribution of X and Y. There are few closed-form expressions for the rate-distortion function, but when memoryless, Gaussian-distributed sources are considered, then the rate distortion has a lower bound:

R(D)≧H[X]−H[D]

where H[D] is the entropy of a Gaussian random variable with σ²≦D.

Thus, efficient compression can be obtained by the method of source coding with side information when the correlated side information is available to the decoder, along with knowledge of the joint probability distribution of the side information and encoded signal. As seen in the above examples, the values of the conditional entropy H[X\Y] and conditional rate-distortion function R_{X|Y}(D) is significantly smaller than H[X] and R_{X}(D), respectively, when X and Y are correlated.

Computation of Expected Rates and Expected Distortions for Various Encoding Techniques

### Source and Side-Information Modeling and Quantization

A specific problem domain to which coding techniques are applied is that of coding transform-domain coefficients, such as the DCT coefficients discussed in the previous subsection, for compression purposes. Transform coefficients can be modeled by Laplacian-type distributions with variances σₓ² and the side information Y available to the decoder and, optionally to the encoder, can be modeled by independently and identically distributed Gaussian-type distributions with variances σ_{z}². For purposes of modeling and discussion, the source data, comprising a set of transform coefficients, is modeled as a Laplacian random variable X with variance σₓ² and the side information available at the decoder and, optionally, at the encoder, is modeled as a random variable Y, where Y=X+Z and Z is i.i.d. Gaussian with variance σ_{z}². In this discussion, the probability density function of X is referred to as f_{X}(x) and the probability density function of Z as f_{Z}(z).

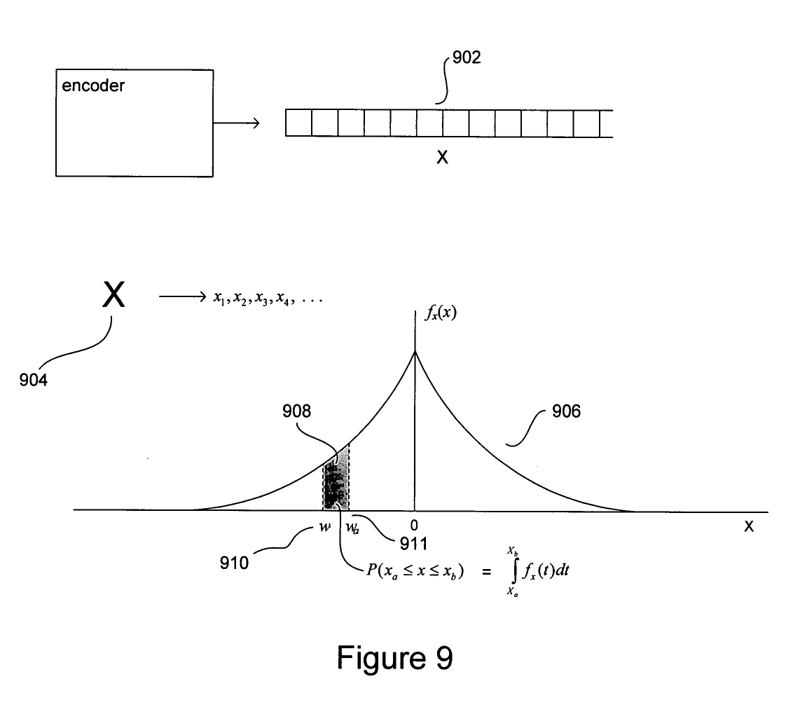

FIG. 9 illustrates the random variable X and probability distribution function f_{X}(x). As shown in FIG. 9, as part of the encoding process, an encoder produces an ordered sequence of transform coefficients X 902. The sequence of the transform coefficients can be modeled as a repeated sampling of the random variable X 904. The random variable X is associated with a probability density function f_{X}(x) 906. The probability density function is a continuous function of the values x that are produced by random variable X, with the probability of a next sample produced by random variable X being within a range of values xₐ to x_{b}, P(xₐ≦x≦x_{b}), is equal to the area under the probability density function curve 908 between x values xₐ 910 and x_{b} 911, computed as:

$${\int }_{{X}_{a}}^{{X}_{b}} {f}_{x} ( t ) d t$$

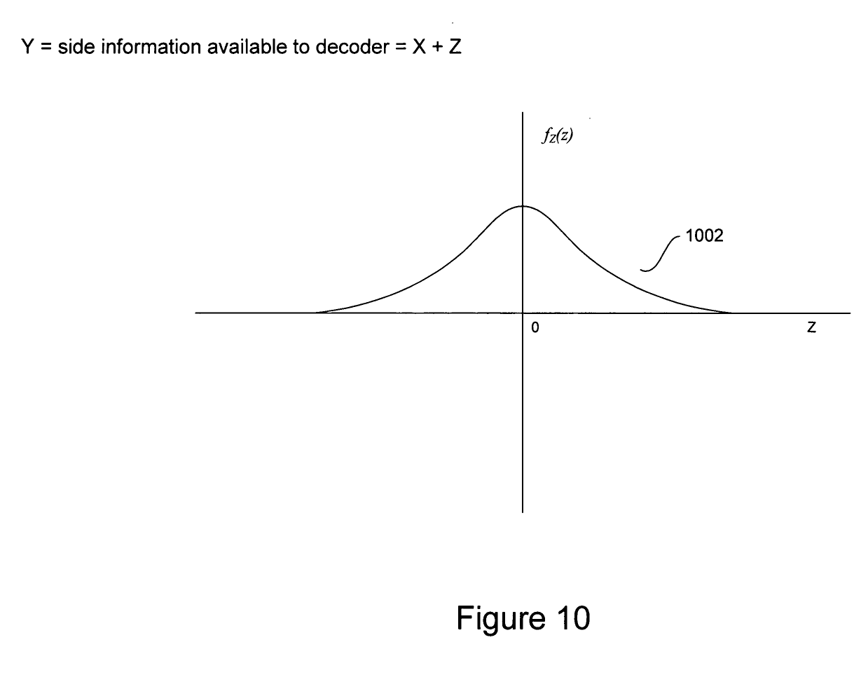

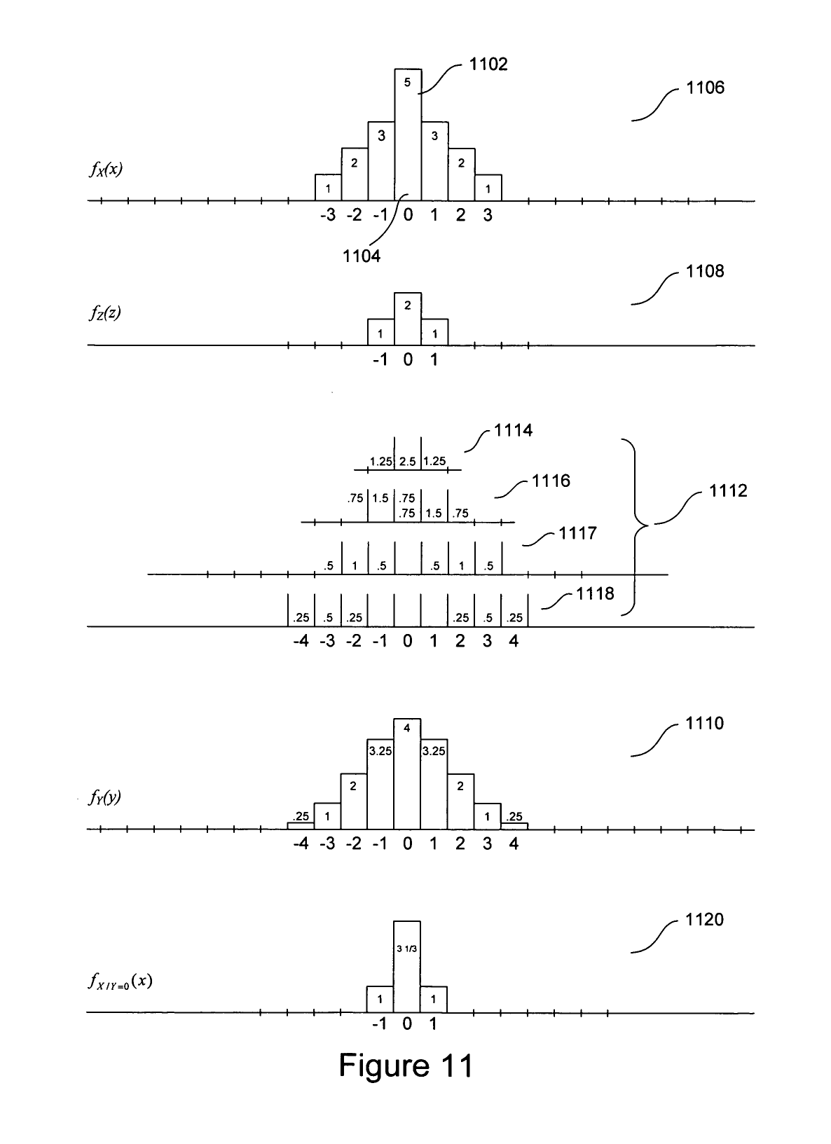

FIG. 10 illustrates the probability density function f_{Z}(z) for the random variable Z. The probability density function f_{Z}(z) 1002 is Gaussian. FIG. 11 illustrates, using discrete histogram-like representations of the continuous probability density functions, f_{X}(x), f_{Z}(z), f_{Y}(y), and f_{X/Y=0}(x). In FIG. 11, the areas of each vertical bar of the histogram are noted within the vertical bars, such as the area 5 1102 within the vertical bar 1104 of the histogram discretely representing f_{X}(x). The discrete representation of the total area under the probability density function curves is therefore the sum of all of the areas of the vertical bars, 17 in the case of f_{X}(x) and f_{Y}(y). In general, a probability density function is normalized, so that the area underneath the curve is 1.0, corresponding to a probability of 1.0 that some value of x within the range of X is obtained by each sampling. However, in the current examples, areas of histogram bars or sections below the probability density function are illustrated with whole integer values. Thus, in the case of the discrete representation of the probability density function f_{X}(x) 1106, the probability that a next sampling of random variable X will produce the value “0,” P(X=0), is 5/17. In the example shown in FIG. 11, the random variable X can produce values in the range {−3,−2, . . . , 3}. The discrete representation of the probability density function for random variable Z 1108 indicates that, for half of the samples of X, no noise is introduced, for one-quarter of the samples of X, noise of value “1” is introduced, and for one-quarter of the samples of X, noise of value “−1 is introduced. The probability density function for side information Y 1110 can be obtained by convolving f_{X}(x) with f_{Z}(z). This process is illustrated in the four steps 1112 shown in FIG. 11. In a first step 114, f_{Z}(z) is applied to the vertical histogram bar 1104 of the discrete representation of f_{X}(x) to produce the three values “1.25,” “2.5,” and “1.25.” Thus, if a sample of random variable X produces the value “0,” then, following introduction of noise via random variable Z, the resulting value y will be 0 one-half the time, −1 one-quarter of the time, and 1 one-quarter of the time. Since the value “0” is produced with the probability of 5/17 by sampling X, the value “0” obtained by sampling random variable X results in a value “0” obtained by sampling Y with a probability of 2.5/17. In successive steps 116-118, f_{Z}(z) is applied to x values −1 and 1, −2 and 2, and −3 and 3, respectively. Summing all of the values produced in these steps produces the discrete representation of the probability density function for side information Y 1110. Thus, a next sample of random variable Y produces the value “0” with a probability of 4/17. Finally, a discrete approximation of the probability density function f_{x/y=0}(x) 1120 is shown, which indicates the probabilities that, when random variable Y is sampled to produce value “0,” the corresponding value of x is “−1,” “0,” or “1.” Thus, if the sample value of Y is “0,” then the probability that the corresponding value of X is “0” is 3.333/5.333. Similar conditional probability density functions for each possible value of Y can be computed.

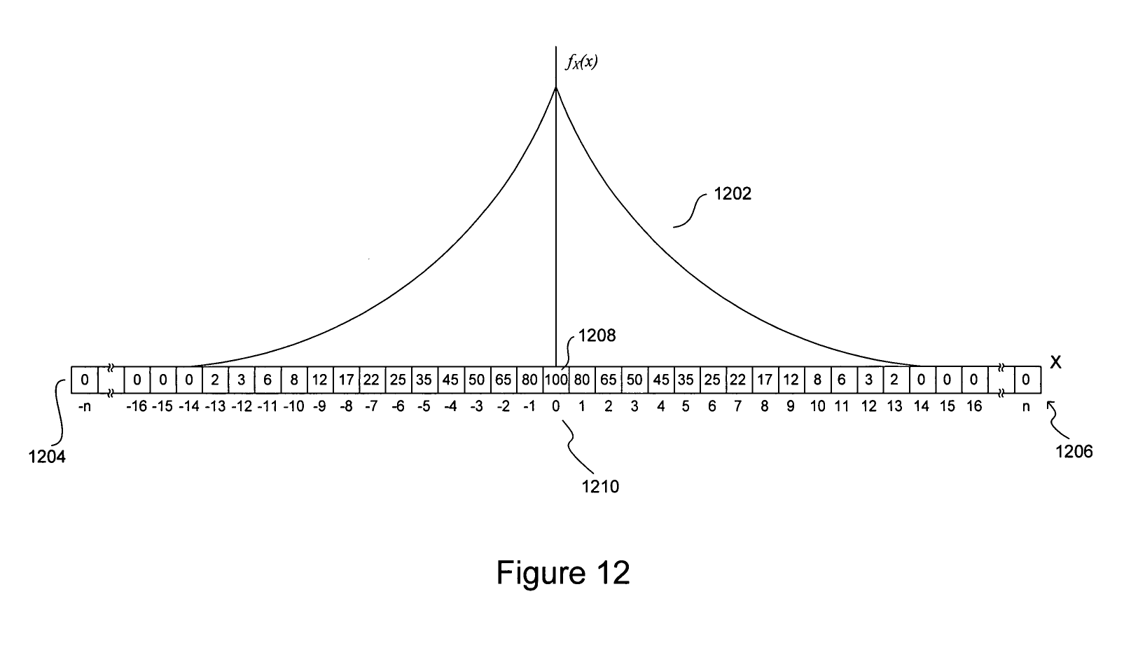

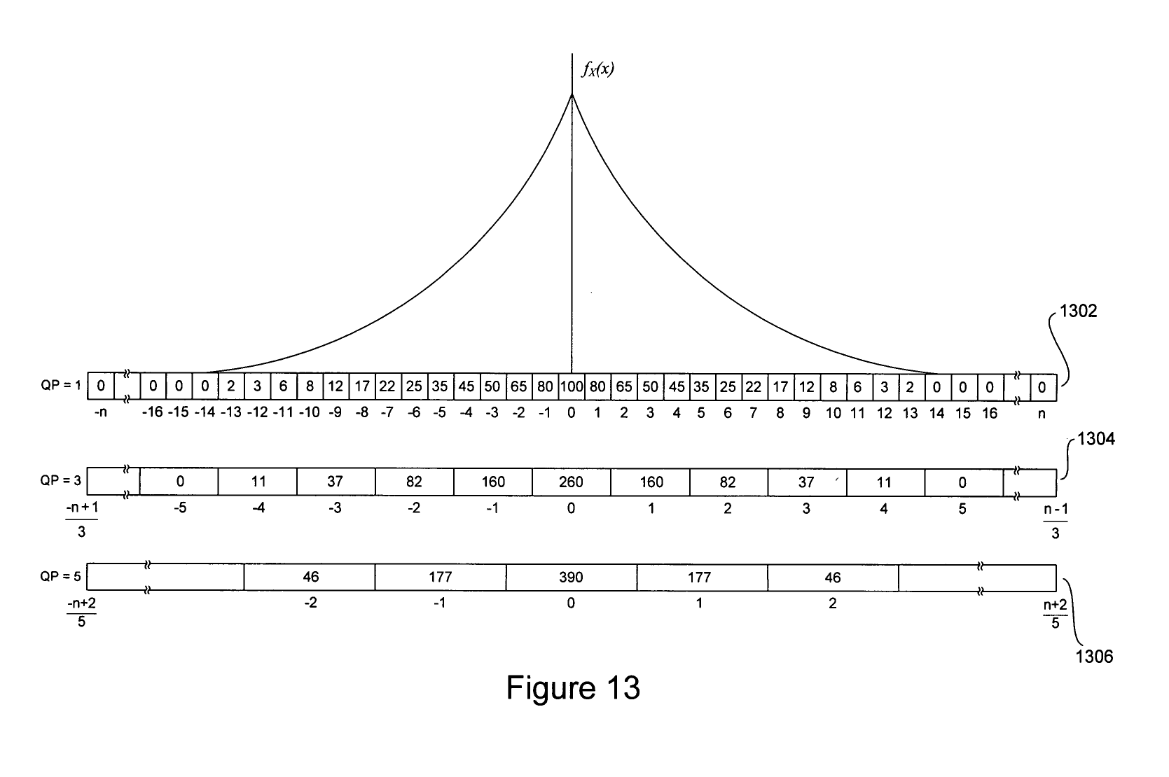

FIGS. 12 and 13 illustrate quantization of the continuous transform values represented by sampling random variable X. In FIG. 12, the continuous probability density function f_{X}(x) 1202 is plotted as a continuous function of X. Below the x axis, a series of bins 1204 are constructed, each bin labeled by an x value 1206. Thus, for example, the central bin 1208 is labeled by the x value “0” 1210. This sequence of bins represents a quantization of the continuous function f_{X}(x). The dimensions of the bins, and the bin indices, are obtained by the quantization function

Q=φ(X ,QP)=round (X/QP)

where QP=1.

Thus, bin 1208 represents the values −0.5 through 0.5, and the number “100” within bin 1208 indicates the area of the column above bin 1208 and below the continuous probability density function f_{X}(x), where, again,=normalized areas are used so that whole-integer values, rather than fractional values, can be used. FIG. 13 illustrates three different quantizations of the probability density function f_{X}(x) generated by the three different values of QP “1,” “3,” and “5.” The first quantization 1302 is the same as that shown in FIG. 12. The second quantization 1304 is obtained using the quantization parameter QP=3, and the third quantization 1306 is obtained by using the quantization parameter QP=5. As the value of QP increases, the sizes of the quantization bins increase, and the resolution of quantization decreases. Thus, for example, a quantization value of “0” in the QP=5 corresponds to a value of X between −2.5 and 2.5. As quantization-bin size increases, the resolution of the representation of transform coefficients by quantization indices decreases, but the range of quantization indices also decreases, allowing each quantization index to be represented by a smaller number of bits. Alternatively, quantization may be carried out using the uniform quantizer with deadzone, as follows:

Q=φ(X, QP)=sign(X)└|X|/QP┘

Note that the quantization index values produced by a quantizer Q would be assumed to take on the integer values {−∞, . . . , −1,0,1, . . . , ∞}, since the probability density function is computed for values of x ranging from −∞ to +∞. However, in practice, the possible quantization values for a particular quantizer Q, Ω_{Q}, can be assumed to range over the values {−qₘₐₓ, −qₘₐₓ₊₁, . . . , −1,0,1, . . . , qₘₐₓ −1, qₘₐₓ}, where qₘₐₓ is large enough that the probability of the Laplacian source x producing positive and negative values that generate quantization indices with absolute values greater than qₘₐₓ is negligible. One problem addressed by various coding methods is to determine an encoding of X based on a given quantizer and given variances {σₓ², σ_{z}²} for a Laplacian X and Gaussian Z and a target maximum distortion Dₜ in order to minimize the encoding rate, expressed as the number of bits per symbol employed to encode each of the symbols of a source represented as a repeated sampling of random variable X.

### Memoryless-Closet-Based Encoding

In many cases of data encoding with side information, it may be undesirable to use channel codes, either because of time constraints on decoding, or because of insufficiently large sample sizes to allow channel-coding efficiencies to be obtained. In these cases, memoryless closet codes may be used. Memoryless closet codes can be generated using various different circular modulus functions, including the circular modulus function mod_{c}(I, J)=I−└I/J┘, which takes two integers I and J as arguments and produces result values in the set {0, 1, . . . , J−1}. Alternatively, a zero-centered circular modulus function, mod_{cz}, can be employed:

$${mod}_{cz} ( I , J ) = \{ \begin{matrix}{mod}_{c} ( I , J ) , & {mod}_{c} ( I , J ) < J / 2 \\ {mod}_{c} ( I , J ) - J , & {mod}_{c} ( I , J ) \geq J / 2\end{matrix}$$

The zero-centered circular modulus function produces values within the set {└−(J−1)/2∃, . . . , −1, 0, 1, . . . , └(J−1)/2┘}. The memoryless closet codes employ a quantizer Φ to quantize the transform coefficients, represented by sampling of random variable X, using a quantization parameter QP and then compute cosets corresponding to the quantization indices, represented as sampling of a closet-index random variable C

C:C=ψ(Q, M)=ψ(Φ(X, QP), M)

where M is the closet modulus, or J in the above definitions of the circular modulus functions, by:

C=ψ(Q, M)=mod_{c}(Q, M).

Sampling of random variable C generates values in the set Ω_{c}={0, 1, . . . , M−1}. The zero-centered variant of the circular modulus function can also be used:

C=ψ(Q, M)=mod_{cz}(Q, M)

where C produces values from the set

Ω_{c}={└−(M−1)/2┘, . . . , −1, 0, 1, . . . , └(M−1)/2┘}

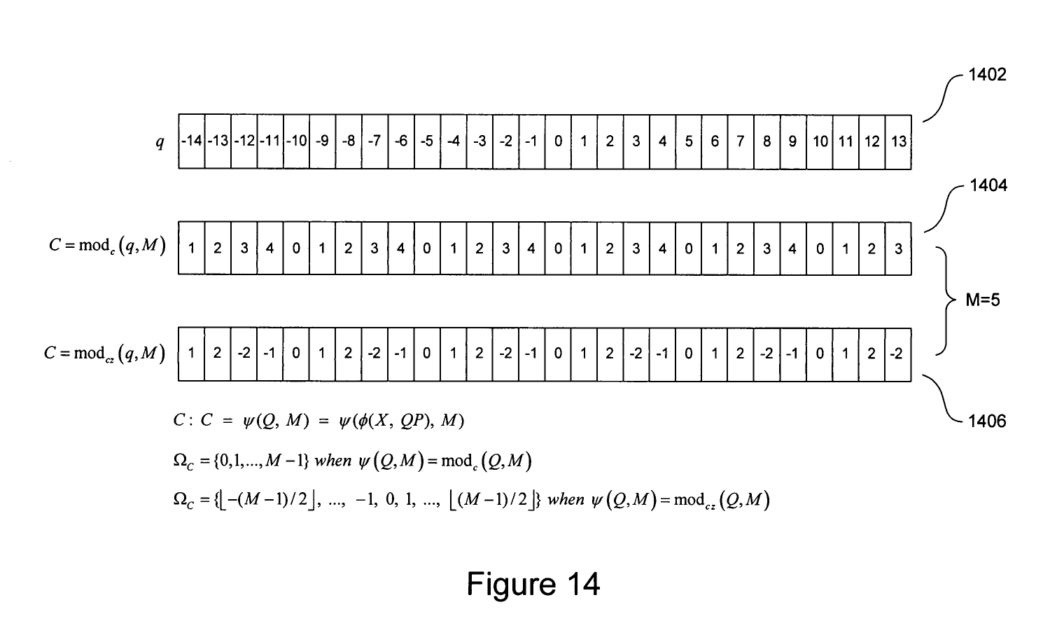

FIG. 14 illustrates closet indices corresponding to quantization indices generated by two different closet-index-producing functions. In FIG. 14, an ordered sequence of possible quantization values is shown 1402 in register with corresponding closet indiced 1404 and 1406 produced by the circular modulus functions mod_{c} and mod_{cz}, respectively. When the quantization index a corresponds to a quantization bin spanning the x-value interval [xₗ(q), xₕ(q)], then the probability of obtaining a closet index c ∈ Ω_{c} from sampling the random variable C can be obtained as:

$${p}_{Q} ( q ) = {\int }_{{x}_{l} ( q )}^{{x}_{h} ( q )} {f}_{X} ( x ) d x$$

$${p}_{C} ( c ) = {\sum }_{q ∈ {Ω}_{Q} : ψ ( q , M ) = c} {p}_{Q} ( q ) = {\sum }_{q ∈ {Ω}_{Q} : ψ ( q , M ) = c} {\int }_{{x}_{l} ( q )}^{{x}_{h} ( q )} {f}_{X} ( x ) d x$$

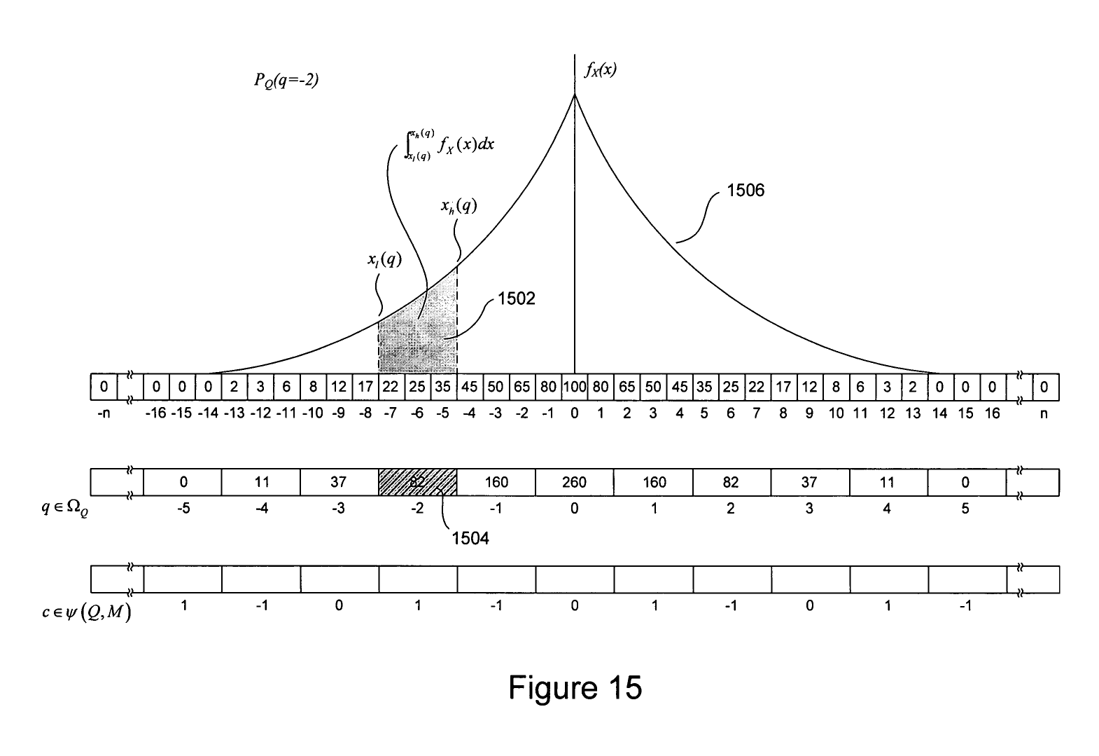

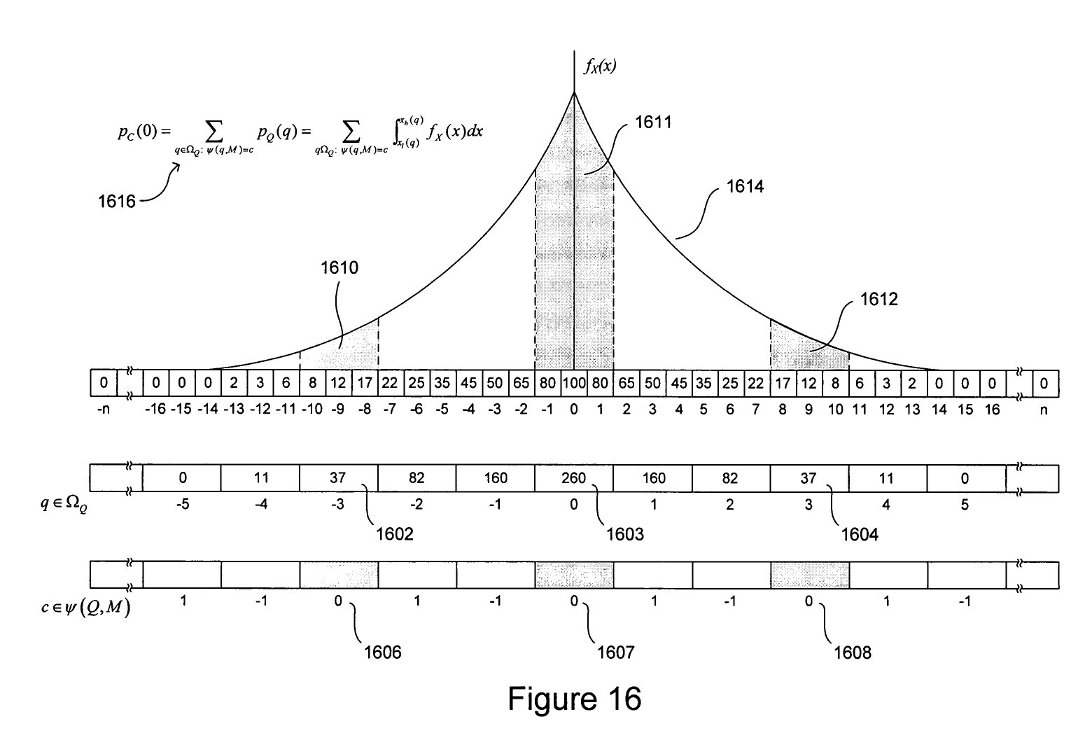

FIG. 15 illustrates computation of the probability P_{Q}(q=−2) based on the exemplary probability density function f_{X}(x) shown in FIG. 13. The probability of obtaining quantization index “−2” from sampling the quantization random variable Q, functionally derived from random variable X, can be seen to be equal to the area 1502 above the quantization bin 1504 indexed by quantization index −2 and below the probability density function f_{X}(x) 1506. FIG. 16 illustrates computation of the probability P_{C}(0) based on the exemplary probability density function f_{X}(x) shown in FIG. 13 and FIG. 15. Because three different quantization bins 1602-1604 correspond to closet index 0 1606-1608, the probability of obtaining the closet index “0” from sampling the closet-index random variable C functionally derived from random variables Q and X is obtained by summing the areas 1610-1612 above quantization bin 1602-1604 and below the probability density function f_{X}(x) 1614, as expressed by equation 1616.

An entropy encoder within an existing regular coder is generally optimized for the distribution p_{Q}(q), and is designed to be particularly efficient for coding zeroes. Because the distribution pC(c) is symmetric for odd M, is centered about zero, and decays with increasing magnitude, an existing entropy coder optimized for p_{Q}(q) may be reused for encoding C, without significant loss in efficiency. If the existing entropy coder is designed for closet indices, then either of the two functions ψ(Q, M) discussed above can be employed interchangeably.

For decoding a sample encoded using a memoryless-closet-based encoding technique, a minimum mean-square-error (“MSE”) reconstruction function \hat{X}_{YC}(y, c) based on unquantized side information y and a received closet index c is given by:

$$\begin{matrix}{\hat{X}}_{YC} ( y , c ) = E ( X / Y = y , C = c ) \\ = E ( X / Y = y , ψ ( φ ( X < QP ) , M ) = c ) \\ = \frac{{\sum }_{q ∈ {Ω}_{Q} : ψ ( q , M ) = c} {\int }_{{x}_{l} ( q )}^{{x}_{h} ( q )} {f}_{X / Y} ( x , y ) d x}{{\sum }_{q ∈ {Ω}_{Q} : ψ ( q , M ) = c} {\int }_{{x}_{l} ( q )}^{{x}_{h} ( q )} {f}_{X / Y} ( x , y ) d x} \\ = \frac{{\sum }_{q ∈ {Ω}_{Q} : ψ ( q , M ) = c} μ ( q , y )}{{\sum }_{q ∈ {Ω}_{Q} : ψ ( q , M ) = c} π ( q , y )}\end{matrix}$$

$$where$$

$$π ( q , y ) = {p}_{Q / Y} ( Q = q / Y = y ) = {\int }_{{x}_{l} ( q )}^{{x}_{h} ( q )} {f}_{X / Y} ( x , y ) d x$$

$$and$$

$$μ ( q , y ) = {\int }_{{x}_{l} ( q )}^{{x}_{h} ( q )} {xf}_{X / Y} ( x , y ) d x$$

and where π(q, y) is the conditional probability of Q given Y.

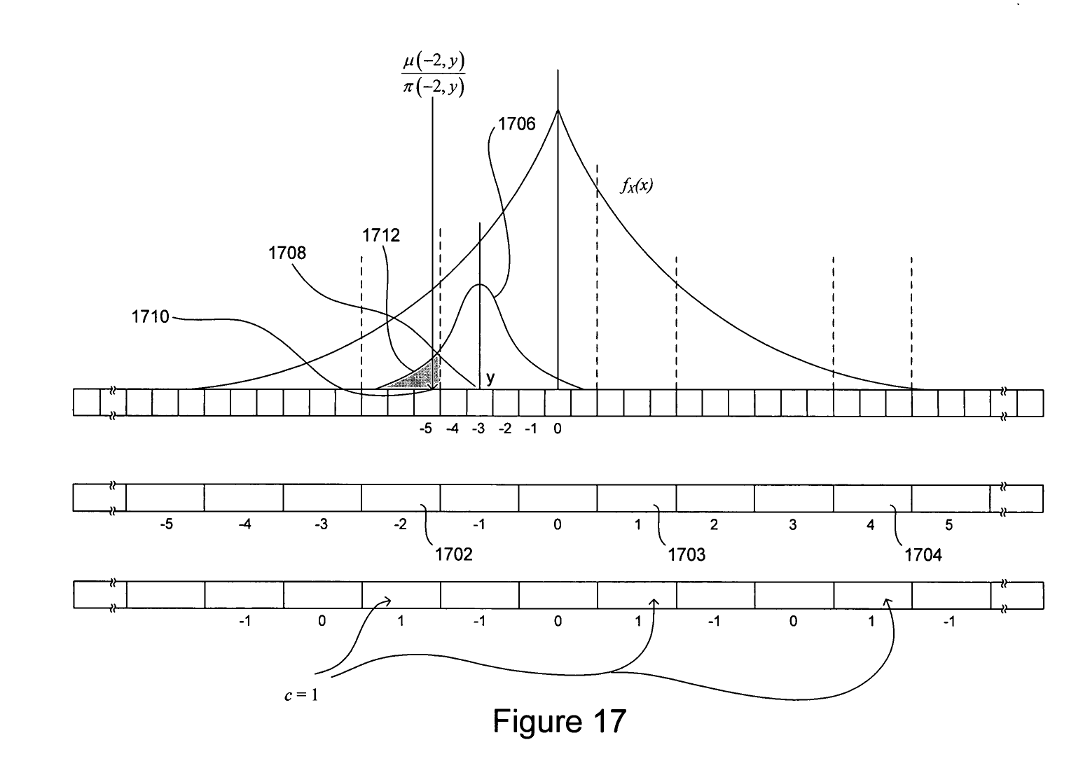

FIG. 17 illustrates the minimum MSE reconstruction function \hat{X}_{YC}(y, c). In the case illustrated in FIG. 17, the received closet-index value c is “1.” Therefore, three quantization bins 1702-1704 correspond to the received closet index c, and these three quantization bins 1702-1704 are indexed by the quantization indices q ∈ Ω_{Q}, :ψ(q,M)=c. Thus, the quantization-bin indexes corresponding to the received closet index c serve as the indices over which the summations in the above expression for \hat{X}_{YC}(y, c) are carried out. The expression μ(q, y) is related to the expected value of x for a quantization bin q in view of side information y. It can be seen, in the above expression for the minimum MSE reconstruction function \hat{X}_{YC}(y, c) that μ(q, y) is a moment computed over the quantization bin using the conditional probability density function f_{X/Y}(x,y)dx. In FIG. 17, the conditional probability density function f_{X/Y}(x,y)dx is shown 1706 superimposed on the graph of f_{X}(x) and centered at y 1708 along the x axis. Because the conditional probability density function 1706 essentially reaches zero prior to the x values corresponding to the final two quantization bins 1703 and 1704, the expected value of x 1710 is obtained by dividing the moment μ by the conditional probability of Q given Y, π(q, y), the shaded area 1712 below the conditional probability density function 1706 and above the x axis region corresponding to quantization bin 1702.

In order to most optimally employ a memoryless closet code, the parameters QP and M need to be chosen to optimize memoryless closet encoding. A target quantization parameter QPₜ corresponding to a target distortion Dₜ based on regular, or non-distributed coding, without side information, may define the expected performance of memoryless closet encoding. The variances for the model random variables X and Z, {σ_{X}², σ_{Z}²}, are assumed to be known. Memoryless closet encoding parameters QP and M for a distributed memoryless closet coding are then chosen so that the target distortion Dₜ is obtained. In other words, because of the availability of side information y to the decoder and optionally to the encoder, a larger QP can be used for encoding with side information than used for regular encoding, without side information, in order to achieve the target distortion Dₜ. The larger parameter QP responds to a larger-granularity quantization, leading to a smaller range of quantization-index values which can be more compactly expressed than a larger range of quantization values generated by a smaller QP parameter.

### Generalized Expected Encoding Rates and Distortions for Various Encoding/Decoding Techniques

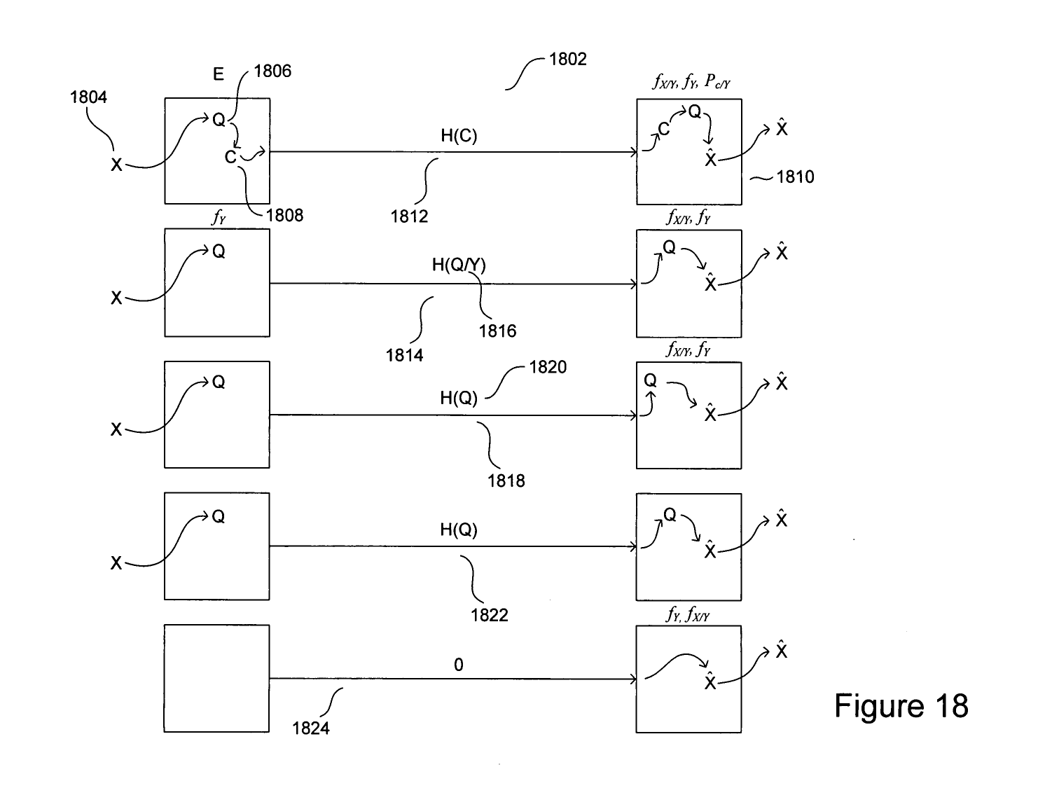

FIG. 18 illustrates five different encoding techniques for which expected rates and expected distortions are subsequently derived. (1) The first case is memoryless closet encoding followed by minimum MSE reconstruction with side information, depicted in FIG. 18 by a first encoder/decoder pair 1802. As discussed above, in memoryless closet encoding techniques, transform coefficients 1804 are quantized 1806, and the quantization indices are then transformed into closet indices 1808 for transfer to the decoder 1810, where quantization indices are regenerated from the closet indices, and transform coefficients are reconstructed from the generated quantization indices. In this case, the decoder employs side information y, probability density functions for transform coefficients x conditioned on y and for the closet indices conditioned on values of y. In this case, the expected rate for encoding is equal to the entropy of the closet indiced 1812. (2) A next considered case is for distributed encoding, represented by the encoder/decoder pair 1814 in FIG. 18. In this case, transform coefficients are quantized to produce quantization indices which are transferred from the encoder to the decoder for reconstruction. The decoder has access to side information y, probability density functions for transform coefficients conditioned on values of Y and the probability density functions for Y. In this case, the encoding rate, in bits per symbol, is optimally the entropy of the quantization random variable Q conditioned on Y 1816. (3) A third case, represented by encoder/decoder pair 1818 in FIG. 18, is for regular encoding with side information available only to the decoder. In this case, the coding rate is optimally the entropy of the quantization random variable Q 1820. (4) A fourth case, represented by encoder/decoder pair 1822, is regular encoding without side information. (5) The final case, represented by encoder/decoder pair 1824, is for zero-rate encoding in which no information is encoded by the encoder, and the decoder relies only on side information to reconstruct and transform coefficients. The expected encoding rate and expected distortion for each of these cases, illustrated in FIG. 18, are next derived.

(1) Rate-Distortion Characterization of Memoryless Closet Encoding Followed by Minimum MSE Reconstruction

Assuming an ideal entropy coder for the closet indices, the expected rate for memoryless-closet-based encoding with minimum MSE reconstruction is the entropy of the closet-index random variable C:

$$\begin{matrix}E ( {R}_{YC} ) = H ( C ) \\ = - {\sum }_{c ∈ {Ω}_{c}} {p}_{c} ( c ) {log}_{2} {p}_{c} \\ = - {\sum }_{c ∈ {Ω}_{c}} \{ {\sum }_{q ∈ {Ω}_{Q} : ψ ( q , M ) = c} {\int }_{{x}_{l} ( q )}^{{x}_{h} ( q )} {f}_{X} ( x ) d x \} \\ {log}_{2} \{ {\sum }_{q ∈ {Ω}_{Q} : ψ ( q , M ) = c} {\int }_{{x}_{l} ( q )}^{{x}_{h} ( q )} {f}_{X} ( x ) d x \}\end{matrix}$$

### Defining

$${m}_{x}^{( i )} ( x ) = {\int }_{- ∞}^{x} {x}^{′ i} {f}_{X} ( {x}^{′} ) d {x}^{′} ,$$

the above expression can be rewritten as:

$$E ( {R}_{YC} ) = - {\sum }_{c ∈ {Ω}_{C}} \{ {\sum }_{q ∈ {Ω}_{Q} ∷ ψ ( q , M ) = c} [ {m}_{X}^{( 0 )} ( {x}_{h} ( q ) ) - {m}_{X}^{( 0 )} ( {x}_{l} ( q ) ) ] \} {log}_{2} \{ {\sum }_{q ∈ {Ω}_{Q} ∷ ψ ( q , M ) = c} [ {m}_{X}^{( 0 )} ( {x}_{h} ( q ) ) - {m}_{X}^{( 0 )} ( {x}_{l} ( q ) ) ] \}$$

Assuming the minimum mean-squared-error reconstruction function \hat{X}_{YC}(y, c) discussed above, the expected distortion D_{YC} given side information y and closet index c is given by:

E(D_{YC}/Y=y, C=c)=E([X−\hat{X}_{YC}(y, c)]²/Y=y, C=c)=E(X²/Y=y, C=c)−\hat{X}_{YC}(y, c)²

using \hat{X}_{YC}(y, c)=E(X/Y=y, C=c). Marginalizing over y and c yields:

$$E ( {D}_{YC} ) = E ( {X}^{2} ) - {\int }_{- ∞}^{∞} \{ {\sum }_{c ∈ {Ω}_{C}} {{\hat{X}}_{YC} ( y , c )}^{2} {p}_{C / Y} ( C = c / Y = y ) \} {f}_{Y} ( y ) d y = {σ}_{X}^{2} - {\int }_{- ∞}^{∞} \{ \begin{matrix}{\sum }_{c ∈ {Ω}_{C}} {( \frac{{\sum }_{q ∈ {Ω}_{Q} ∷ ψ ( q , M ) = c} μ ( q , y )}{{\sum }_{q ∈ {Ω}_{Q} ∷ ψ ( q , M ) = c} π ( q , y )} )}^{2} \\ {p}_{C / Y} ( C = c / Y = y )\end{matrix} \} {f}_{Y} ( y ) d y = {σ}_{X}^{2} - {\int }_{- ∞}^{∞} \{ \begin{matrix}{\sum }_{c ∈ {Ω}_{C}} {( \frac{{\sum }_{q ∈ {Ω}_{Q} ∷ ψ ( q , M ) = c} {\int }_{{x}_{l} ( q )}^{{x}_{h} ( q )} {xf}_{X / Y} ( x , y ) d x}{{\sum }_{q ∈ {Ω}_{Q} ∷ ψ ( q , M ) = c} {\int }_{{x}_{l} ( q )}^{{x}_{h} ( q )} {f}_{X / Y} ( x , y ) d x} )}^{2} \\ {p}_{C / Y} ( C = c / Y = y )\end{matrix} \} {f}_{Y} ( y ) d y$$

where p_{C/Y}(C=c/Y=y) is the conditional probability mass function of C given Y.

Noting that:

$${p}_{C / Y} ( C = c / Y = y ) = {\sum }_{q ∈ {Ω}_{Q} ∷ ψ ( q , M ) = c} {p}_{Q / Y} ( Q = q / Y = y ) = {\sum }_{q ∈ {Ω}_{Q} ∷ ψ ( q , M ) = c} π ( q , y ) = {\sum }_{q ∈ {Ω}_{Q} ∷ ψ ( q , M ) = c} {\int }_{{x}_{l} ( q )}^{{x}_{h} ( q )} {f}_{X / Y} ( x , y ) d x$$

the expected distortion can be expressed as:

$$\begin{matrix}E ( {D}_{YC} ) = {σ}_{X}^{2} - {\int }_{- ∞}^{∞} \{ {\sum }_{c ∈ {Ω}_{c}} \frac{{( {\sum }_{q ∈ {Ω}_{Q} ∷ ψ ( q , M ) = c} μ ( q , y ) )}^{2}}{( {\sum }_{q ∈ {Ω}_{Q} ∷ ψ ( q , M ) = c} π ( q , y ) )} \} {f}_{Y} ( y ) d y \\ = {σ}_{X}^{2} - {\int }_{- ∞}^{∞} \{ {\sum }_{c ∈ {Ω}_{c}} \frac{{( {\sum }_{q ∈ {Ω}_{Q} ∷ ψ ( q , M ) = c} {\int }_{{x}_{l} ( q )}^{{x}_{h} ( q )} {xf}_{X / Y} ( x , y ) d x )}^{2}}{( {\sum }_{q ∈ {Ω}_{Q} ∷ ψ ( q , M ) = c} {\int }_{{x}_{l} ( q )}^{{x}_{h} ( q )} {f}_{X / Y} ( x , y ) d x )} \} {f}_{Y} ( y ) d y\end{matrix}$$

### Defusing:

$${m}_{X / Y}^{( i )} ( x , y ) = {\int }_{- ∞}^{x} {x}^{′ i} {f}_{X / Y} ( {x}^{′} , y ) d {x}^{′}$$

πr(q, y) and μ(q, y) can be expressed as:

$$π ( q , y ) = {\int }_{{x}_{l} ( q )}^{{x}_{h} ( q )} {f}_{X / Y} ( x , y ) d x = [ {m}_{X / Y}^{( 0 )} ( {x}_{h} ( q ) , y ) - {m}_{X / Y}^{( 0 )} ( {x}_{l} ( q ) , y ) ]$$

$$μ ( q , y ) = {\int }_{{x}_{l} ( q )}^{{x}_{h} ( q )} {xf}_{X / Y} ( x , y ) d x = [ {m}_{X / Y}^{( 1 )} ( {x}_{h} ( q ) , y ) - {m}_{X / Y}^{( 1 )} ( {x}_{l} ( q ) , y ) ]$$

The expected distortion can then be expressed as:

$$E ( {D}_{YC} ) = {σ}_{X}^{2} - {\int }_{- ∞}^{∞} \{ {\sum }_{c ∈ {Ω}_{C}} \frac{{( {\sum }_{q ∈ {Ω}_{Q} ∷ ψ ( q , M ) = c} [ {m}_{X / Y}^{( 1 )} ( {x}_{h} ( q ) , y ) - {m}_{X / Y}^{( 1 )} ( {x}_{l} ( q ) , y ) ] )}^{2}}{( {\sum }_{q ∈ {Ω}_{Q} ∷ ψ ( q , M ) = c} [ {m}_{X / Y}^{( 0 )} ( {x}_{h} ( q ) , y ) - {m}_{X / Y}^{( 0 )} ( {x}_{l} ( q ) , y ) ] )} \} {f}_{Y} ( y ) d y$$

(2) Rate-Distortion Characterization of Distributed Encoding

Next, the expected rate and distortion are derived for distributed coding. An ideal distributed coding would use a rate no larger than H(Q/Y) to convey the quantization bins error-free. Once the bins have been conveyed error-free, a minimum MSE reconstruction can be still conducted, but only within the decoded bin. The expected rate E(R_{YQ}) is given by:

$$E ( {R}_{YQ} ) = H ( Q / Y ) = - {\int }_{- ∞}^{∞} \{ \begin{matrix}{\sum }_{q ∈ {Ω}_{Q}} {p}_{Q / Y} ( Q = q / Y = y ) \\ {log}_{2} {p}_{Q / Y} ( Q = q / Y = y )\end{matrix} \} {f}_{Y} ( y ) d y = - {\int }_{- ∞}^{∞} \{ {\sum }_{q ∈ {Ω}_{Q}} π ( q , y ) {log}_{2} π ( q , y ) \} {f}_{Y} ( y ) d y = - {\int }_{- ∞}^{∞} \{ \begin{matrix}{\sum }_{q ∈ {Ω}_{Q}} [ {m}_{X / Y}^{( 0 )} ( {x}_{h} ( q ) , y ) - {m}_{X / Y}^{( 0 )} ( {x}_{l} ( q ) , y ) ] \\ {log}_{2} [ {m}_{X / Y}^{( 0 )} ( {x}_{h} ( q ) , y ) - {m}_{X / Y}^{( 0 )} ( {x}_{l} ( q ) , y ) ]\end{matrix} \} {f}_{Y} ( y ) d y$$

The expected Distortion D_{YQ} is the distortion incurred by a minimum MSE reconstruction function within a quantization bin, given the side information y and bin index q. This reconstruction function \hat{X}_{YQ}(y,q) is given by:

$$\begin{matrix}{\hat{X}}_{YQ} ( y , q ) = E ( X / Y = y , Q = q ) = E ( X / Y = y , φ ( X , QP ) = q ) \\ = \frac{{\int }_{{x}_{l} ( q )}^{{x}_{h} ( q )} {xf}_{X / Y} ( x , y ) d x}{{\int }_{{x}_{l} ( q )}^{{x}_{h} ( q )} {f}_{X / Y} ( x , y ) d x} = \frac{μ ( q , y )}{π ( q , y )} \\ = \frac{{m}_{X / Y}^{( 1 )} ( {x}_{h} ( q ) , y ) - {m}_{X / Y}^{( 1 )} ( {x}_{l} ( q ) , y )}{{m}_{X / Y}^{( 0 )} ( {x}_{h} ( q ) , y ) - {m}_{X / Y}^{( 0 )} ( {x}_{l} ( q ) , y )}\end{matrix}$$

Using this reconstruction, the expected distortion with noise-free quantization bins, D_{YQ}, is given by:

$$\begin{matrix}E ( {D}_{YQ} ) = {σ}_{X}^{2} - {\int }_{- ∞}^{∞} \{ {\sum }_{q ∈ {Ω}_{Q}} \frac{{( {\int }_{{x}_{l} ( q )}^{{x}_{h} ( q )} {xf}_{X / Y} ( x , y ) d x )}^{2}}{( {\int }_{{x}_{l} ( q )}^{{x}_{h} ( q )} {f}_{X / Y} ( x , y ) d x )} \} {f}_{Y} ( y ) d y \\ = {σ}_{X}^{2} - {\int }_{- ∞}^{∞} \{ {\sum }_{q ∈ {Ω}_{Q}} \frac{{μ ( q , y )}^{2}}{π ( q , y )} \} {f}_{Y} ( y ) d y \\ = {σ}_{X}^{2} - {\int }_{- ∞}^{∞} \{ {\sum }_{q ∈ {Ω}_{Q}} \frac{{( {m}_{X / Y}^{( 1 )} ( {x}_{h} ( q ) , y ) - {m}_{X / Y}^{( 1 )} ( {x}_{l} ( q ) , y ) )}^{2}}{( {m}_{X / Y}^{( 0 )} ( {x}_{h} ( q ) , y ) - {m}_{X / Y}^{( 0 )} ( {x}_{l} ( q ) , y ) )} \} {f}_{Y} ( y ) d y\end{matrix}$$

(3) Rate-Distortion Characterization of Regular Encoding with Side Information Available Only to the Decoder

Next, the rate and distortion for non-distributed coding on the quantization bins done at the encoder. In this case, the expected rate is just the entropy of Q.

$$\begin{matrix}E ( {R}_{Q} ) = H ( Q ) = - {\sum }_{q ∈ {Ω}_{Q}} {p}_{Q} ( q ) {log}_{2} {p}_{Q} ( q ) \\ = - {\sum }_{q ∈ {Ω}_{Q}} [ {m}_{X}^{( 0 )} ( {x}_{h} ( q ) ) - {m}_{X}^{( 0 )} ( {x}_{l} ( q ) ) ] {log}_{2} [ {m}_{X}^{( 0 )} ( {x}_{h} ( q ) ) - {m}_{X}^{( 0 )} ( {x}_{l} ( q ) ) ]\end{matrix}$$

In this case, the reconstruction function and the corresponding expected distortion are given by:

$$\begin{matrix} \begin{matrix}{\hat{X}}_{YQ} ( y , q ) = E ( X / Y = y , Q = q ) = E ( X / Y = y , φ ( X , QP ) = q ) \\ = \frac{{\int }_{{x}_{l} ( q )}^{{x}_{h} ( q )} {xf}_{X / Y} ( x , y ) d x}{{\int }_{{x}_{l} ( q )}^{{x}_{h} ( q )} {f}_{X / Y} ( x , y ) d x} = \frac{μ ( q , y )}{π ( q , y )} \\ = \frac{{m}_{X / Y}^{( 1 )} ( {x}_{h} ( q ) , y ) - {m}_{X / Y}^{( 1 )} ( {x}_{l} ( q ) , y )}{{m}_{X / Y}^{( 0 )} ( {x}_{h} ( q ) , y ) - {m}_{X / Y}^{( 0 )} ( {x}_{l} ( q ) , y )}\end{matrix} \\ and \\ \begin{matrix}E ( {D}_{YQ} ) = {σ}_{X}^{2} - {\int }_{- ∞}^{∞} \{ {\sum }_{q ∈ {Ω}_{Q}} \frac{{( {\int }_{{x}_{l} ( q )}^{{x}_{h} ( q )} {xf}_{X / Y} ( x , y ) d x )}^{2}}{( {\int }_{{x}_{l} ( q )}^{{x}_{h} ( q )} {f}_{X / Y} ( x , y ) d x )} \} {f}_{Y} ( y ) d y \\ = {σ}_{X}^{2} - {\int }_{- ∞}^{∞} \{ {\sum }_{q ∈ {Ω}_{Q}} \frac{{μ ( q , y )}^{2}}{π ( q , y )} \} {f}_{Y} ( y ) d y \\ = {σ}_{X}^{2} - {\int }_{- ∞}^{∞} \{ {\sum }_{q ∈ {Ω}_{Q}} \frac{{( {m}_{X / Y}^{( 1 )} ( {x}_{h} ( q ) , y ) - {m}_{X / Y}^{( 1 )} ( {x}_{l} ( q ) , y ) )}^{2}}{( {m}_{X / Y}^{( 0 )} ( {x}_{h} ( q ) , y ) - {m}_{X / Y}^{( 0 )} ( {x}_{l} ( q ) , y ) )} \} {f}_{Y} ( y ) d y\end{matrix}\end{matrix}$$

(4) Rate-Distortion Characterization of Regular Encoding Without Side Information

When there is no side information available, the expected distortion D_{Q} is the distortion incurred by a minimum MSE reconstruction function based only on the bin index q. This reconstruction function \hat{X}_{Q}(q) is given by:

$$\begin{matrix}{\hat{X}}_{Q} ( q ) = E ( X / Q = q ) = E ( X / φ ( X , QP ) = q ) = \frac{{\int }_{{x}_{l} ( q )}^{{x}_{h} ( q )} {xf}_{X} ( x ) d x}{{\int }_{{x}_{l} ( q )}^{{x}_{h} ( q )} {f}_{X} ( x ) d x} \\ = \frac{{m}_{X}^{( 1 )} ( {x}_{h} ( q ) ) - {m}_{X}^{( 1 )} ( {x}_{l} ( q ) )}{{m}_{X}^{( 0 )} ( {x}_{h} ( q ) ) - {m}_{X}^{( 0 )} ( {x}_{l} ( q ) )}\end{matrix}$$

while the expected distortion is given by:

$$\begin{matrix}E ( {D}_{Q} ) = {σ}_{X}^{2} - {\sum }_{q ∈ {Ω}_{Q}} \frac{{( {\int }_{{x}_{l} ( q )}^{{x}_{h} ( q )} {xf}_{X} ( x ) d x )}^{2}}{( {\int }_{{x}_{l} ( q )}^{{x}_{h} ( q )} {f}_{X} ( x ) d x )} \\ = {σ}_{X}^{2} - {\sum }_{q ∈ {Ω}_{Q}} \frac{{( {m}_{X}^{( 1 )} ( {x}_{h} ( q ) ) - {m}_{X}^{( 1 )} ( {x}_{l} ( q ) ) )}^{2}}{( {m}_{X}^{( 0 )} ( {x}_{h} ( q ) ) - {m}_{X}^{( 0 )} ( {x}_{l} ( q ) ) )}\end{matrix}$$

(5) Rate-Distortion Characterization 0-Rate Encoding

The final case is when no information is transmitted corresponding to X, so that the encoding rate is 0. The decoder performs the minimum MSE reconstruction function \hat{X}_{T}(y):

$${\hat{X}}_{Y} ( y ) = E ( X / Y = y ) = {\int }_{- ∞}^{∞} {xf}_{X / Y} ( x , y ) d x = {m}_{X / Y}^{( 1 )} ( ∞ , y )$$

The expected zero-rate distortion D_{Y} is given by:

$$\begin{matrix}E ( {D}_{Y} ) = {σ}_{X}^{2} - {\int }_{- ∞}^{∞} {( {\int }_{- ∞}^{∞} {xf}_{X / Y} ( x , y ) d x )}^{2} {f}_{Y} ( y ) d y \\ = {σ}_{X}^{2} - {\int }_{- ∞}^{∞} {{m}_{X / Y}^{( 1 )} ( ∞ , y )}^{2} {f}_{Y} ( y ) d y\end{matrix}$$

Encoding Rates and Distortions for a Laplacian Source with Additive Gaussian Noise

While the expressions in the previous subsection are generic, they can be particularized for the case of Laplacian X and Gaussian Z:

$${f}_{X} ( x ) = \frac{1}{\sqrt{2} {σ}_{X}} {e}^{- \vert \frac{x \sqrt{2}}{{σ}_{X}} \vert} , {f}_{Z} ( z ) = \frac{1}{\sqrt{2 π} {σ}_{Z}} {e}^{- \frac{1}{2} {\vert \frac{z}{{σ}_{z}} \vert}^{2}}$$

### Assuming:

$$erf ( x ) = \frac{2}{\sqrt{π}} {\int }_{0}^{x} {e}^{- {t}^{2}} d t$$

and defining:

$$β ( x ) = {e}^{\frac{\sqrt{2} x}{{σ}_{x}}}$$

the partial moments mₓ⁽⁰⁾(x) and mₓ⁽¹⁾(x) can be expressed as:

$$\begin{matrix}{m}_{X}^{( 0 )} ( x ) = \{ \begin{matrix}\frac{β ( x )}{2} , & x \leq 0 \\ 1 - \frac{1}{2 β ( x )} , & x > 0\end{matrix} \\ {m}_{X}^{( 1 )} ( x ) = \{ \begin{matrix}\frac{β ( x )}{2 \sqrt{2}} ( \sqrt{2} x - {σ}_{X} ) , & x \leq 0 \\ - \frac{1}{2 \sqrt{2} β ( x )} ( \sqrt{2} x + {σ}_{X} ) , & x > 0\end{matrix}\end{matrix}$$

Further defining:

$${γ}_{1} ( x ) = erf ( \frac{{σ}_{X} x - \sqrt{2} {σ}_{Z}^{2}}{\sqrt{2} {σ}_{X} {σ}_{Z}} ) , {γ}_{2} ( x ) = erf ( \frac{{σ}_{X} x + \sqrt{2} {σ}_{Z}^{2}}{\sqrt{2} {σ}_{X} {σ}_{Z}} )$$

and using Y=X+Z, the joint probability distribution f_{XY}(x, y), probability distribution f_{Y}(y), and conditional probability distribution f_{X/Y}(x, y) can be expressed as:

$${f}_{XY} ( x , y ) = \frac{1}{2 \sqrt{π} {σ}_{X} {σ}_{Z}} {e}^{- \vert \frac{x \sqrt{2}}{{σ}_{X}} \vert} {e}^{- \frac{1}{2} {( \frac{y - x}{{σ}_{Z}} )}^{2}}$$

$${f}_{Y} ( y ) = {\int }_{- ∞}^{∞} {f}_{XY} ( x , y ) d x = \frac{1}{2 \sqrt{2} β ( y ) {σ}_{X}} {e}^{{σ}_{X}^{2} / {σ}_{Z}^{2}} [ \begin{matrix}{γ}_{1} ( y ) + 1.0 - \\ {β ( y )}^{2} ( {γ}_{2} ( y ) - 1.0 )\end{matrix} ]$$

$${f}_{X / Y} ( x , y ) = \frac{{f}_{XY} ( x , y )}{{f}_{Y} ( y )} = \frac{\sqrt{2} β ( y )}{\sqrt{π} {σ}_{Z}} \frac{{e}^{- \vert \frac{x \sqrt{2}}{{σ}_{X}} \vert - \frac{1}{2} {( \frac{y - x}{{σ}_{Z}} )}^{2} \frac{{σ}_{X}^{2}}{{σ}_{Z}^{2}}}}{[ {γ}_{1} ( y ) + 1.0 - {β ( y )}^{2} ( {γ}_{2} ( y ) - 1.0 ) ]}$$

Using the above-derived expression for f_{X/Y}(x, y), the partial moments m_{X/Y}⁽⁰⁾(x, y) and m_{X/Y}⁽¹⁾(x, y) can be expressed as:

$${m}_{X / Y}^{( 0 )} ( x , y ) = \{ \begin{matrix}\frac{1}{[ {γ}_{1} ( y ) + 1.0 - {β ( y )}^{2} ( {γ}_{2} ( y ) - 1.0 ) ]} {β ( y )}^{2} [ 1 - erf ( \frac{\begin{matrix}{σ}_{X} ( y - x ) + \\ \sqrt{2} {σ}_{Z}^{2}\end{matrix}}{\sqrt{2} {σ}_{X} {σ}_{Z}} ) ] , & x \leq 0 \\ 1 - \frac{1}{[ {γ}_{1} ( y ) + 1.0 - {β ( y )}^{2} ( {γ}_{2} ( y ) - 1.0 ) ]} [ 1 + erf ( \frac{\begin{matrix}{σ}_{X} ( y - x ) - \\ \sqrt{2} {σ}_{Z}^{2}\end{matrix}}{\sqrt{2} {σ}_{X} {σ}_{Z}} ) ] , & x > 0\end{matrix}$$

$${m}_{X / Y}^{( 1 )} ( x , y ) = \{ \begin{matrix}\frac{\begin{matrix}{β ( y )}^{2} [ y + \sqrt{2} \frac{{σ}_{Z}^{2}}{{σ}_{X}} ] [ 1 - erf ( \frac{\begin{matrix}{σ}_{X} ( y - x ) + \\ \sqrt{2} {σ}_{Z}^{2}\end{matrix}}{\sqrt{2} {σ}_{X} {σ}_{Z}} ) ] - \\ \frac{\sqrt{2}}{\sqrt{π}} {σ}_{Z} {β ( x )}^{2} {e}^{\frac{- \frac{1}{2} {( {σ}_{X} ( y - x ) - \sqrt{2} {σ}_{Z}^{2} )}^{2}}{{σ}_{X}^{2} {σ}_{Z}^{2}}}\end{matrix}}{[ {γ}_{1} ( y ) + 1 - {β ( y )}^{2} ( {γ}_{2} ( y ) - 1 ) ]} , \\ x \leq 0 \\ \frac{\begin{matrix}- {β ( y )}^{2} [ \begin{matrix}y + \\ \sqrt{2} \frac{{σ}_{Z}^{2}}{{σ}_{X}}\end{matrix} ] ( \begin{matrix}{γ}_{2} ( y ) - \\ 1\end{matrix} ) + \\ [ \begin{matrix}y - \\ \sqrt{2} \frac{{σ}_{Z}^{2}}{{σ}_{X}}\end{matrix} ] [ \begin{matrix}{γ}_{1} ( y ) - \\ erf ( \frac{\begin{matrix}{σ}_{x} ( y - x ) - \\ \sqrt{2} {σ}_{Z}^{2}\end{matrix}}{\sqrt{2} {σ}_{X} {σ}_{Z}} )\end{matrix} ] - \frac{\sqrt{2}}{\sqrt{π}} {σ}_{Z} {e}^{\frac{- \frac{1}{2} {( {σ}_{X} ( y - x ) - \sqrt{2} {σ}_{Z}^{2} )}^{2}}{{σ}_{X}^{2} {σ}_{Z}^{2}}}\end{matrix}}{[ {γ}_{1} ( y ) + 1 - {β ( y )}^{2} ( {γ}_{2} ( y ) - 1 ) ]} , \\ x > 0\end{matrix}$$

A special case used for the optimal reconstruction and distortion functions in the zero-rate case is when x→∞. In this case,

$$\begin{matrix}{m}_{X / Y}^{( 1 )} ( ∞ , y ) = \frac{- {β ( y )}^{2} [ y + \sqrt{2} \frac{{σ}_{Z}^{2}}{{σ}_{X}} ] ( {γ}_{2} ( y ) - 1 ) + [ y - \sqrt{2} \frac{{σ}_{Z}^{2}}{{σ}_{X}} ] ( {γ}_{1} ( y ) + 1 )}{[ {γ}_{1} ( y ) + 1 - {β ( y )}^{2} ( {γ}_{2} ( y ) - 1 ) ]} \\ = y - \sqrt{2} \frac{{σ}_{Z}^{2}}{{σ}_{X}} \frac{[ {γ}_{1} ( y ) + 1 + {β ( y )}^{2} ( {γ}_{2} ( y ) - 1 ) ]}{[ {γ}_{1} ( y ) + 1 - {β ( y )}^{2} ( {γ}_{2} ( y ) - 1 ) ]}\end{matrix}$$

The erf( ) function used in the above expressions for moments and f_{Y}(y) can be evaluated based on a 9^{th} order polynomial approximation. All the generalized expected rate and distortion functions provided for the five selected encoding methods, above, can be evaluated based on these moments in conjunction with numerical integration with f_{Y}(y), given the quantization function φ and the closet modulus function ψ.

### Optimal Parameter Selection and a Combination-Memoryless-Encoding Method

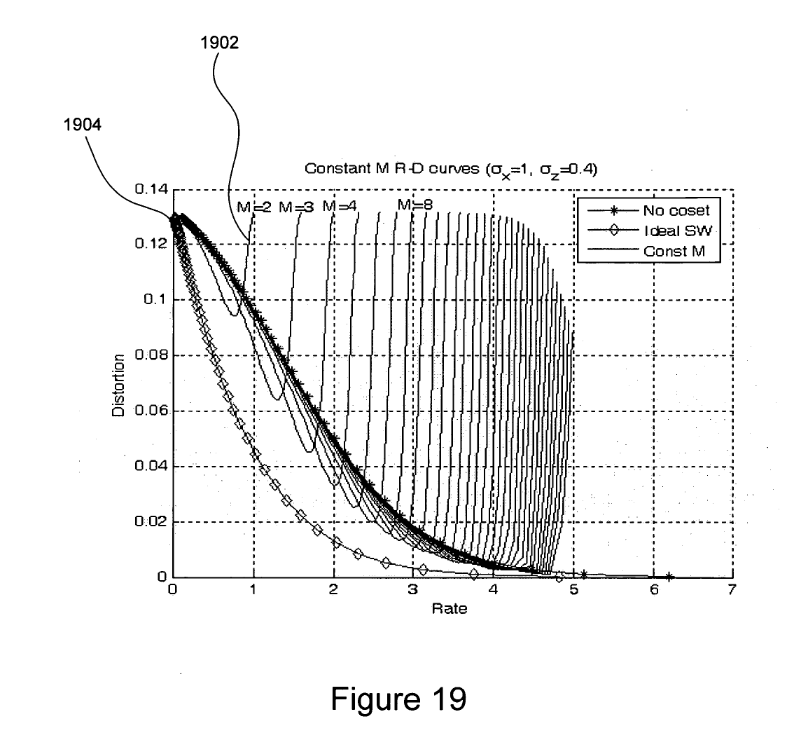

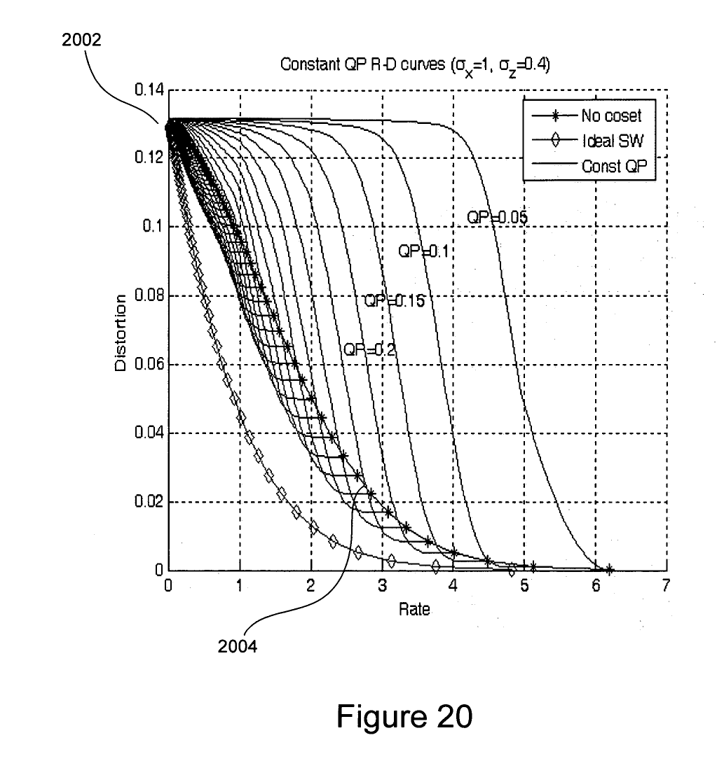

FIGS. 19 and 20 show constant-M rate/distortion curves and constant QP rate/distortion curves for memoryless-closet-based encoding of transform coefficients using the deadzone quantizer and the circular-modulus-based closet-index-generation function discussed above. These exemplary rate/distortion curves are generated for transform coefficients modeled by a random variable X with σₓ=1 and a Gaussian noise model represented by a random variable Z with σ_{z}=0.4. In FIG. 19, each rate/distortion curve, shown by U-shaped curves, such as curve 1902, is generated using a constant closet-generating modulus of M and quantization parameter QP varying over a range of values at increments of 0.05. In FIG. 20, the curves are generated by fixing QP and varying the parameter Mover similarly small increments.

In the constant M curves, as QP→∞, the encoder approaches the zero-rate encoding case, since the amount of encoded information approaches zero, and the distortion approaches the expected distortion rate D=E(D_{Y}) for the zero-rate encoding case discussed above. Thus, all of the constant-M curves start at the point {0, E(D_{Y})} 1904 of the vertical axis. As QP→0+, each closet index has equal probability, and the entropy for the closet indices converges to log₂M. At this extreme, distortion again approaches that for the zero-rate case E(D_{Y}). In FIG. 19, the line labeled with “*” characters corresponds to the regular encoding with side information at the decoder, represented by encoder/decoder pair 1818 in FIG. 18. The line with diamond-like-character labeling corresponds to the distributed encoding, represented by encoder/decoder pair 1814 in FIG. 18. All of the constant-QP curves of FIG. 20 start from point {0, E(D_{Y})} 2002, as in the case of constant-M curves in FIG. 19. This point also represents the QP→∞ curve. As M→∞, the coder approaches a regular encoding technique without closet-index generation, and thus each constant QP curve ends along the regular-coding-with-side-information-at-the-decoder curve 2004 labeled with “*” characters.

In considering the constant M and constant QP curves illustrated in FIGS. 19 and 20, it can be seen that memoryless closet encoding provides an advantage over regular encoding with side information available only at the decoder only when the parameters M and QP are adjusted so that the rate/distortion plot of the memoryless closet encoder lies along a constant M and constant QP curve below the curve for regular encoding with side information available only at the decoder, indicated in FIGS. 19 and 20 by the curve marked with “*” symbols. In other words, memoryless closet encoding is always less efficient, for a given target distortion, than theoretically optimal distributed coding, but may be more efficient, for a target distortion rate, than regular encoding with side information available only at the decoder when appropriate M and QP parameters are chosen. Therefore, in order to efficient use memoryless closet encoding, a technique needs to be devised to select only those QP and M parameter pairs for which memoryless closet encoding provides a better rate for a given target distortion than regular encoding with side information at the decoder only.

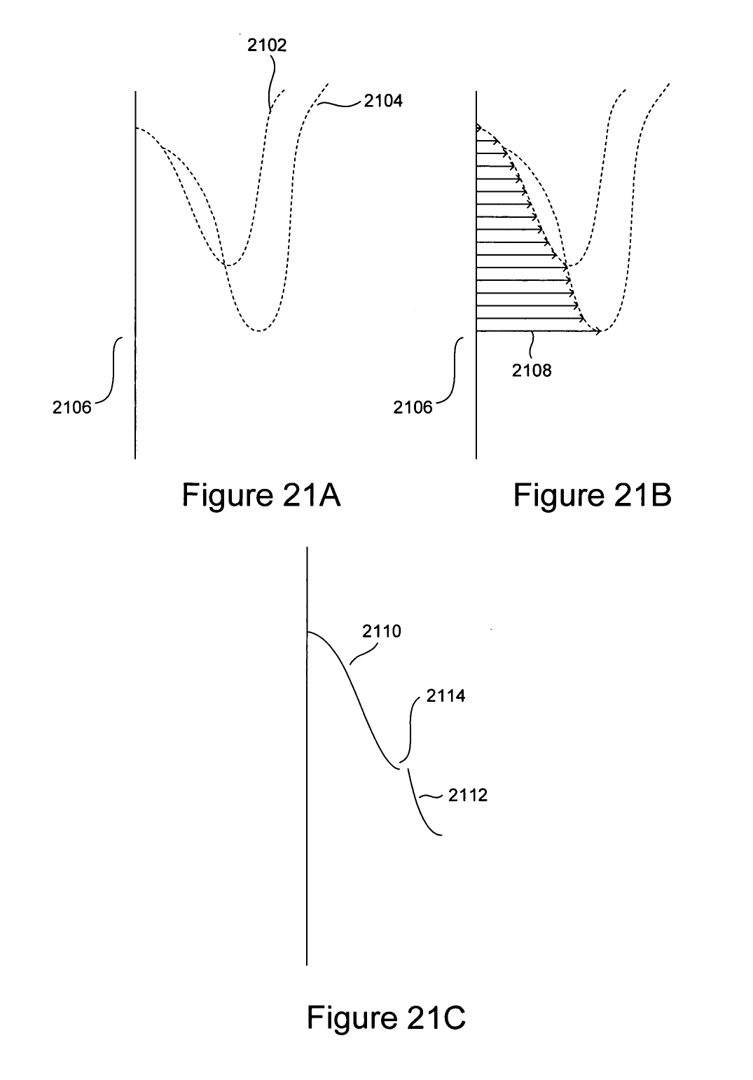

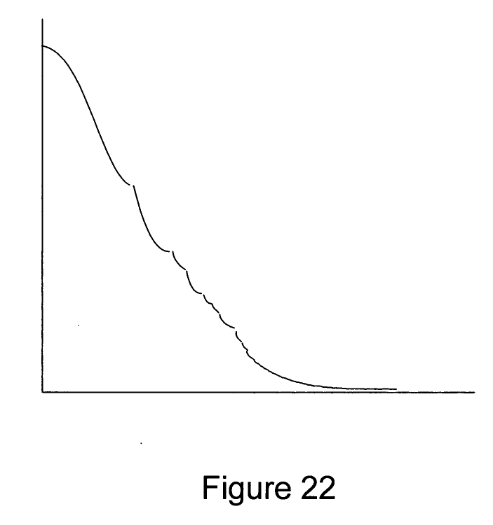

FIGS. 21A-26 illustrate a method for determining the M and QP parameters for memoryless closet encoding that provides coding efficiencies better than those obtained by non-distributed regular encoding with side information. FIGS. 21A-C illustrate selection of Pareto-Optimal points from two constant-M rate/distortion curves such as those shown in FIG. 19. Two constant-M rate/distortion curves 2102 and 2104 are shown in FIG. 21A with respect to a vertical distortion axis 2106. The Pareto-Optimal points are those obtained by selecting the first rate/distortion-curve point encountered when moving from the vertical distortion axis 2106 towards the rate/distortion curves in a horizontal direction, as represented in FIG. 21B by arrows, such as arrow 2108. Each end point at the head of each of the arrows, where the first rate/distortion-curve point is encountered, is a Pareto-Optimal point. Thus, as shown in FIG. 21C, the Pareto-Optimal points for the two rate/distortion curves form two curved segments 2110 and 2112 separated by a discontinuity 2114 between the final point of the first curve 2110 and the first point of the second curve 2112. FIG. 22 shows the Pareto-Optimal points for the set of constant-M rate/distortion curves shown in FIG. 19.

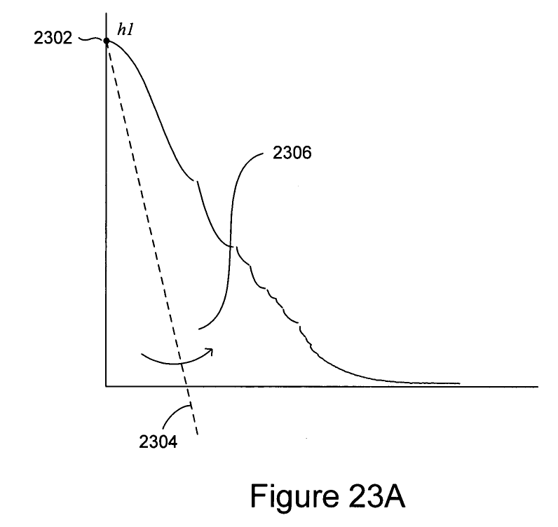

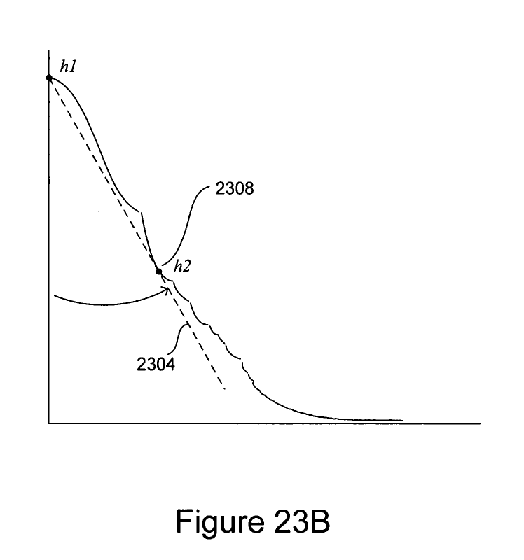

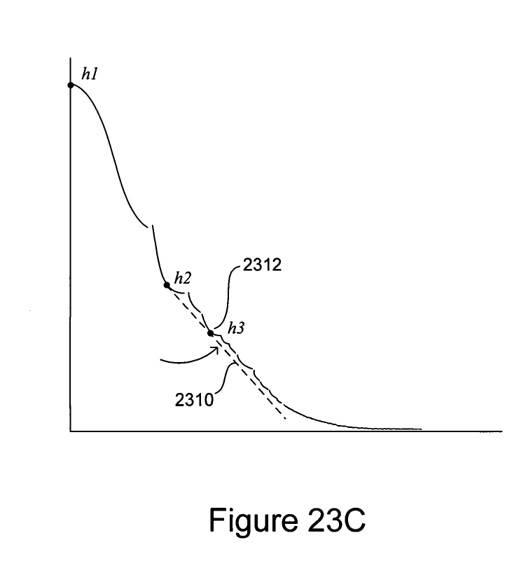

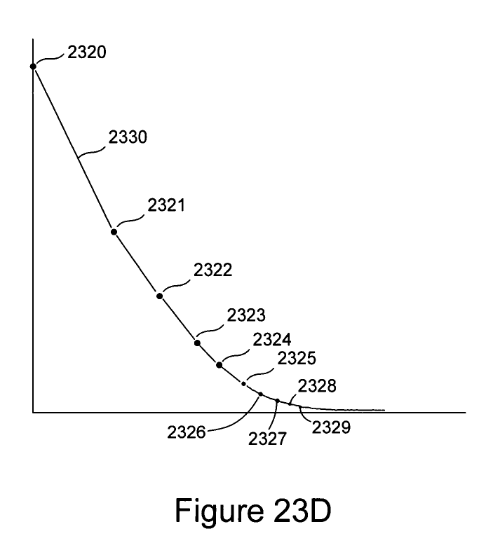

Next, a subset of the Pareto-Optimal points P, referred to as a convex-hull set H, are selected by an iterative steepest-gradient approach. FIGS. 23A-D illustrate selection of the convex-hull points H from the Pareto-Optimal points P shown in FIG. 22. In a first step, the Pareto-Optimal point with distortion equal to E(D_{Y}) 2302 is selected as the first convex-hull point h1. Then, a vertical line 2304 initially perpendicular and including the initial convex-hull point h1 is pivoted about point h1 towards the Pareto-Optimal-point curves 2306. The first Pareto-Optimal-point-curve point touched by the pivoting line 2304, as shown in FIG. 23B, is selected as the second convex-hull point h2 2308. Then, as shown in FIG. 23, a line tangent to the Pareto-Optimal-point curve including point h2 is rotated about point h2 until the rotating line 2310 touches a next Pareto-Optimal-point-curve point 2312, which is then selected as the third convex-hull point h3 2312. This process continues until the slope of the tangent line passing through the last convex-hull point selected approaches zero, or until there are no further Pareto-Optimal points to consider. This produces the set of points 2320-2329, and additional points too close together to differentiate, shown in FIG. 23D. As discussed below, the above-described graphical approach is equivalent to a steepest gradient method in which the next-select convex-hull point lies at the steepest, descending angle from last selected convex-hull point.

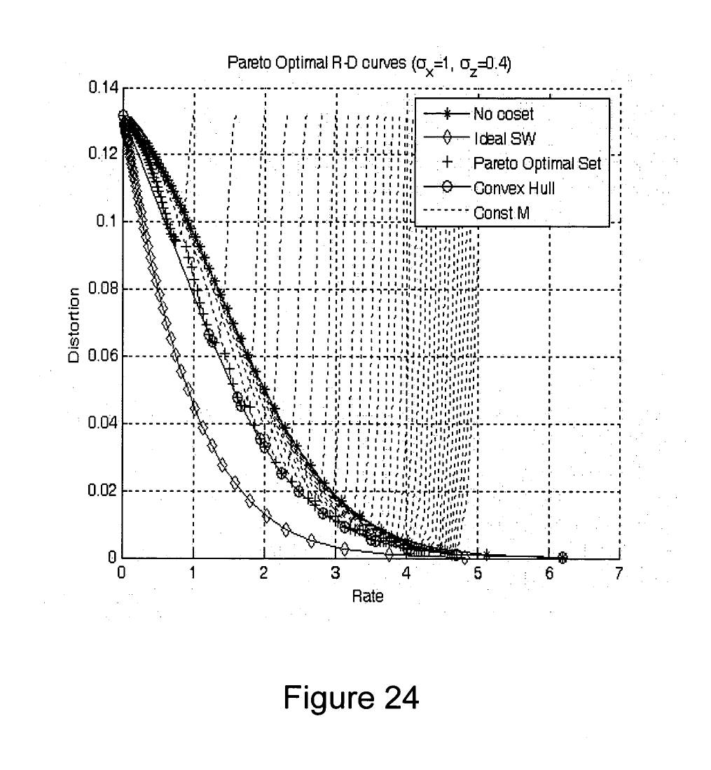

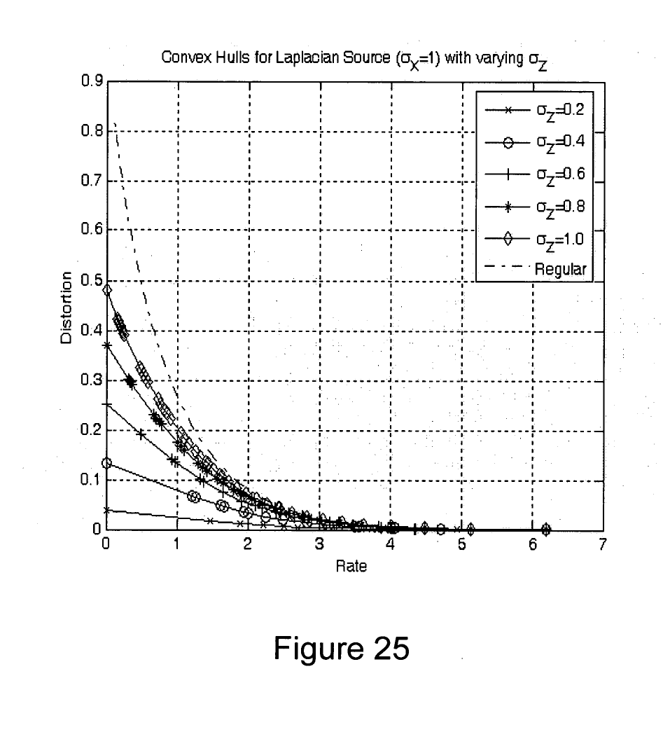

By connecting successive pairs of the convex-hull points H by straight lines, such as straight line 2330 connecting points h1 2320 and h2 2321, the convex hull corresponding to the Pareto-Optimal points is obtained. FIG. 24 illustrates the Pareto-Optimal points and convex-hull points for the constant-M rate/distortion curve set shown in FIG. 19. FIG. 25 shows convex hulls computed for a number of different source/noise models, in which the Laplacian source X has standard deviation equal to 1 and the Gaussian noise random variable produces a probability density function with σ_{z} ranging from 0.2 to 1.0. The convex-hull points represent the theoretically optimal M and QP values for memoryless closet encoding. It is unsurprising that the distortion exhibited for a given encoding rate increases as the standard deviation of the Gaussian noise random variable Z increases. As the probability density function for the noise random variable Z broadens, the side information y probability density function also broadens, providing less value in reconstructing quantization bins.

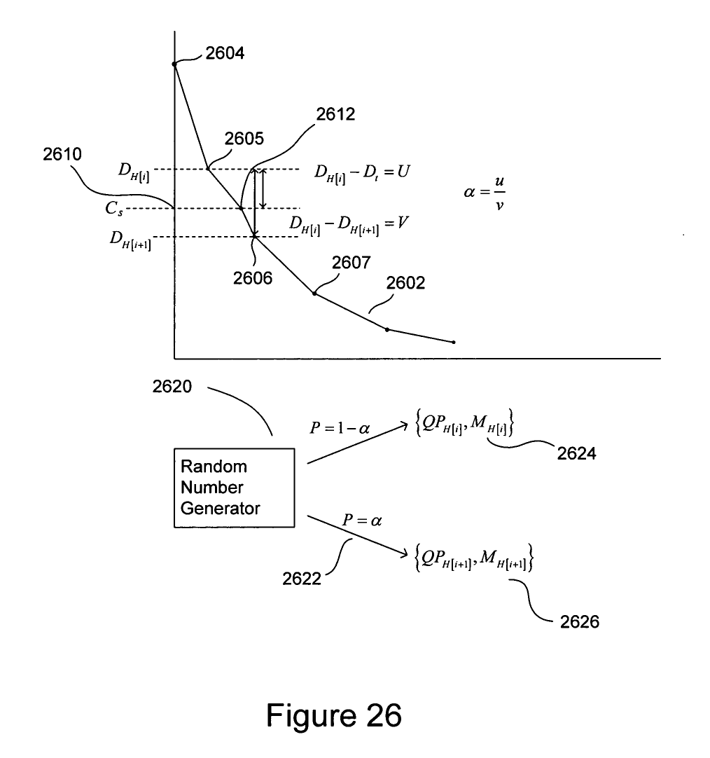

FIG. 26 illustrates optimal memoryless closet encoding parameter selection. The convex hull 2602 computed for the particular source and noise models by which the encoding problem is modeled can be computed from rate/distortion curves generated using the model, as described above with reference to FIGS. 19-25. The convex-hull points, such as convex-hull points h1 2604, h2 2605, h3 2606, and h4 2607 represent actual rate/distortion pairs calculated from QP and M values. However, the line segments joining these points are theoretical convex-hull points, rather than rate/distortion points obtained from actual encoding based on QP and M parameters. Therefore, according to one method, in order to obtain optimal memoryless-closet-based encoding for a selected target distortion Dₜ, a ratio α is obtained by interpolation from the convex hull, and two different memoryless-closet-based encoding techniques, defined by the QP and M values of the nearest convex-hull points, are employed to encode a series of source samples. For example, as shown in FIG. 26, a target distortion Dₜ 2610 is first selected, and then the interpolation point 2612 is obtained as the intersection of a horizontal line through the target distortion Dₜ and the convex hull 2602. The ratio α is obtained from the vertical distance between the interpolation point 2612 and a horizontal line passing through a first, nearest, higher-distortion convex-hull point 2605 and the distance between the convex-hull points 2605 and 2606 that bracket the interpolation point 2612, as shown in FIG. 26. Then, an optimal memoryless-closet-based decoding is obtained by using synchronized pseudo-random number generators in both the encoder and decoder that produce the Boolean value TRUE with a probability of 1-α 2620 and that produce the Boolean value FALSE with a probability of a 2622. For each sample encoded, a next Boolean value TRUE or FALSE is obtained from the pseudo-random number generator. When the value TRUE is obtained, the QP/M pair 2624 corresponding to the higher-distortion convex-hull point 2605, referred to below as {QPᵢ, Mᵢ} or {QP₁, M₁}, is selected for configuring memoryless-closet-based encoding for the sample. Otherwise, the QP/M pair 2626 corresponding to the lower-distortion convex-hull point 2606, referred to below as {QPᵢ₊₁, Mᵢ₊₁} or {QP₂, M₂}, is selected for configuring memoryless-closet-based encoding of the sample. As the number of samples encoded and decoded increases, the overall coding rate and decoding distortion approaches that represented by the interpolation point 2612.

As discussed above, a target distortion Dₜ corresponds to a target QPₜ. The bracketing convex-hull points, and corresponding QP and M parameters, can be computed by the above-described methods for each possible target distortion Dₜ or corresponding target QPₜ, along with the ratio α. A table of the computed QPᵢ/Mᵢ, QPᵢ₊₁/Mᵢ₊₁, and α values for each target distortion Dₜ or corresponding target QPₜ can be compiled for each possible source and noise model. When such tables are incorporated into the encoder/decoder, along with the synchronized random number generator, then, when the model for the source and noise is specified, the encoder and decoder can employ a table appropriate to a specified source and noise model to obtain optimal memoryless-closet-based encoding by the method described above with reference to FIG. 26. Table 1, provided below, includes the five parameters for optimal memoryless-closet-based encoding for a particular source/noise model over a range of target QP values QPₜ:

TABLE 1
Look-up table from target QPₜ to 5-tuple parameters for σ_{X} = 1, σ_{Z} = 0.4

| QPₜ | QP₁ | M₁ | QP₂ | M₂ | α |
|---|---|---|---|---|---|
| 0.05 | 0.10 | 32 | 0.05 | ∞ | 0.93314 |
| 0.10 | 0.15 | 21 | 0.10 | 32 | 0.90638 |
| 0.15 | 0.20 | 15 | 0.15 | 20 | 0.98211 |
| 0.20 | 0.20 | 14 | 0.20 | 15 | 0.39819 |
| 0.25 | 0.30 | 9 | 0.25 | 11 | 0.96786 |
| 0.30 | 0.35 | 7 | 0.30 | 9 | 0.87608 |
| 0.35 | 0.40 | 6 | 0.35 | 7 | 0.92355 |
| 0.40 | 0.45 | 5 | 0.40 | 6 | 0.74711 |
| 0.45 | 0.55 | 4 | 0.50 | 5 | 0.97749 |
| 0.50 | 0.55 | 4 | 0.50 | 5 | 0.03730 |
| 0.55 | 0.70 | 3 | 0.60 | 4 | 0.54183 |
| 0.60 | ∞ | 1 | 0.75 | 3 | 0.99238 |
| 0.65 | ∞ | 1 | 0.75 | 3 | 0.80090 |
| 0.70 | ∞ | 1 | 0.75 | 3 | 0.59556 |
| 0.75 | ∞ | 1 | 0.75 | 3 | 0.37739 |
| 0.80 | ∞ | 1 | 0.75 | 3 | 0.14747 |
| 0.85 | ∞ | 1 | ∞ | 1 | 0 |
| 0.90 | ∞ | 1 | ∞ | 1 | 0 |
| 0.95 | ∞ | 1 | ∞ | 1 | 0 |
| 1.00 | ∞ | 1 | ∞ | 1 | 0 |

Entries with QP=∞ and M=1 correspond to a zero encoding rate. An entry with M=∞ corresponds to coding without cosets but using side information based on minimum MSE reconstruction.

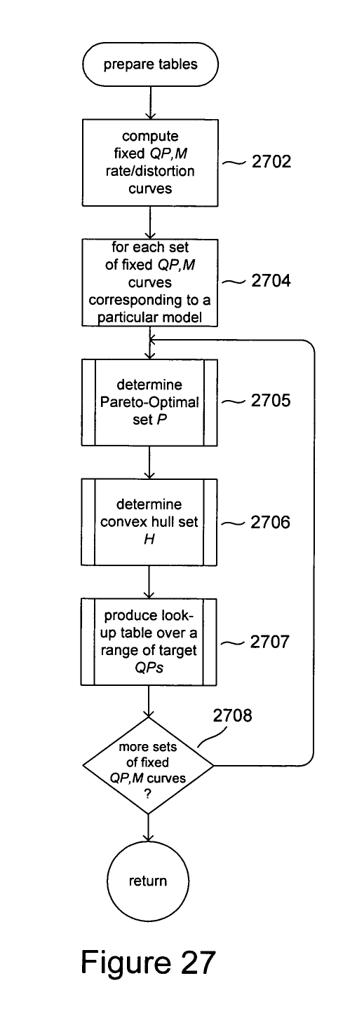

FIG. 27 is a control-flow diagram illustrating preparation of lookup tables that include the QPᵢ/Mᵢ, QPᵢ₊₁/Mᵢ₊₁, and α values for each target distortion Dₜ or corresponding QP parameter QPₜ for some number of source and noise models. First, in step 2702, sets of fixed-QP/M rate/distortion curves are computed, such as those shown in FIG. 19, for each desired source/noise model combination. Then, in the for-loop comprising steps 2704-2708, a lookup table is prepared for each source/noise model. For each currently considered source/noise model, the Pareto-Optimal set P is determined in step 2705, the convex-hull set H is determined in step 2706, and the lookup table, such as Table 1, for the currently considered model is prepared for a range of target quantization-parameter values QP₁ₜor corresponding target distortion values Dₜ as described above with reference to FIGS. 19-26.

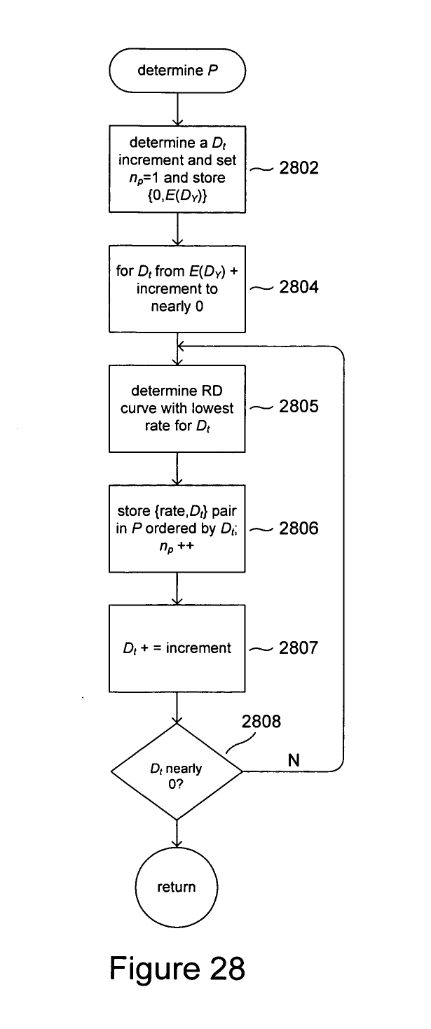

FIG. 28 is a control-flow diagram for the routine, called in step 2705 of FIG. 27, for constructing a Pareto-Optimal set P. In step 2802, a target distortion Dₜ increment, or corresponding target quantization-parameter increment QTₜ, is determined, and the current size of the Pareto-Optimal set P, nₚ, is set to 1. The Pareto-Optimal set P is initialized to include the first Pareto-Optimal point [0, E(D_{Y})]. Next, in the for-loop comprising steps 2804-2808, rate/distortion pairs {rate, Dₜ} are determined for each target distortion Dₜ in the range from (E(D_{Y})+increment) to a distortion approaching zero. In step 2805, the rate/distortion curve with lowest rate for the currently considered distortion target Dₜ is determined, and, in step 2806, the rate/distortion pair {rate, Dₜ} that represents the intersection of a horizontal line including currently considered target distortion Dₜ with the selected rate/distortion curve in step 2805, is added to the Pareto-Optimal set P, ordered by Dₜ, and nₚ is incremented. Finally, in step 2807, the currently considered target distortion rate Dₜ is incremented, and the for-loop continues with a subsequent iteration when the incremented value Dₜ is not yet nearly zero, as determined in step 2808. The terms “nearly zero,” or “approaching zero,” indicate that a lowest target distortion min (Dₜ) corresponds to a value that approaches 0 as the encoding rate→∞.

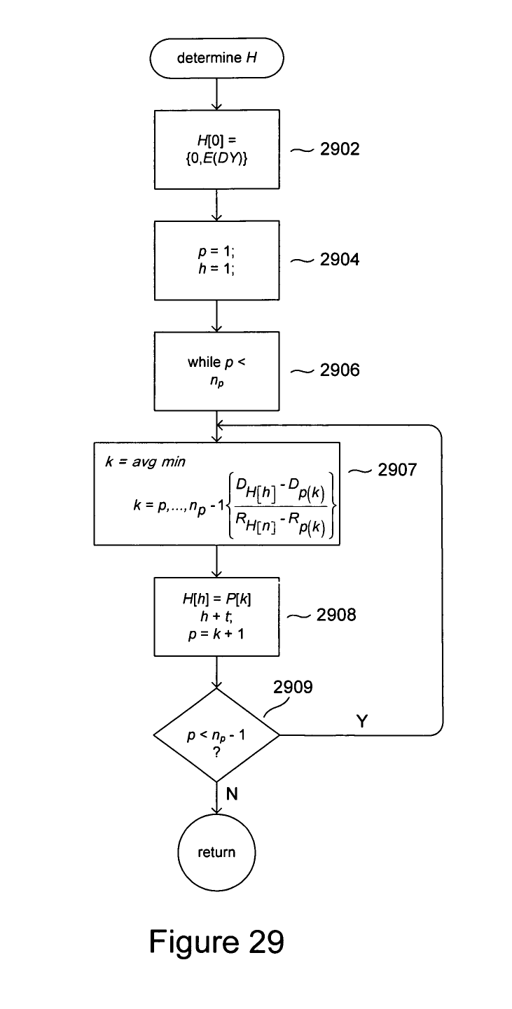

FIG. 29 is a control-flow diagram for the routine, called in step 2706 in FIG. 27, for determining the convex-hull set H. First, in step 2902, the first convex-hull point H[0] is set to the highest-distortion Pareto-Optimal point within the analyzed set of fixed QP/M curves, {0, E(D_{Y}),}. Next, the local variables p and h are set to the value “1” in step 2904. Then, in the while-loop of steps 2906-2909, each additional convex-hull point is determined and added to the convex-hull-set H. In step 2907, the index k for the next convex-hull point within the Pareto-Optimal set P is determined by selecting the Pareto-Optimal-set point located at the steepest angle of descent from most recently added convex-hull point H[h]. In step 2908, the selected point, indexed by k, is added to the convex-hull set, h is incremented, and p is incremented to the index of the Pareto-Optimal-set point following the Pareto-Optimal-set point indexed by k. The for-loop continues while there are still Pareto-Optimal points left to consider, as determined in step 2909.

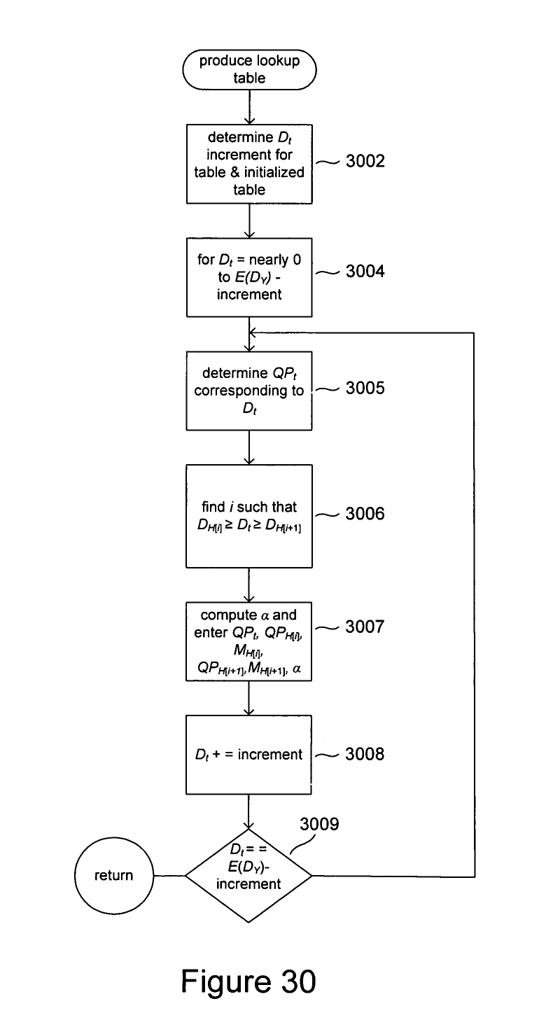

FIG. 30 is a control-flow diagram for the routine called in step 2707 in FIG. 27. In step 3002, a suitable Dₜ increment for the lookup table to be prepared is determined, and a new lookup table is initialized. A suitable increment is determined as the precision by which target distortions need to be computed by the memoryless-closet-based encoding method. In the for-loop of steps 3004 to 3009, a lookup-table entry is prepared for each possible target distortion in the range of target distortions of from nearly zero to E(D_{Y}). For each target distortion, the corresponding QPₜ is determined, in step 3005, and the bracketing convex-hull points H[i] and H[i+1] are determined in step 3006. Then, in step 3007, the parameters α, QP_{H[i]}, M_{H[i]} and QP_{H[i+1]}, and M_{H[i+1]} are determined by the method discussed with reference to FIG. 26 and entered into the lookup table. In step 3008, Dₜ is incremented by the Dₜ increment determined in step 3002, and the for-loop continues in a next iteration unless the incremented Dₜ is equal to (E(D_{Y})—the Dₜ increment), as determined in step 3009.

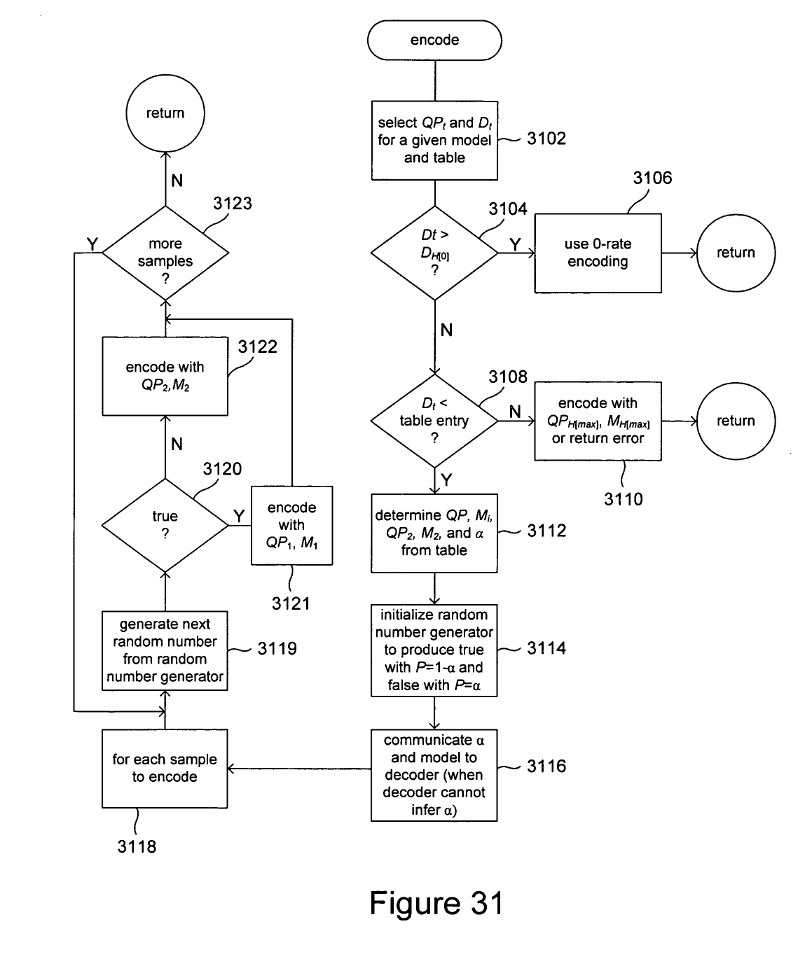

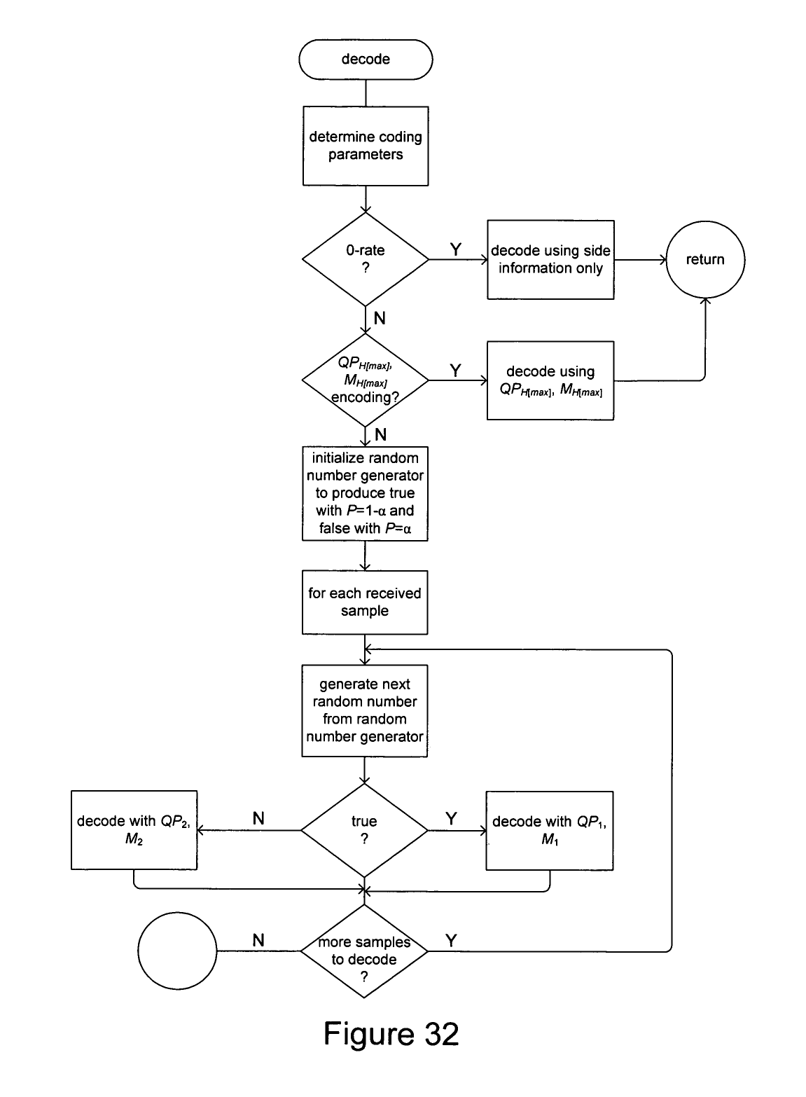

FIGS. 31-32 are control-flow diagrams that illustrate a combination-memoryless-closet-based-coding method. FIG. 31 illustrates memoryless-closet-based encoding, and FIG. 32 illustrates corresponding memoryless-closet-based decoding.

The memoryless-based-encoding method begins, in step 3102, by selection of a target distortion Dₜ and corresponding target quantization parameter QPₜ for the given source and noise model. If the target distortion Dₜ is greater than the zero-rate distortion, as determined in step 3104, then a zero-rate encoding technique is employed in step 3106. Otherwise, if the target distortion Dₜ is less than any target distortion listed in the lookup table, as determined in step 3108, then either encoding of the next sample is carried out with a single memoryless-closet-based encoding method parameterized with default, minimum-distortion parameters QP_{H[max]}, M_{H[max]} or an error is returned, depending on which of alternative embodiments are desired, in step 3110. Otherwise, in step 3112, the target distortion Dₜ is matched to the closest target distortion or corresponding QPₜ in the lookup table, and the entry with the closest target distortion or QP parameter is accessed to recover the above-discussed parameters α, QPᵢ, Mᵢ, QPᵢ₊₁, and Mᵢ₊₁. Then, in step 3114, the pseudo-random-number generator used by the encoder is initialized to produce Boolean value TRUE with a probability 1-α and Boolean value FALSE with a probability a, as discussed above with reference to FIG. 26. The quantization parameters, or target distortion Dₜ, and model information, may need to be transferred to the decoder or to the storage medium, in step 3116, if the decoder lacks sufficient information to infer this information. Then, in the for-loop of steps 3118-3123, a series of samples is encoded, one sample each iteration of the for-loop, by generating a next pseudo-random-number-generator generated Boolean value, in step 3119, and, depending on the Boolean value returned by the pseudo-random-number generator in step 3119, as considered in step 3120, employing a memoryless-closet-based encoding parameterized either by QPᵢ, Mᵢ, or QPᵢ₊₁, Mᵢ₊₁, in steps 3121 and 3122. The for-loop continues until there are no more samples to encode, as determined in step 3123.

FIG. 32 illustrates the decoding process for a decoding process for a combination-memoryless-closet-based-coding method. The steps in FIG. 32 essentially mirror the steps of FIG. 31, differing primarily in that that the decoding process decodes encoded samples with parameters QPᵢ, Mᵢ, or QPᵢ₊₁, Mᵢ₊₁, depending on the Boolean value returned by the random-number generator in each iteration of a decoding for-loop, rather than encoding uncoded samples, in the case of the combination-memoryless-closet-based-coding method illustrated in FIG. 31.

Optimal parameter choice for a set of N random variables: X₀, X₁, . . . , X_{N-1}, where X is assumed to have variance σ²_{X}_{ᵢ} and the corresponding side information Yᵢ is obtained by: Yᵢ=Xᵢ+Zᵢ, where Zᵢ is i.i.d. additive Gaussian with variance σ²_{Z}_{ᵢ}, is also possible. Such situations arise in various, orthogonal transform coding scenarios, where each frequency can be modeled with different statistics. The expected distortion is then the average (sum/N) of the distortions for each Xᵢ and the expected rate is the sum of the rates for each Xᵢ. In order to make an optimal parameter choice, individual convex-hull curves are generated for each i. Using typical Lagrangian optimization techniques, the optimal solution for a given total rate or distortion target is obtained when points from the individual convex hull R-D curves are chosen to have the same local slope A. The exact value of X may be searched by bisection search or a similar method to yield the distortion target or the rate target. Note that, since the convex hulls are piecewise linear, the slopes are decreasing piecewise constants in most parts. Therefore, interpolation of the slopes is necessary under the assumption that the virtual slope function holds its value as the true slope of a straight segment only at its mid-point.

A Family of Combination-Distributed-Coding Methods

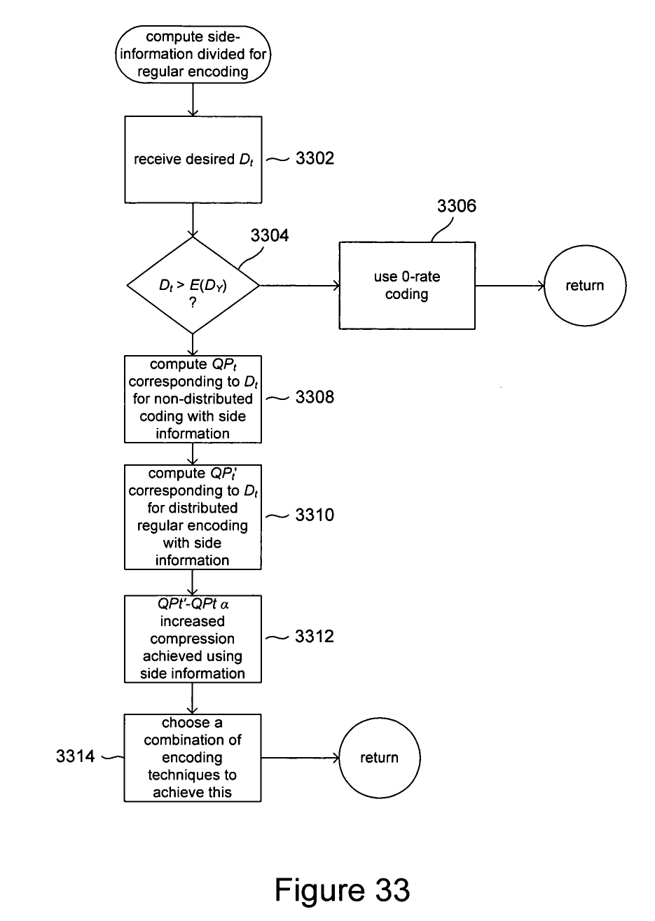

In the above discussion, coding methods that employ multiple memoryless-closet-based encoding schemes to achieve optimal encoding are described. Next, a more general encoding technique that takes advantage of the many different, sophisticated source and channel encoding methods developed over the years is discussed. FIG. 33 is a control-flow diagram that generally illustrates a concept underlying a second family of combination-encoding method embodiments for optimally encoding a sequence of samples using existing source-coding and channel-coding techniques. In step 3302, a desired distortion Dₜ is determined or received. This is a primary parameter that characterizes the performance of the selected multi-encoding-technique method. If the desired distortion Dₜ is greater than the zero-rate-encoding distortion, as determined in step 3304, then zero-rate-encoding is used, in step 3306, for encoding all samples in a sequence of samples. In essence, there is no point using sophisticated combination-encoding methods when the target distortion is greater than that that can be achieved by zero-rate encoding. Otherwise, in step 3308, the parameter QP, corresponding to the target distortion Dₜ is determined for non-distributed, regular without side information or, in other words, the encoding technique described by encoded/decoded pair 1822 in FIG. 18. Then, in step 3310, the quantization parameter QPₜ′ for distributed encoding, or, in other words, the encoding technique represented by encoder/decoder pair 1814 in FIG. 18, is computed to give the same target distortion Dₜ. In step 3312, the difference between QPₜ′ and QPₜ is computed, and that difference is proportional to the increased compression that can be achieved by using a combination of known encoding techniques. Finally, in step 3314, a combination of encoding techniques is chosen in order to achieve the increased compression that can be obtained by using distributed encoding with side information.

Table 2, provided below, illustrates the relaxation in the QP parameter that can be obtained when the ideal, distributed coding with side information can be achieved. In Table 2, the parameter QP, corresponds to the desired distortion Dₜ for non-distributed coding without side information. The corresponding values in the column QP indicate the increase in the parameter QP that is theoretically possible when optimal distributed regular encoding with side information is employed. The problem is to determine a method for achieving this optimal distributed regular encoding with side information.

TABLE 2

| QPₜ | Dₜ | QP | D |
|---|---|---|---|
| 0.05 | 0.00025 | 0.05002 | 0.00025 |
| 0.10 | 0.00115 | 0.10023 | 0.00115 |
| 0.15 | 0.00287 | 0.15095 | 0.00287 |
| 0.20 | 0.00556 | 0.20257 | 0.00556 |
| 0.25 | 0.00930 | 0.25553 | 0.00930 |
| 0.30 | 0.01415 | 0.31034 | 0.01415 |
| 0.35 | 0.02016 | 0.36758 | 0.02016 |
| 0.40 | 0.02731 | 0.42790 | 0.02731 |
| 0.45 | 0.03562 | 0.49208 | 0.03562 |
| 0.50 | 0.04503 | 0.56072 | 0.04503 |
| 0.55 | 0.05553 | 0.63525 | 0.05553 |
| 0.60 | 0.06704 | 0.71737 | 0.06704 |
| 0.65 | 0.07953 | 0.80919 | 0.07953 |
| 0.70 | 0.09292 | 0.91409 | 0.09292 |
| 0.75 | 0.10715 | 1.03678 | 0.10715 |
| 0.80 | 0.12214 | 1.18524 | 0.12214 |
| 0.85 | 0.13783 | 1.37415 | 0.13783 |
| 0.90 | 0.15413 | 1.63595 | 0.15413 |
| 0.95 | 0.17099 | 2.07343 | 0.17099 |
| 1.00 | 0.18833 | ∞ | 0.18586 |
| 1.05 | 0.20608 | ∞ | 0.18586 |
| 1.10 | 0.22418 | ∞ | 0.18586 |
| 1.15 | 0.24255 | ∞ | 0.18586 |
| 1.20 | 0.26115 | ∞ | 0.18586 |

Symbol-Plane By Symbol-Plane Coding

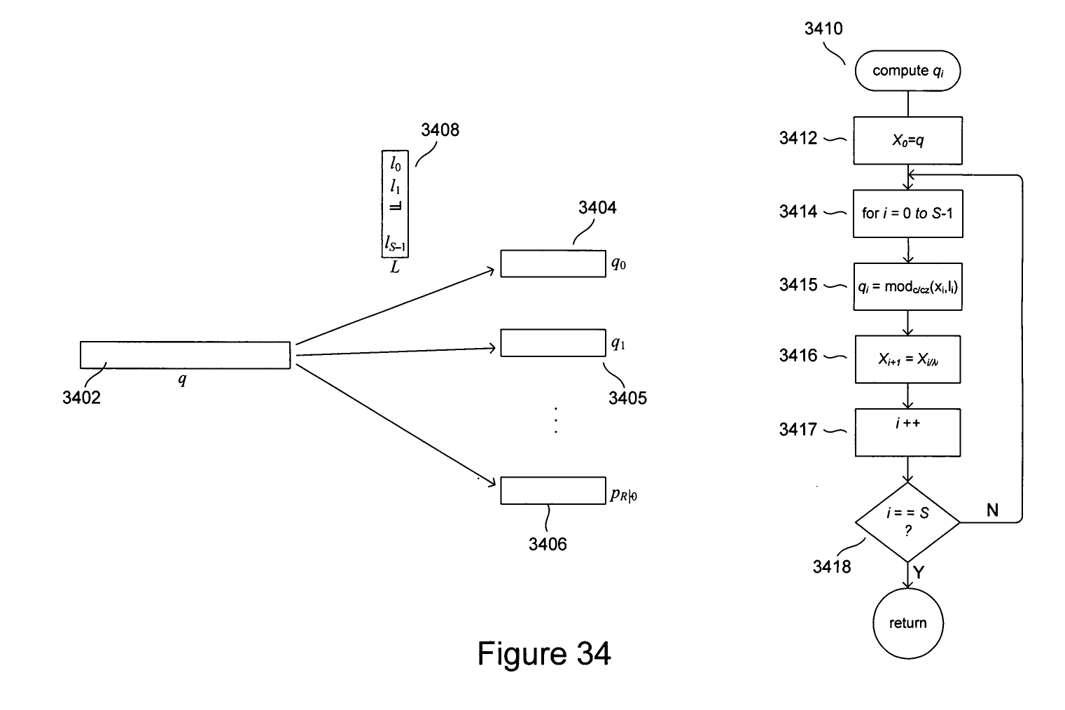

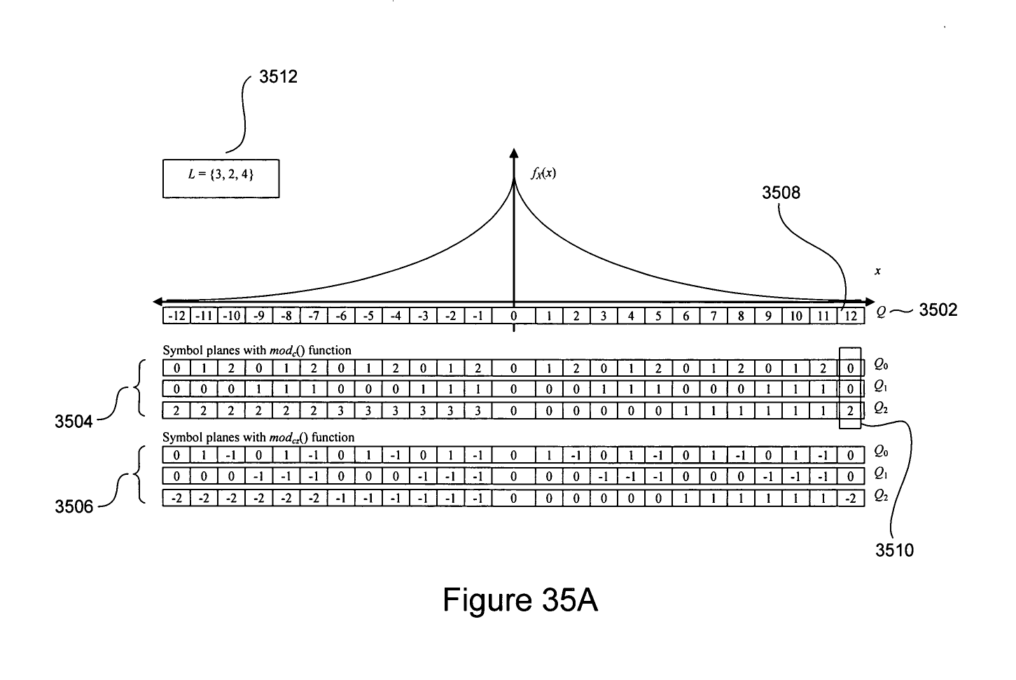

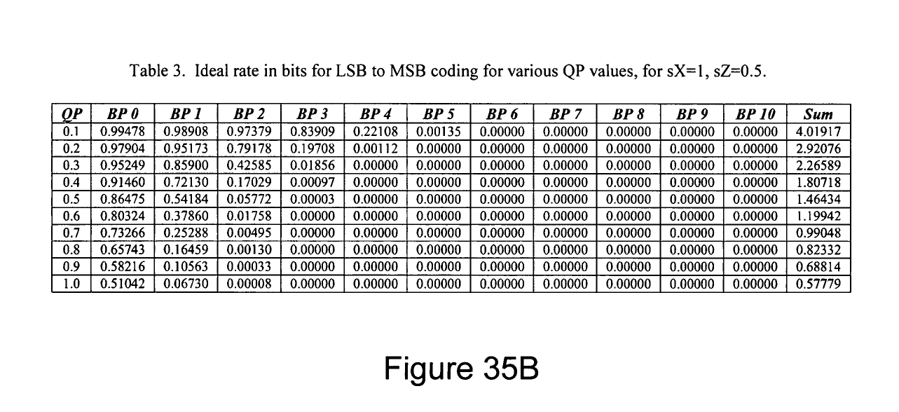

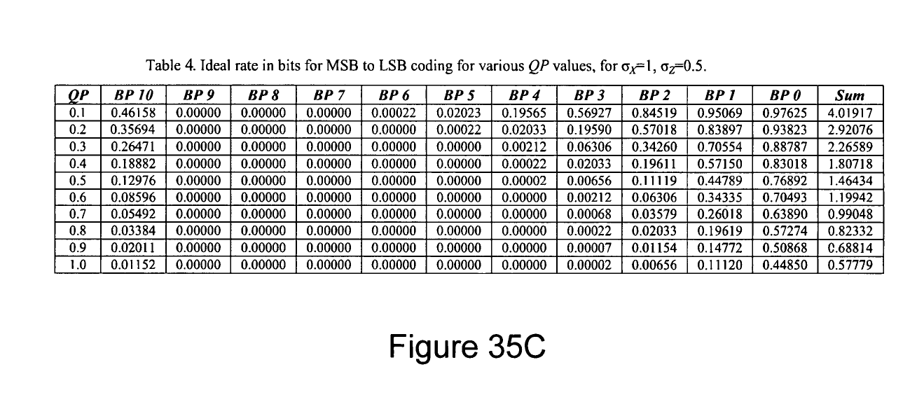

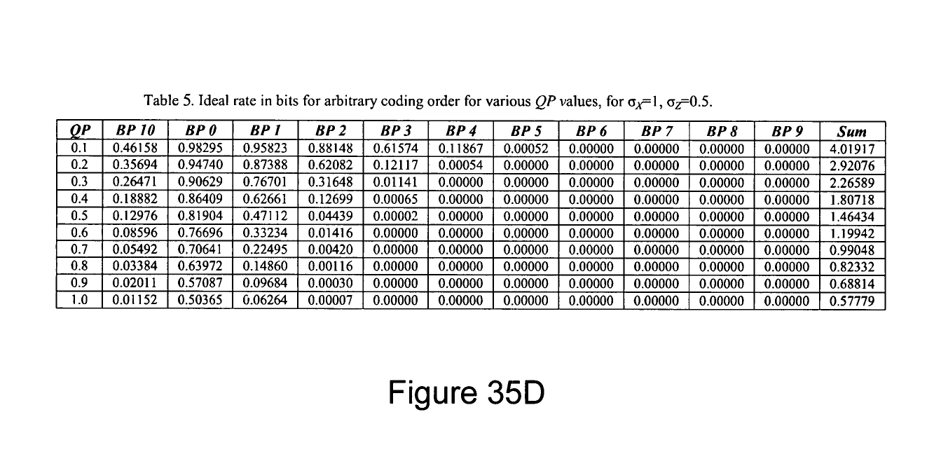

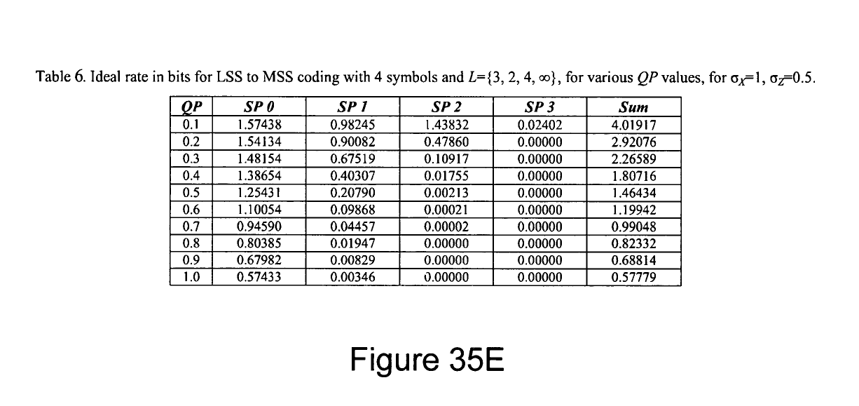

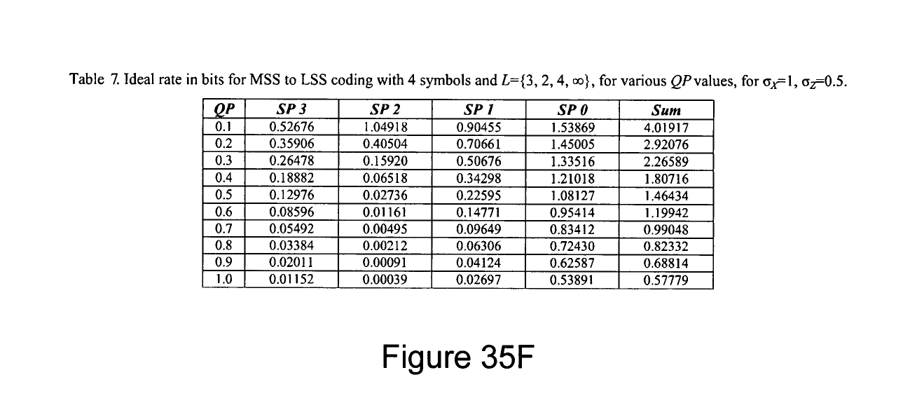

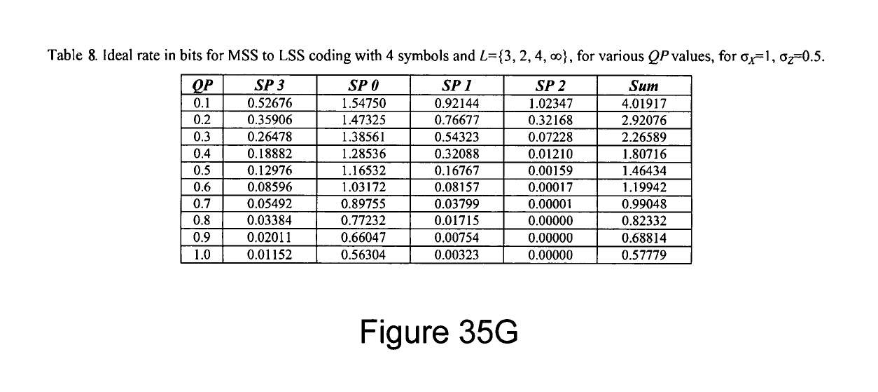

One approach for achieving the ideal-distributed-encoding-with-side-information efficiency employs symbol-plane-by-symbol-plane coding. FIGS. 34-35G illustrate symbol-plane-by-symbol-plane encoding concepts. As shown in FIG. 34, a particular quantization index 3402 can be transformed, or partitioned, into a sequence of sub-indices 3404-3406 {q₀, q₁, q_{S-1}}. This partitioning process is defined by an alphabet-size-vector L 3408. The elements of L, {l₀, l₁, . . . , l_{S-1}} each specify the alphabet size employed to generate corresponding quantization sub-indices. The control-flow diagram 3410 in FIG. 34 illustrates the sub-index-generating algorithm used to partition a quantization index q into an ordered set of sub-indices {q₀, q₁, . . . , qₛ₋₁}. First, the local variable x₀ is set to the original quantization index q, in step 3412. Then, in the for-loop comprising steps 3414-3418, each next quantization sub-index, characterized by the sub-index index i, from 0 to S−1, is generated. The next quantization sub-index q is obtained, in step 3415, by employing the circular modulus function mod_{c} or mod_{cz}, depending on the partitioning desired, with arguments xᵢ and lᵢ. Argument xᵢ is the most recently generated remainder computed in the following step 3416. The argument lᵢ is the (i+1)^{th} index of the alphabet-size vector L. A next remainder is generated in 3416, as discussed above, and the for-loop variable i is incremented, in step 3417. The for-loop continues until all of the S sub-indices corresponding to quantization index q have been generated.

FIG. 35A illustrates the symbol planes generated by the technique discussed, above, with reference to FIG. 34 using, in one case, the mod_{c} function, and, in another case, the mod_{c=}function. The original quantization indices 3502 are shown as an ordered sequence of values q just below the source probability density function. A first set of symbol planes 3504 corresponding to these quantization indices, and generated by the above-described technique using the mod_{c} function, appear next, and a final set of symbol planes 3506 generated using the mod_{cz} function follow. For a particular quantization index, such as quantization index 3508, the corresponding column 3510 in the symbol planes includes the sub-indices {q₀, q₁, . . . . , q_{S-1}}. In the case shown in FIG. 35, S=3, and the alphabet-size vector 3512 contains three elements.

One approach typically considered is to use bit-plane-by-bit-plane channel coding, where the alphabet sizes in L are 2, based on powerful systematic channel codes that span long sample sequences, for instance, Turbo, Low-delay Parity Check (LDPC) codes and Repeat-Accumulate (RA) codes. Specifically, the quantization index Q using quantization parameter QP for each sample is binarized up to a certain number of bit-planes. The binarized Q values of a typically long sequence of samples are stacked up, and for each bit-plane a systematic channel code of a certain rate is used to yield a set of parity bits that are transmitted in the bit-stream. The systematic bits are not sent, and left to be recovered from the side-information at the decoder, in conjunction with the parity bits. The rate allocation and corresponding decoding for each bit-plane involves the source and correlation model as well as the order in which the bit-planes are to be decoded at the decoder, but, in many currently proposed methods, this fact is not recognized and implementations are not designed for optimal bit-plane ordering.

A somewhat more generic version of this bit-plane coding approach is to allow decomposition of Q into an arbitrary number of symbols, each with an arbitrary alphabet size, as discussed above. Q is decomposed into S symbols {Q₀, Q₁, . . . , Q_{S-1}}, where a is the (i+1)^{th} least significant symbol (i.e. Q₀ is the least significant symbol, Q₁ is the second least significant symbol, and so on). In this case, Qᵢ ∈ Ω_{Q}={0,1, . . . , lᵢ−1} for i=0,1, . . . , S−1 when the mod_{c}-based partitioning is used, and Qᵢ ∈ Ω_{Q}={└−(lᵢ−1)/2┘, . . . , −1,0,1, . . . , └(lᵢ−1)2┘} for i=0,1, . . . , S−1 when the mod_{cz}-based partitioning is used. Note that since the source is infinite, in order for the S-tuple {Q₀, Q₁, . . . , Q_{S-1}} to provide the same information as Q, l_{S-}should be infinite in both of these cases. However, in practice, it is sufficient to only consider a finite value for l_{S-1} based on the value of qₘₐₓ, the maximum magnitude quantization index Q beyond which the probabilities of the bins are trivial. Specifically, as long as

Πl₁≧2qₘₐₓ+1,

the entropies H(Q)=H(Q₀,Q₁, . . . ,Q_{S-1}) can be considered. It is sometimes convenient to write one of the lᵢ's in L as ∞ to indicate that it is ideally ∞ but in practice as big as needed to ensure that there is negligible probability of information loss. The notation Qᵢ=ξᵢ^{L}(Q) is used to denote the mapping function from Q to the ith symbol Qᵢ, given the alphabet-size vector L={l₀, l₁, . . . , l_{S-1}}

Since the information in Q is identical to that in {Qᵢ} under the assumption Πlᵢ≧2qₘₐₓ+1, the distributed-coding rate can be decomposed as: H(Q/Y)=H (Q₀, Q₁, . . . ,Q_{S-1}/Y). If coding for the individual symbols is conducted from least to most significant symbols, then the obtained decomposition is:

$$\begin{matrix}H ( Q / Y ) = H ( {Q}_{0} , {Q}_{1} , … , {Q}_{S - 1} / Y ) \\ = H ( {Q}_{0} / Y ) + H ( {Q}_{1} / {Q}_{0} , Y ) + H ( {Q}_{2} / {Q}_{0} , {Q}_{1} , Y ) + \\ … + H ( {Q}_{S - 1} / {Q}_{0} , {Q}_{1} , … , {Q}_{S - 2} , Y )\end{matrix}$$

Each term corresponds to the ideal rate to be allocated for noiseless transmission of each symbol. However, to be able to achieve the rate needed for each symbol, the decoding of the symbols should be conducted in the same order—from the least to the most significant symbol and, furthermore, decoding each symbol should be based not only on the side information Y, but also on prior decoded symbols. Likewise, if the coding order of the symbols is from the most to the least significant symbol, then the obtained decomposition is:

$$\begin{matrix}H ( Q / Y ) = H ( {Q}_{0} , {Q}_{1} , … , {Q}_{S - 1} / Y ) \\ = H ( {Q}_{S - 1} / Y ) + H ( {Q}_{S - 2} / {Q}_{S - 1} , Y ) + \\ H ( {Q}_{S - 3} / {Q}_{S - 1} , {Q}_{S - 2} , Y ) + … + \\ H ( {Q}_{0} / {Q}_{S - 1} , {Q}_{S - 2} , … , {Q}_{1} , Y )\end{matrix}$$

In general, coding of symbols can be conducted in any order, but, for each order, the rate allocation per symbol generally differs, and so also the decoding.

In order to exactly compute the rate allocation for a symbol i, given a subset of symbols already transmitted, the conditional entropy H(Qᵢ/{Qₖ:k ∈ Gᵢ},Y) is generally computed, where Gᵢ is the set of indices corresponding to symbols that are to be transmitted prior to symbol Qᵢ. For example, when the coding order is from the least significant symbol to the most significant symbol:

G₀={ }, G₁={0}, G₂={0,1}, . . . , G_{S-1}={0,1, . . . , S−2}.

This conditional entropy can be written as:

$$H ( {Q}_{i} / \{ {Q}_{k} ∷ k ∈ {G}_{i} \} , Y ) = {\int }_{- ∞}^{∞} ( {{\sum }_{{q}_{k} ∈ {Ω}_{{Q}_{k}}}}_{∀ k ∈ {G}_{i}} \begin{matrix}[ \begin{matrix}{\sum }_{{q}_{i} ∈ {Ω}_{{Q}_{i}}} p ( {Q}_{i} = {q}_{i} / \{ {Q}_{k} = {q}_{k} ∷ k ∈ {G}_{i} \} , Y = y ) \\ {log}_{2} \frac{1}{p ( {Q}_{i} = {q}_{i} / \{ {Q}_{k} = {q}_{k} ∷ k ∈ {G}_{i} \} , Y = y )}\end{matrix} ] \\ \times p ( \{ {Q}_{k} = {q}_{k} ∷ k ∈ {G}_{i} \} / Y = y )\end{matrix} ) {f}_{Y} ( y ) d y = {\int }_{- ∞}^{∞} ( {{\sum }_{{q}_{k} ∈ {Ω}_{{Q}_{k}}}}_{∀ k ∈ {G}_{i}} \begin{matrix}[ \begin{matrix}{\sum }_{{q}_{i} ∈ {Ω}_{{Q}_{i}}} \frac{p ( \{ {Q}_{k} = {q}_{k} ∷ k ∈ {G}_{i} ⋃ \{ i \} \} / Y = y )}{p ( \{ {Q}_{k} = {q}_{k} ∷ k ∈ {G}_{i} \} / Y = y )} \\ {log}_{2} \frac{p ( \{ {Q}_{k} = {q}_{k} ∷ k ∈ {G}_{i} \} / Y = y )}{p ( \{ {Q}_{k} = {q}_{k} ∷ k ∈ {G}_{i} ⋃ \{ i \} \} / Y = y )}\end{matrix} ] \\ \times p ( \{ {Q}_{k} = {q}_{k} : k ∈ {G}_{i} \} / Y = y )\end{matrix} ) {f}_{Y} ( y ) d y = {\int }_{- ∞}^{∞} ( {{\sum }_{{q}_{k} ∈ {Ω}_{{Q}_{k}}}}_{∀ k ∈ {G}_{i}} [ \begin{matrix}{\sum }_{{q}_{i} ∈ {Ω}_{{Q}_{i}}} p ( \{ {Q}_{k} = {q}_{k} ∷ k ∈ {G}_{i} ⋃ \{ i \} \} / Y = y ) \\ {log}_{2} \frac{p ( \{ {Q}_{k} = {q}_{k} ∷ k ∈ {G}_{i} \} / Y = y )}{p ( \{ {Q}_{k} = {q}_{k} ∷ k ∈ {G}_{i} ⋃ \{ i \} \} / Y = y )}\end{matrix} ] ) {f}_{Y} ( y ) d y = {\int }_{- ∞}^{∞} ( {{\sum }_{{q}_{k} ∈ {Ω}_{{Q}_{k}}}}_{∀ k ∈ {G}_{i} ⋃ \{ i \}} [ \begin{matrix}p ( \{ {Q}_{k} = {q}_{k} ∷ k ∈ {G}_{i} ⋃ \{ i \} \} / Y = y ) \\ {log}_{2} \frac{p ( \{ {Q}_{k} = {q}_{k} ∷ k ∈ {G}_{i} \} / Y = y )}{p ( \{ {Q}_{k} = {q}_{k} ∷ k ∈ {G}_{i} ⋃ \{ i \} \} / Y = y )}\end{matrix} ] ) {f}_{Y} ( y ) d y$$

Noting that the conditional probability can be expressed as:

$$p ( \{ {Q}_{k} = {q}_{k} ∷ k ∈ {G}_{i} \} / Y = y ) = {\sum }_{{q ∈ {Ω}_{Q} ∷}_{{ξ}_{k}^{L} ( q ) = {q}_{k} ∀ k ∈ {G}_{i}}} π ( q , y ) = {\sum }_{{q ∈ {Ω}_{Q} ∷}_{{ξ}_{k}^{L} ( q ) = {q}_{k} ∀ k ∈ {G}_{i}}} {\int }_{{x}_{l} ( q )}^{{x}_{h} ( q )} {f}_{X / Y} ( x , y ) d x = {\sum }_{{q ∈ {Ω}_{Q} ∷}_{{ξ}_{k}^{L} ( q ) = {q}_{k} ∀ k ∈ {G}_{i}}} [ {m}_{X / Y}^{( 0 )} ( {x}_{h} ( q ) , y ) - {m}_{X / Y}^{( 0 )} ( {x}_{l} ( q ) , y ) ]$$

the conditional entropy is given by:

$$H ( {Q}_{i} / \{ {Q}_{k} ∷ k ∈ {G}_{i} \} , Y ) = {\int }_{- ∞}^{∞} ( {{\sum }_{{q}_{k} ∈ {Ω}_{{Q}_{k}}}}_{∀ k ∈ {G}_{i} ⋃ \{ i \}} [ \begin{matrix}( {\sum }_{{q ∈ {Ω}_{Q} ∷}_{{ξ}_{k}^{L} ( q ) = {q}_{k} ∀ k ∈ {G}_{i} ⋃ \{ i \}}} π ( q , y ) ) {log}_{2} \\ \frac{( {\sum }_{{q ∈ {Ω}_{Q} ∷}_{{ξ}_{k}^{L} ( q ) = {q}_{k} ∀ k ∈ {G}_{i}}} π ( q , y ) )}{( {\sum }_{{q ∈ {Ω}_{Q} ∷}_{{ξ}_{k}^{L} ( q ) = {q}_{k} ∀ k ∈ {G}_{i} ⋃ \{ i \}}} π ( q , y ) )}\end{matrix} ] ) {f}_{Y} ( y ) d y = {\int }_{- ∞}^{∞} ( {{\sum }_{{q}_{k} ∈ {Ω}_{{Q}_{k}}}}_{∀ k ∈ {G}_{i} ⋃ \{ i \}} [ \begin{matrix}( {\sum }_{{q ∈ {Ω}_{Q} ∷}_{{ξ}_{k}^{L} ( q ) = {q}_{k} ∀ k ∈ {G}_{i} ⋃ \{ i \}}} [ \begin{matrix}{m}_{X / Y}^{( 0 )} ( {x}_{h} ( q ) , y ) - \\ {m}_{X / Y}^{( 0 )} ( {x}_{l} ( q ) , y )\end{matrix} ] ) {log}_{2} \\ \frac{( {\sum }_{{q ∈ {Ω}_{Q} ∷}_{{ξ}_{k}^{L} ( q ) = {q}_{k} ∀ k ∈ {G}_{i}}} [ \begin{matrix}{m}_{X / Y}^{( 0 )} ( {x}_{h} ( q ) , y ) - \\ {m}_{X / Y}^{( 0 )} ( {x}_{l} ( q ) , y )\end{matrix} ] )}{( {\sum }_{{q ∈ {Ω}_{Q} ∷}_{{ξ}_{k}^{L} ( q ) = {q}_{k} ∀ k ∈ {G}_{i} ⋃ \{ i \}}} [ \begin{matrix}{m}_{X / Y}^{( 0 )} ( {x}_{h} ( q ) , y ) - \\ {m}_{X / Y}^{( 0 )} ( {x}_{l} ( q ) , y )\end{matrix} ] )}\end{matrix} ] ) {f}_{Y} ( y ) d y$$

This entropy can be readily calculated based on the expressions for the partial moments discussed above, in conjunction with numerical integration over y. Note that even though the expressions look formidable, they are fairly straight-forward to compute.

FIGS. 35B-D show, as Tables 3-5, examples of the ideal bit-plane-by-bit-plane rate allocation for a Laplacian σ_{X}=1 source and Gaussian σ_{Z}=0.5 noise model. Table 3, in FIG. 35B, shows an allocation for LSB to MSB coding. Table 4, in FIG. 35c, shows an allocation for MSB to LSB coding. Table 5, in FIG. 35D, shows an allocation for an arbitrary coding order (first MSB followed by LSB, second LSB, and so on). In each table, the columns are ordered according to the order of coding of the bit-planes. The tables also provide the total conditional entropy or the ideal distributed-coding rate in the column labeled “Sum,” which is the sum of the rates for the individual bit-planes. Note that this value across different tables for the same QP is the same, regardless of the coding order.

FIGS. 35E-G show, as Tables 6-8, similar results for symbol-based coding, assuming only 4 symbols, with the alphabet-size vector being given by {3, 2, 4, 100}. The Laplacian source and Gaussian correlation model is given by σ_{X}=1, σ_{Z}=0.5. Table 6, in FIG. 35E, shows the ideal rate for LSS (least significant symbol) to MSS (most significant symbol) coding. Table 7, in FIG. 35F, shows the ideal rate for MSS to LSS coding. Table 8, in FIG. 35G, shows the ideal rates for an arbitrary order.

While the conditional entropy results are presented for arbitrary symbol decomposition, in a practical scenario, it is convenient to choose alphabet-sizes for each symbol to be 2, or at most small powers of 2. The case where each lᵢ=2 corresponds to the popular bit-plane by bit-plane coding case, where extensive prior knowledge on behavior and performance of binary error-correction codes can be brought to bear.

Coding of each symbol plane in the pre-determined order is conducted by use of a systematic channel code, where only the parity information is transmitted. The amount of parity information sent should be at least as much as the conditional entropy, expressions for which are provided above, in order to ensure noise-free decoding. However, since noise-free transmission is achievable only for very large block lengths, it is necessary to add a margin to the computed ideal rate. The margin may depend on the expected length of a block specific to a given application, the complexity of the code, as well as the impact of an error in decoding a symbol to the overall distortion. The margin can be a multiplicative factor, denoted γᵢ for the symbol Qᵢ, of the ideal rate. The rate allocated for channel coding rᵢ^{CC}, where “CC” stands for channel coding, is then given by:

rᵢ^{CC}=(γᵢ+1)H (Qᵢ/{Qₖ:k ∈ Gᵢ},Y)

where γᵢ>0.

The encoding rate needed to transmit a symbol plane noise-free with only source coding conditioned on previously transmitted symbol planes is next considered. This rate, denoted rᵢ^{SC}, where “SC” stands for source coding, is given by the conditional entropy H(Qᵢ/{Qₖ:k ∈ Gᵢ}) as follows:

$$\begin{matrix}{r}_{i}^{SC} = H ( {Q}_{i} / \{ {Q}_{k} : k ∈ {G}_{i} \} ) \\ = {\sum }_{{{q}_{k} ∈ {Ω}_{Qk}}_{∀ k ∈ {G}_{i} ⋃ ( i )}} [ ( {\sum }_{{q ∈ {Ω}_{Q} :}_{{ξ}_{k}^{L} ( q ) = {q}_{k} ∀ k ∈ {G}_{i} ⋃ ( i )}} π ( q , y ) ) \\ {log}_{2} \frac{( {\sum }_{{q ∈ {Ω}_{Q} :}_{{ξ}_{k}^{L} ( q ) = {q}_{k} ∀ k ∈ {G}_{i}}} π ( q , y ) )}{( {\sum }_{{q ∈ {Ω}_{Q} :}_{{ξ}_{k}^{L} ( q ) = {q}_{k} ∀ k ∈ {G}_{i} ⋃ ( i )}} π ( q , y ) )} ] \\ = {\sum }_{{{q}_{k} ∈ {Ω}_{Qk}}_{∀ k ∈ {G}_{i} ⋃ ( i )}} [ ( {\sum }_{{q ∈ {Ω}_{Q} :}_{{ξ}_{k}^{L} ( q ) = {q}_{k} ∀ k ∈ {G}_{i} ⋃ ( i )}} [ {m}_{X}^{( 0 )} ( {x}_{k} ( q ) ) - {m}_{X}^{( 0 )} ( {x}_{i} ( q ) ) ] ) \\ {log}_{2} \frac{( {\sum }_{{q ∈ {Ω}_{Q} :}_{{ξ}_{k}^{L} ( q ) = {q}_{k} ∀ k ∈ {G}_{i}}} [ {m}_{X}^{( 0 )} ( {x}_{h} ( q ) ) - {m}_{X}^{( 0 )} ( {x}_{i} ( q ) ) ] )}{( {\sum }_{{q ∈ {Ω}_{Q} :}_{{ξ}_{k}^{L} ( q ) = {q}_{k} ∀ k ∈ {G}_{i} ⋃ ( i )}} [ {m}_{X}^{( 0 )} ( {x}_{k} ( q ) ) - {m}_{X}^{( 0 )} ( {x}_{i} ( q ) ) ] )} ]\end{matrix}$$

This rate can be practically achieved by context-adaptive entropy coding, including arithmetic coding.

Even though H(Qᵢ/{Qₖ:k ∈ Gᵢ},Y)≦H(Qᵢ/{Qₖ:k ∈ Gᵢ}), the margin requirement for the practical channel coding case may make it possible that rᵢ^{SC}≦rᵢ^{CC}. In this case, just source coding should be used instead of channel coding.

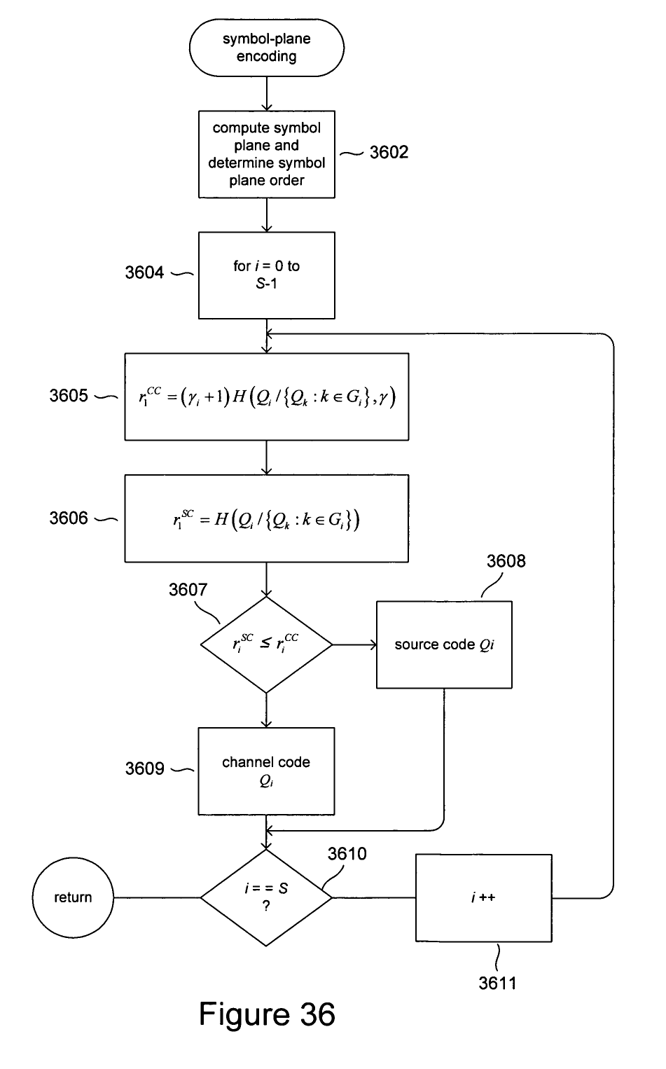

FIG. 36 is a control-flow diagram that illustrates a symbol-plane-by-symbol-plane-based combination-encoding method. In step 3602, a symbol-plane order for encoding is determined. Next, in the for-loop of steps 3604-3611, each symbol plane computed for the quantization indices of a sample is encoded in the determined symbol-plane order. In step 3605, the expected rate for channel coding rcc is s determined, and in step 3606, the expected rate for source coding rᵢ^{SC} is computed. If rᵢ^{SC} is less than or equal to rᵢ^{CC}, as determined in step 3607, then the symbol plane is encoded using a selected source-code technique, in step 3608. Otherwise, the symbol plane is encoded using a selected channel-code technique, in step 3609. The for-loop continues until all symbol planes have been encoded, as determined in step 3610.

There is one caveat in the use of conditional source coding for symbol planes other than the first. In order to enable correct decoding of a source coded symbol plane, it is assumed that the channel coded symbol planes transmitted prior to this plane have been decoded noise-free. While this can be ensured by having big enough margins, a more robust alternative is to use, as context for source coding, only the previously transmitted source coded planes, but not channel coded planes. In this case, the source coding rate is given by the above expression for rᵢ^{SC} , where Gᵢ represents the set of indices of previously transmitted source coded symbol planes, rather than the set of indices of all previously transmitted symbol planes. Naturally, this leads to loss of compression efficiency, although there is no difference in the two approaches for the first symbol plane transmitted. The source coding rate in this case is given by the unconditional entropy of the symbol:

$$\begin{matrix}{r}_{i}^{SC} = H ( {Q}_{i} ) \\ = - {\sum }_{{q}_{i} ∈ {Ω}_{Qi}} ( {\sum }_{{q ∈ {Ω}_{Q} :}_{{ξ}_{i}^{L} ( q ) = {q}_{i}}} π ( q , y ) ) {log}_{2} ( {\sum }_{{q ∈ {Ω}_{Q} :}_{{ξ}_{i}^{L} ( q ) = {q}_{i}}} π ( q , y ) ) \\ = - {\sum }_{{q}_{i} ∈ {Ω}_{Qi}} ( {\sum }_{{q ∈ {Ω}_{Q} :}_{{ξ}_{i}^{L} ( q ) = {q}_{i}}} [ {m}_{X}^{( 0 )} ( {x}_{k} ( q ) ) - {m}_{X}^{( 0 )} ( {x}_{i} ( q ) ) ] ) \\ {log}_{2} ( {\sum }_{{q ∈ {Ω}_{Q} :}_{{ξ}_{i}^{L} ( q ) = {q}_{i}}} [ {m}_{X}^{( 0 )} ( {x}_{k} ( q ) ) - {m}_{X}^{( 0 )} ( {x}_{i} ( q ) ) ] )\end{matrix}$$

Since the rates needed for channel-coded planes are arbitrary, it is inconvenient to design different codes for every possible rate. Furthermore, in many applications, the number of samples to be transmitted is variable and not known a priori. In such cases, puncturing should be used. Only certain systematic codes at fixed rates should be designed, and the intermediate rate codes are derived from the next higher rate code by removing an appropriate number of parity bits. The total number of parity bits to be transmitted for symbol plane Qᵢ, is given by Nₛₐₘₚₗₑₛ×rᵢ^{CC}. If the number of parity bits with the next higher rate code is N_{parity}, then N_{parity}−Nₛₐₘₚₗₑₛ×rᵢ^{CC} parity bits must be removed. Parity bits can be removed at regular intervals, so that Nₛₐₘₚᵢₑₛ×rᵢ^{CC} bits are eventually transmitted.

Even though an i.i.d. model is assumed in this discussion, for correlated sources, the actual source coding rate can be much less than that given by the above expressions for rᵢ^{SC}. Sophisticated modeling is often used in source coding to reduce the bit-rate, even when the residual correlation is limited. On the other hand, for channel coding, the correlation between neighboring samples is much harder to exploit. While there exists a framework to exploit these correlations using decoding on graphs, such decoders can be quite complicated to implement in practice with robust enough convergence characteristics. Therefore, in the general case, instead of using the above expressions for rᵢ^{SC} to estimate the source coding rate, an actual source coder may be used, and the actual rate produced may be considered in deciding whether to use source coding or channel coding. In other words, if the rate required for channel coding to reliably decode a plane is less than the rate required with an actual source coder, only then channel coding should be used.

For decoding, a soft input decoder may be used. Such a decoder takes, as input, a priori soft probabilities of systematic and parity symbols for a block in order to perform the decoding, and outputs either a hard-decision about the symbols, such as by using the Viterbi algorithm, or a soft-decision yielding the posteriori probability mass function of each symbol, such as by using the BCJR algorithm. Both cases are discussed below.

In the soft-input hard-output case case, the prior probabilities for the systematic symbols in any plane are obtained based on the side information y, and knowledge of previously hard-decoded symbol planes. Thus, for decoding the symbol plane Qᵢ, given previously decoded symbols {Qₖ=qₖ:k ∈ Gᵢ} and side-information Y=y, the prior probability of Qᵢ=qᵢ ∈ Ω_{Q}_{ᵢ}, denoted {p^{(prior)}(Qᵢ=qᵢ): qᵢ ∈ Ω_{Q}_{ᵢ}} are given by:

$$\begin{matrix}{p}^{( prior )} ( {Q}_{i} = {q}_{i} ) = p ( {Q}_{i} = {q}_{i} / \{ {Q}_{k} = {q}_{k} : k ∈ {G}_{i} \} , Y = y ) \\ = \frac{p ( \{ {Q}_{k} = {q}_{k} : k ∈ {G}_{i} ⋃ \{ i \} \} / Y = y )}{p ( \{ {Q}_{k} = {q}_{k} : k ∈ {G}_{i} \} / Y = y )} \\ = \frac{{\sum }_{{q ∈ {Ω}_{Q} :}_{{ξ}_{k}^{L} ( q ) = {q}_{k} ∀ k ∈ {G}_{i} ⋃ ( i )}} π ( q , y )}{{\sum }_{{q ∈ {Ω}_{Q} :}_{{ξ}_{k}^{L} ( q ) = {q}_{k} ∀ k ∈ {G}_{i}}} π ( q , y )} \\ = \frac{{\sum }_{{q ∈ {Ω}_{Q} :}_{{ξ}_{k}^{L} ( q ) = {q}_{k} ∀ k ∈ {G}_{i} ⋃ ( i )}} [ {m}_{X / Y}^{( 0 )} ( {x}_{h} ( q ) , y ) - {m}_{X / Y}^{( 0 )} ( {x}_{i} ( q ) , y ) ]}{{\sum }_{{q ∈ {Ω}_{Q} :}_{{ξ}_{k}^{L} ( q ) = {q}_{k} ∀ k ∈ {G}_{i}}} [ {m}_{X / Y}^{( 0 )} ( {x}_{h} ( q ) , y ) - {m}_{X / Y}^{( 0 )} ( {x}_{i} ( q ) , y ) ]}\end{matrix}$$

Since the parity symbols are assumed to be transmitted noise-free, their prior probabilities are taken as unity for the received symbol and zero otherwise. A drawback of this approach is that, when an error has been made in decoding a symbol in one plane, the error can propagate to the rest of the symbol planes to be decoded. However, when a sufficiently conservative margin has been chosen, the probability of such errors is generally very small.

The soft-input decoder may also make a soft-decision about the symbol transmitted. In this case, the decoder for each plane returns the soft posteriori probability mass functions for the decoded symbols, denoted p^{(post)}(Qᵢ=qᵢ), qᵢ ∈ Ω_{Q}_{ᵢ}. An ability to use this soft information effectively for decoding the rest of the symbol planes can potentially lead to better decoding performance. Assuming that soft joint posteriori probability mass functions of previously decoded symbol planes, denoted p^{(post)}({Qₖ=qₖ:k ∈ Gᵢ}), are available, the prior probabilities comprising the soft input for decoding next plane a, may be obtained as:

$$\begin{matrix}{p}^{( prior )} ( {Q}_{i} = {q}_{i} ) = {\sum }_{\{ {q}_{k} ∈ {Ω}_{{Q}_{k}} : k ∈ {G}_{i} \}}^{ } {p}^{( post )} ( \{ {Q}_{k} = {q}_{k} : k ∈ {G}_{i} \} ) \cdot \\ p ( {Q}_{i} = {q}_{i} / \{ {Q}_{k} = {q}_{k} : k ∈ {G}_{i} \} , Y = y ) \\ = {\sum }_{\{ {q}_{k} ∈ {Ω}_{{Q}_{k}} : k ∈ {G}_{i} \}}^{ } {p}^{( post )} ( \{ {Q}_{k} = {q}_{k} : k ∈ {G}_{i} \} ) \cdot \\ \frac{{\sum }_{{q ∈ {Ω}_{Q} :}_{{ξ}_{k}^{L} ( q ) = {q}_{k} ∀ k ∈ {G}_{i} ⋃ ( i )}} π ( q , y )}{{\sum }_{{q ∈ {Ω}_{Q} :}_{{ξ}_{k}^{L} ( q ) = {q}_{k} ∀ k ∈ {G}_{i}}} π ( q , y )} \\ = {\sum }_{\{ {q}_{k} ∈ {Ω}_{{Q}_{k}} : k ∈ {G}_{i} \}}^{ } {p}^{( post )} ( \{ {Q}_{k} = {q}_{k} : k ∈ {G}_{i} \} ) \cdot \\ \frac{{\sum }_{{q ∈ {Ω}_{Q} :}_{{ξ}_{k}^{L} ( q ) = {q}_{k} ∀ k ∈ {G}_{i} ⋃ ( i )}} [ {m}_{X / Y}^{( 0 )} ( {x}_{h} ( q ) , y ) - {m}_{X / Y}^{( 0 )} ( {x}_{i} ( q ) , y ) ]}{{\sum }_{{q ∈ {Ω}_{Q} :}_{{ξ}_{k}^{L} ( q ) = {q}_{k} ∀ k ∈ {G}_{i}}} [ {m}_{X / Y}^{( 0 )} ( {x}_{h} ( q ) , y ) - {m}_{X / Y}^{( 0 )} ( {x}_{i} ( q ) , y ) ]}\end{matrix}$$

Once the decoder produces the soft outputs p^{(post)}(Qᵢ=qᵢ), the soft outputs are combined with the existing joint probabilities p^{(post)}({Qₖ=qₖ:k ∈ Gᵢ}) to obtain the updated joint probability distribution p^{(post)}({Qₖ=qₖ:k ∈ Gᵢ ∪ {i})) that includes the newly decoded symbol plane. Under the assumption of independence of the symbol planes, the joint posteriori probability distribution is the product of the distributions of the constituent symbol planes. The new joint distribution is then:

$$\begin{matrix}{p}^{( post )} ( \{ {Q}_{k} = {q}_{k} : k ∈ {G}_{i} ⋃ \{ i \} \} ) = {p}^{( post )} ( \{ {Q}_{k} = {q}_{k} : k ∈ {G}_{i} \} ) \times \\ {p}^{( post )} ( {Q}_{i} = {q}_{i} ) \\ = {\prod }_{k ∈ {G}_{i} ⋃ ( i )} {p}^{( post )} ( {Q}_{k} = {q}_{k} ) ,\end{matrix}$$

$$∀ {q}_{k} ∈ {Ω}_{{Q}_{k}} , k ∈ {G}_{i} ⋃ \{ i \}$$

This is next used to obtain the priors for decoding the next symbol plane. Once all symbol planes have been decoded, the soft posteriori probabilities for each quantization bin can be obtained, and a hard decision can be made.

While this approach mitigates the propagation of errors from symbol plane to symbol plane, it still does not enable correcting errors that have been made in a symbol plane. In order to enable that, the following iterative decoding strategy may be used. When all the symbol planes have been decoded once according to the above strategy, the posteriori probabilities of the individual symbol planes are obtained. Each symbol plane can be re-decoded in any order, where the prior is assumed to be computed based on the joint distribution of all symbol planes other than the symbol plane being decoded. The joint distribution is simply the product of the individual symbols under the independence assumption.

$$\begin{matrix}{p}^{( prior )} ( {q}_{i} = {q}_{i} ) = {\sum }_{\{ {q}_{k} ∈ {Ω}_{{Q}_{k}} : k ∈ \{ 0 , 1 , … , S - 1 \} \backslash \{ i \} \}} {p}^{( post )} ( \{ {Q}_{k} = {q}_{k} : k ∈ \\ \{ 0 , 1 , … , S - 1 \} \backslash \{ i \} ) \times p ( {Q}_{i} = {q}_{i} / \\ \{ {Q}_{k} = {q}_{k} : k ∈ \{ 0 , 1 , … , S - 1 \} \backslash \{ i \} \} , Y = y ) \\ = {\sum }_{\{ {q}_{k} ∈ {Ω}_{{Q}_{k}} : k ∈ \{ 0 , 1 , … , S - 1 \} \backslash \{ i \} \}} \\ ( {\prod }_{k ∈ \{ 0 , 1 , … , S - 1 \} \backslash \{ i \}} {p}^{( post )} ( {Q}_{k} = {q}_{k} ) ) \times p ( {Q}_{i} = {q}_{i} / \\ \{ {Q}_{k} = {q}_{k} : k ∈ \{ 0 , 1 , … , S - 1 \} \backslash \{ i \} \} , Y = y )\end{matrix}$$

The new decoded posteriori probabilities update the posteriori distribution of the symbol plane concerned. The process is repeated over all symbol planes until the posteriori distributions converge. Although this procedure is very demanding, computationally, decoding is generally better.

Various combinations of the above two decoding strategies can be considered. For example, the early symbol planes in encoding order may be channel coded with a big margin or source coded, to ensure virtually noise-free transmission, while the trailing ones may be channel coded with a smaller margin. In this case, the early channel coded symbol planes can be hard-decoded, while the trailing symbol planes may use soft-output based decoding.

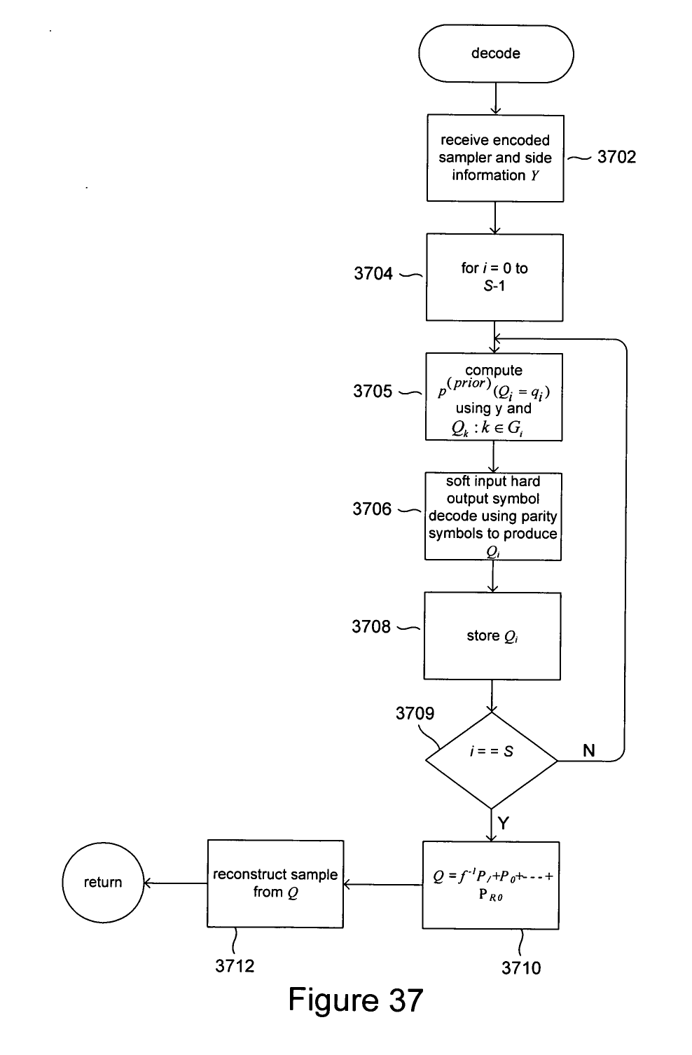

FIG. 37 illustrates a decoding method corresponding to the encoding method illustrated in FIG. 36. First, an encoded sample is received and, of course, the side information y is received or already available in step 3702. Then, in the for-loop of steps 3704-3709, the quantization sub-indices corresponding to symbol planes are reconstructed, symbol-plane-by-symbol-plane. First, the prior probability p^{(prior)}(Qᵢ=qᵢ) is computed using the side information and already computed symbol planes. Then, in step 3706, the current symbol plane is decoded using parity symbols to produce the sub-indices a corresponding to the current symbol plane. In step 3708, the sub-indices for the currently considered symbol plane are stored. In step 3710, the quantization indices Q are computed by a reverse transform, or reverse partitioning, of the computed sub-indices. Then, in step 3712, the transform coefficients are reconstructed from the quantization indices.

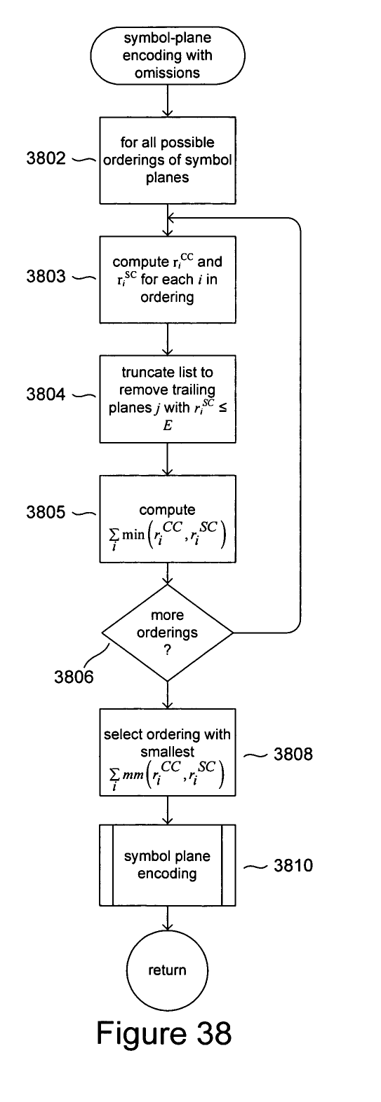

FIG. 38 shows a modified symbol-plane-by-symbol-plane-based combination-encoding method. First, in the for-loop of steps 3802-3806, all possible orderings of symbol planes computed for the next sample are considered. In each ordering, the rᵢ^{CC} and rᵢ^{SC} values are computed and ordered in descending order with respect to the computed value of rᵢ^{SC}. Then, in step 3804, the list of ordered rᵢ^{CC} and rᵢ^{SC} values symbol plane is truncated by removing any trailing symbol planes j for which rⱼ^{SC} is less than or equal to some threshold value E. In step 3805, an overall rate for those symbol planes not omitted in step 3804 is computed for the currently considered ordering. Next, in step 3808, the symbol plane ordering with the smallest computed overall rate is selected and then, in step 3810, the selected symbol plane is encoded as in the encoding technique described in FIG. 36, the difference that the rᵢ^{CC} and rᵢ^{SC} values are already tabulated for those symbol planes that are to be encoded. Thus, in the modified technique illustrated in FIG. 38, those symbol planes that can be transmitted with a source-coding rate less than some threshold value are simply omitted and not sent.

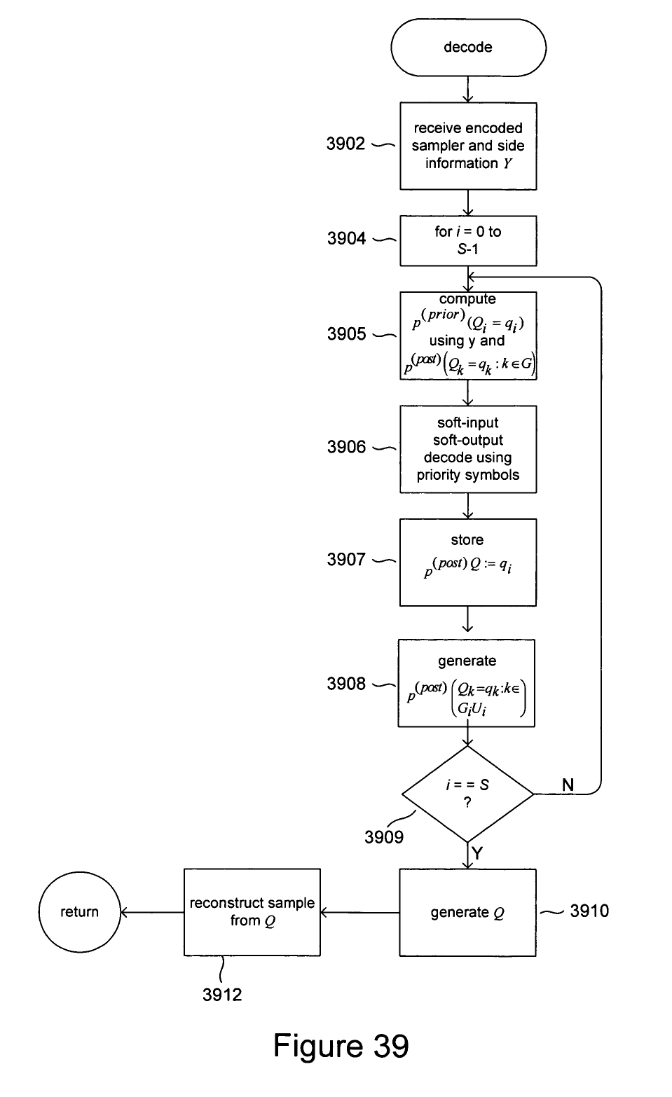

FIG. 39 illustrates the decoding process that corresponds to the encoding process described in FIG. 38. A set of encoded samples are received along with side information y, if y is not already available, in step 3902. Next in the for-loop of steps 3904-3909, each of the sub-indices corresponding to sent symbol planes are generated. In step 3905, the prior probabilities p^{(prior)}(Qᵢ=qᵢ) using the side information and previously computed posterior probabilities p^{(post)}({Qₖ=qₖ:k ∈ G}). Next, in step 3906, soft-input and soft-output decoding is used, along with parity symbols, to produce the posterior probability for the current symbol plane In step 3907, the posterior probabilities for the current symbol plane are stored. In step 3908, posterior probabilities for all of the so-far considered symbol planes are computed. When all symbol planes have been decoded in the for-loop of steps 3904-3909, the quantization indices Q are regenerated, in step 3910, from the decoded quantization sub-indices Q₀, Q₁, . . . , Q_{S-1}. Then, in step 3912, the transform coefficients are reconstructed from the generated quantization indices.

A decoder that eventually returns soft posteriori probabilities of quantization bins must be appropriately represented in obtaining the fmal reconstruction. Assume that the decoder obtains the soft posteriori probabilities of a set of symbol planes in index set G: p^{(post)}({Qₖ=qₖ:k ∈ G}) ∀qₖ, ∈ Ω_{Q}_{ᵢ}. Note that the planes in set G may not include all the symbol planes, if there are trailing skipped symbol planes. Also, if there are planes in G that are source coded or channel coded with a big margin and subsequently hard decoded, the corresponding marginal probability is taken as 1 for the decoded value, and 0 for the rest.

Generally speaking, a form of the a posteriori conditional distribution f_{X/Y}^{(post)}(x, y) is assumed which has the same shape as the a priori distribution f_{X/Y}(x, y) within each bin, but scaled appropriately to satisfy the posteriori probabilities p^{(post)}({Qₖ=qₖ:k ∈ G}) ∀_{q}_{ₖ}, ∈ Ω_{Q}_{ᵢ}. The minimum MSE reconstruction function is then given by:

$$\begin{matrix}\hat{X} = E ( X / Y = y , {p}^{( post )} ( \{ {Q}_{k} = {q}_{k} : k ∈ G \} ) ) \\ = {\sum }_{q ∈ {Ω}_{Q}} {\int }_{{x}_{i} ( q )}^{{x}_{k} ( q )} {xf}_{X / Y}^{( post )} ( x , y ) d x \\ = {\sum }_{q ∈ {Ω}_{Q}} [ \frac{{p}^{( post )} ( \{ {Q}_{k} = {ξ}_{k}^{L} ( q ) : k ∈ G \} )}{{\sum }_{{{q}^{′} ∈ {Ω}_{Q} :}_{{ξ}_{k}^{L} ( {q}^{′} ) = {ξ}_{k}^{L} ( q ) ∀ j ∈ G}} {\int }_{{x}_{i} ( {q}^{′} )}^{{x}_{k} ( q )} {xf}_{X / Y} ( x , y ) d x} ( {\int }_{{x}_{i} ( q )}^{{x}_{k} ( q )} {xf}_{X / Y} ( x , y ) d x ) ] \\ = {\sum }_{q ∈ {Ω}_{Q}} [ \frac{{p}^{( post )} ( \{ {Q}_{k} = {ξ}_{k}^{L} ( q ) : k ∈ G \} ) \times μ ( q , y )}{{\sum }_{{{q}^{′} ∈ {Ω}_{Q} :}_{{ξ}_{k}^{L} ( {q}^{′} ) = {ξ}_{k}^{L} ( q ) ∀ k ∈ G}} π ( {q}^{′} , y )} ] \\ = {\sum }_{q ∈ {Ω}_{Q}} [ \frac{\begin{matrix}{p}^{( post )} ( \{ {Q}_{k} = {ξ}_{k}^{L} ( q ) : k ∈ G \} ) \times \\ [ {m}_{X / Y}^{( 1 )} ( {x}_{h} ( q ) , y ) - {m}_{X / Y}^{( 1 )} ( {x}_{i} ( q ) , y ) ]\end{matrix}}{{\sum }_{{{q}^{′} ∈ {Ω}_{Q} :}_{{ξ}_{k}^{L} ( {q}^{′} ) = {ξ}_{k}^{L} ( q ) ∀ k ∈ G}} [ {m}_{X / Y}^{( 0 )} ( {x}_{h} ( {q}^{′} ) , y ) - {m}_{X / Y}^{( 0 )} ( {x}_{i} ( {q}^{′} ) , y ) ]} ]\end{matrix}$$

Specifically, for the case where there are some hard-decoded planes, such as source-coded or channel-coded with a big margin, and some soft decoded planes, we can denote: G=G_{soft} ∪ G_{hard}, where G_{soft} and G_{hard} are disjoint subsets of G with the hard and soft-decoded symbol indices respectively. Further, if the hard decoded values are Qⱼ=qⱼ∀ⱼ ∈ G_{hard}, the optimal reconstruction can be rewritten as:

$$\hat{X} = {\sum }_{q ∈ {Ω}_{Q}} [ \frac{\begin{matrix}{p}^{( post )} ( \{ {Q}_{k} = {ξ}_{k}^{L} ( q ) : k ∈ {G}_{soft} \} ) \times \\ [ {m}_{X / Y}^{( 1 )} ( {x}_{h} ( q ) , y ) - {m}_{X / Y}^{( 1 )} ( {x}_{i} ( q ) , y ) ]\end{matrix}}{{\sum }_{{{q}^{′} ∈ {Ω}_{Q} :}_{{{ξ}_{j}^{L} ( {q}^{′} ) = {q}_{j} ∀ j ∈ {G}_{hard}}_{{ξ}_{k}^{L} ( {q}^{′} ) = {ξ}_{k}^{L} ( q ) ∀ k ∈ {G}_{soft}}}} [ \begin{matrix}{m}_{X / Y}^{( 0 )} ( {x}_{h} ( {q}^{′} ) , y ) - \\ {m}_{X / Y}^{( 0 )} ( {x}_{i} ( {q}^{′} ) , y )\end{matrix} ]} ]$$

When there are skipped symbol-planes, or when the channel coded planes have not been coded with a sufficiently large margin, usually a certain probability of erroneous decoding is tolerated. In such cases, partial soft-decoding followed by the above form for the reconstruction function yields somewhat better reconstruction in practice.

### An Efficient and Practical Wyner-Ziv Codec

An efficient and practical Wyner-Ziv codec is next discussed. Consider a symbol-plane-by-symbol-plane coder with S=K+2 symbols, where the alphabet-size vector is given by {M, 2, 2, . . . , (K 2s), ∞} and where {M, K} are parameters for the code. The coding order is LSS to MSS. The M-ary LSS, which is the first symbol in coding order, is source coded, the most significant symbol-plane is skipped, while the intermediate binary planes are each channel coded with powerful binary channel codes. Note that, for LSS to MSS coding, the conditional entropy decays very fast at the higher symbol planes, which makes the MSS very appropriate for skipping. The source coding rate is given by the above-discussed unconditional-entropy expression for rᵢ^{SC}. Since this is the first symbol plane, there is no possibility of error propagation due to erroneous decoding of prior channel coded planes. The intermediate binary planes, in low-to-high-significance order, are coded with punctured binary error correction codes with rates given by adding a margin to the ideal rate. The case of K=1 is particularly convenient since there is only one channel coded plane preceded by a noise free source coded plane, and consequently there are no complications due to the possibility of error propagation. Optimal reconstruction can be then conducted based on \hat{X}_{YC}(y, c), in the case of hard output decoding, or based on the above-described expression for \hat{X}, in the case of soft-output decoding. The case M=1 for this code is a degenerate case, where the source coded symbol plane is non-existent, so that the code essentially becomes a bit-plane by bit-plane LSB to MSB channel coder with K bit-planes.

The goal of parameter choice for this code is to obtain the appropriate values of {M, K} and also the ideal rates to be used for the binary planes, given the source and correlation statistics {σ_{X}², σ_{Z}²}. The following algorithm may be used to find the optimal value of {M, K}, based on the fact that in order to skip the MSS, its conditional entropy must be below a small threshold ε.
1. For each k in a set of allowable values: {1, 2, . . . , Kₘₐₓ}
   a. Initialize m=1.
   b. Obtain conditional entropy H (Qₖ₊₁/Q₀, Q₁, . . . , Qₖ, Y) with L={m, 2, 2, . . . , ∞}. (If m=1, there is no information in Q₀).
   c. If H(Q_{K+1}/Q₀, Q₁, . . . , Y)>ε do m=m+1 and go to Step 1b, else assign M(k)=m and go to step 1d.
   d. Obtain source coding rate r₀^{SC}(k)=H(Q₀) for code parameters {M(k), k}. (If M(k)=1, H(Q₀)=0).
   e. Obtain ideal rate for binary planes: H(Q₁/Q₀, Y), H(Q₂/Q₀, Q,₁, Y), . . . , H(Qₖ/Q₀, Q,₁, . . . , Qₖ₋₁, Y).
   f. If k>1, check if: H(Qₖ₊₁/Q₀, Q₁, . . . , Qₖ, Y)+H(Qₖ/Q₀, Q₁, . . . , Qₖ₋₁, Y)<ε. If so, assign r_{practical}(k)=VERY_LARGE_VALUE and go to Step 1 and continue for next k. (In this case, a lower value of k should be used rather than the one tested).
   g. Compute practical channel coding rates: r₁^{CC}(k)=(1+γ₁)H(Q₁/Q₀, Y), r₂^{CC}(k)=(1+γ₂)H(Q₂/Q₀, Q₁, Y), . . . , rₖ^{CC}(k)=(1+γₖ)H(Q_{K}/Q₀, Q₁, . . . , Q_{K-1}, Y) for code parameters {M(k), k}.
   h. Obtain total practical rate: r_{practical}(k)=r₀^{SC}(k)+r₁^{CC}(k)+r₂^{CC}(k)+ . . . +rₖ^{CC}(k).
2. Find K=argₖmin r_{practical}(k) . The optimal code parameters are then {M(K), K}, with the channel coding rates as computed in Step le for this combination.

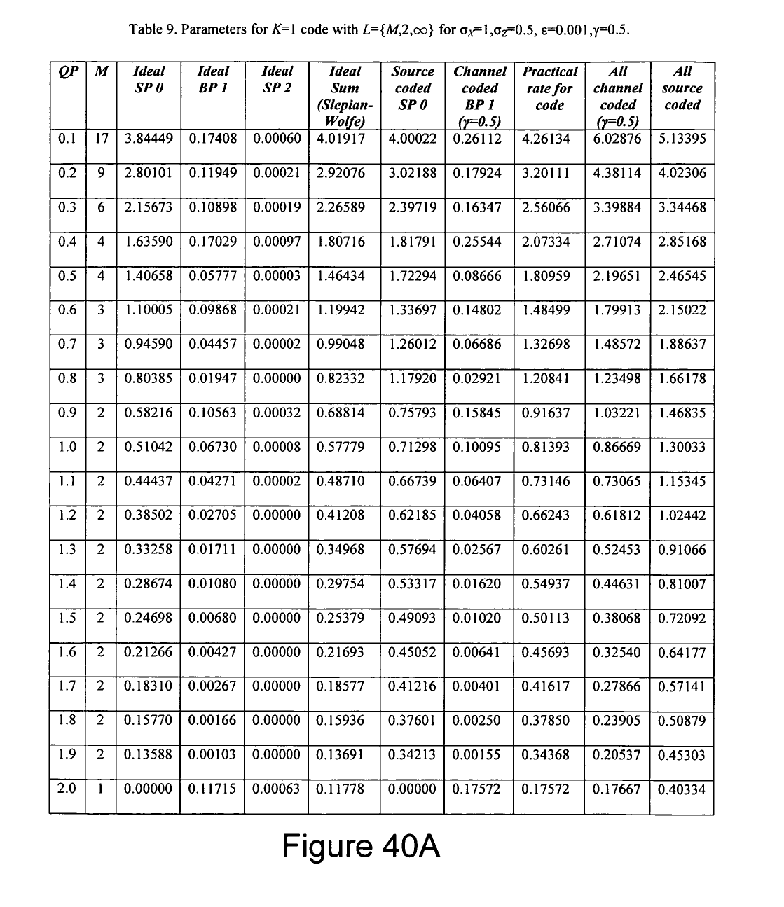

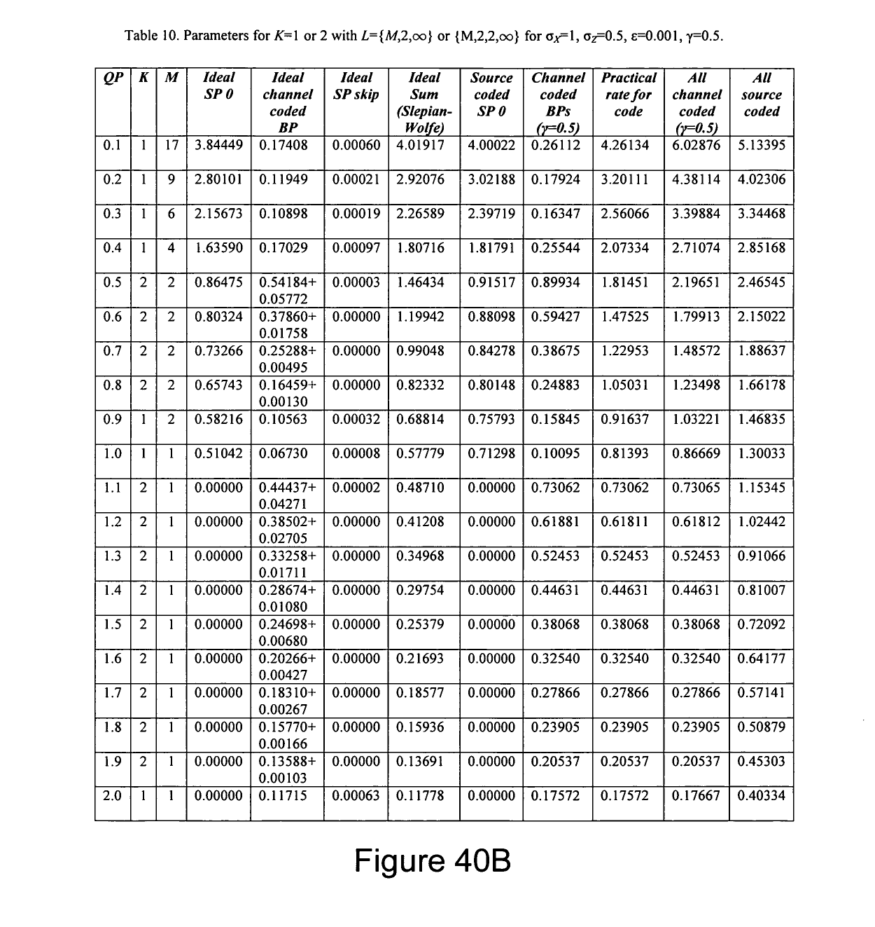

Table 9, provided in FIG. 40A, shows the parameters chosen for the above algorithm, for the model σ_{X}=1, σ_{Z}=0.5, for varying values of QPₜ, with ε=0.001. Further, K=1 is the allowed configuration for practical convenience, corresponding to a 3-symbol code with L={M, 2, ∞}. The ideal rates for coding, as well as the practical rate with the first symbol source coded and second symbol coded with a margin are provided. The margin factor, γᵢ=y=0.5 is assumed to be appropriate for the expected number of samples to be coded as a block, and the code complexity, and is assumed to be the same γ for each symbol plane. Note that this factor may be decided on the fly depending on the block size, if the number of samples in a block is not known beforehand.

As we can see from the table, the practical rate with this code diverges substantially from the ideal distributed-coding rate. However, when only channel coding is used for this code with the same margin requirement, the rate is (1+γ) times as much as the ideal distributed-coding rate shown in the second rightmost column, which is actually larger than the rate with the 3-symbol source-channel code at higher rates. At lower rates (QP>1), the channel-only code rate is lower. Also shown for comparison in the rightmost column is the rate when pure source coding is used.

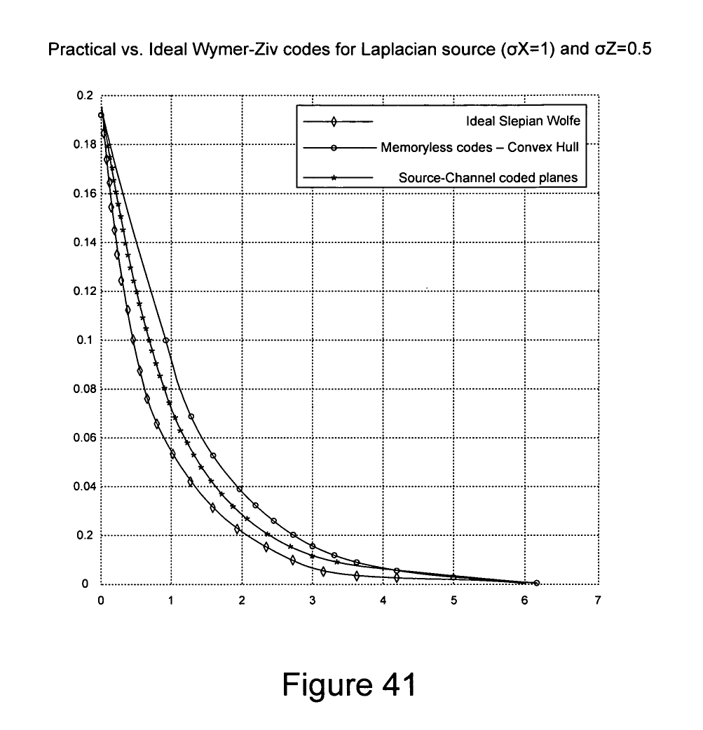

When up to 2 channel coded bit-planes (Kₘₐₓ=2) are allowed, the inefficiency at the lower rates can be largely removed, since the coding option with two channel coded planes but no source coding can now be chosen. FIG. 40B shows the parameters chosen when both K=1 (3-symbol) and K=2 (4-symbol) codes are used. For certain mid-QP values, namely QP=0.5, 0.6, 0.7, 0.8, it becomes optimal to use K=2 channel coded bit-planes. At the lower rates QP>1, it again becomes optimal to use K=2 channel coded bit-planes, but the source coded symbol plane becomes degenerate at these rates (M=1). In other words, only two channel coded bit-planes are used, and use of source coded symbol plane is no longer optimal. At very low rates, QP it becomes sufficient to use a single channel coded bit-plane. FIG. 41 shows a comparison the rate/distortion curves for ideal distributed coding followed by optimal reconstruction, with the convex hull for memoryless coding, and the characteristics of the above practical code with a combination of source and channel coding. As expected, the latter curve with memory enables getting closer to the bound.

For actual channel coding of the intermediate bit-planes, powerful systematic codes such as LDPC codes or punctured Turbo codes may be used. However, if the number of samples is variable for each block, and not known beforehand, punctured Turbo codes will be found to be particularly advantageous for fast encoding. With LDPC codes, for every block of samples of unknown length to be coded, a new parity check matrix for a pseudo-random code with the specified rate needs to be instantiated. The set-up time during encoding may be too complex, even though, once the set up is done, encodings very simple. For punctured Turbo codes however, encoding with two constituent convolutional codes, followed by puncturing to obtain the required rate can all be done very fast in a straight-forward manner.

Decoding is conducted based on knowledge of the source decoded LSS (Q₀=q₀), and the side information Y in order from the lower to higher significance. Any of the decoding strategies outlined above may be employed in the general case. However, if K=1, then there is a single channel coded bit-plane preceded by a source coded symbol-plane, and a soft-input soft-output decoder may be used very conveniently. In this case, the soft input prior probabilities are assumed to be obtained by computing: p^{(prior)}(Q₁=q₁)=p(Q₁=q₁/Q₀=q₀, Y=y) using the above-described expression for p^{(prior)}(Qᵢ=qᵢ), while the soft-output posteriori probabilities p^{(post)}(Q₁=q₁) may be used in conjunction with the above-discussed expression for \hat{X} during eventual reconstruction. Alternatively, the above-discussed expression for \hat{X}_{YQ}(y, q) may be used after hard-thresholding the posteriori probabilities.

Mathematical Description of Selected Error-Control Encoding Techniques

Error-control encoding techniques systematically introduce supplemental bits or symbols into plain-text messages, or encode plain-text messages using a greater number of bits or symbols than absolutely required, in order to provide information in encoded messages to allow for errors arising in storage or transmission to be detected and, in some cases, corrected. One effect of the supplemental or more-than-absolutely-needed bits or symbols is to increase the distance between valid codewords, when codewords are viewed as vectors in a vector space and the distance between codewords is a metric derived from the vector subtraction of the codewords.

In describing error detection and correction, it is useful to describe the data to be transmitted, stored, and retrieved as one or more messages, where a message μ comprises an ordered sequence of symbols, μᵢ, that are elements of a field F. A message μ can be expressed as:

μ=(μ₀, μ₁, . . . , μₖ₋₁)

where μ₁ ∈ F.

The field F is a set that is closed under multiplication and addition, and that includes multiplicative and additive inverses. It is common, in computational error detection and correction, to employ fields comprising a subset of integers with sizes equal to a prime number, with the addition and multiplication operators defined as modulo addition and modulo multiplication. In practice, the binary field is commonly employed. Commonly, the original message is encoded into a message c that also comprises an ordered sequence of elements of the field F, expressed as follows:

c=(c₀, c₁, . . . , cₙ₋₁)

where cᵢ ∈ F

Block encoding techniques encode data in blocks. In this discussion, a block can be viewed as a message μ comprising a fixed number of symbols k that is encoded into a message c comprising an ordered sequence of n symbols. The encoded message c generally contains a greater number of symbols than the original message μ, and therefore n is greater than k. The r extra symbols in the encoded message, where r equals n−k, are used to carry redundant check information to allow for errors that arise during transmission, storage, and retrieval to be detected with an extremely high probability of detection and, in many cases, corrected.

In a linear block code, the 2” codewords form a k-dimensional subspace of the vector space of all n-tuples over the field F. The Hamming weight of a codeword is the number of non-zero elements in the codeword, and the Hamming distance between two codewords is the number of elements in which the two codewords differ. For example, consider the following two codewords a and b, assuming elements from the binary field:
a=(1 0 0 1 1)
b=(1 0 0 0 1)
   The codeword a has a Hamming weight of 3, the codeword b has a Hamming weight of 2, and the Hamming distance between codewords a and b is 1, since codewords a and b differ only in the fourth element. Linear block codes are often designated by a three-element tuple [n, k, d], where n is the codeword length, k is the message length, or, equivalently, the base-2 logarithm of the number of codewords, and d is the minimum Hamming distance between different codewords, equal to the minimal-Hamming-weight, non-zero codeword in the code.

The encoding of data for transmission, storage, and retrieval, and subsequent decoding of the encoded data, can be described as follows, when no errors arise during the transmission, storage, and retrieval of the data:

μ→c(s)→c(r)→μ

where c(s) is the encoded message prior to transmission, and c(r) is the initially retrieved or received, message. Thus, an initial message μ is encoded to produce encoded message c(s) which is then transmitted, stored, or transmitted and stored, and is then subsequently retrieved or received as initially received message c(r). When not corrupted, the initially received message c(r) is then decoded to produce the original message μ. As indicated above, when no errors arise, the originally encoded message c(s) is equal to the initially received message c(r), and the initially received message c(r) is straightforwardly decoded, without error correction, to the original message μ.

When errors arise during the transmission, storage, or retrieval of an encoded message, message encoding and decoding can be expressed as follows:

μ(s)→c(s)→c(r)→μ(r)

Thus, as stated above, the final message μᵣ may or may not be equal to the initial message μ(s), depending on the fidelity of the error detection and error correction techniques employed to encode the original message μ(s) and decode or reconstruct the initially received message c(r) to produce the final received message μ(r). Error detection is the process of determining that:

c(r)≠c(s)

while error correction is a process that reconstructs the initial, encoded message from a corrupted initially received message:

c(r)→c(s)

The encoding process is a process by which messages, symbolized as μ, are transformed into encoded messages c. Alternatively, a messages μ can be considered to be a word comprising an ordered set of symbols from the alphabet consisting of elements of F, and the encoded messages c can be considered to be a codeword also comprising an ordered set of symbols from the alphabet of elements of F. A word μ can be any ordered combination of k symbols selected from the elements of F, while a codeword c is defined as an ordered sequence of n symbols selected from elements of F via the encoding process:

{c:μ→c}

Linear block encoding techniques encode words of length k by considering the word μ to be a vector in a k-dimensional vector space, and multiplying the vector μ by a generator matrix, as follows:

c=μ·G

Expanding the symbols in the above equation produces either of the following alternative expressions:

$$( {c}_{0} , {c}_{1} , … , {c}_{n - 1} ) = ( {μ}_{0} , {μ}_{1} , … , {μ}_{k - 1} ) ( \begin{matrix}{g}_{00} & {g}_{01} & {g}_{02} & ⋯ & {g}_{0 , n - 1} \\ & ⋮ & & ⋱ & ⋮ \\ {g}_{k - 1 , 0} & {g}_{k - 1 , 1} & {g}_{k - 1 , 2} & ⋯ & {g}_{k - 1 , n - 1}\end{matrix} )$$

$$( {c}_{0} , {c}_{1} , … , {c}_{n - 1} ) = ( {μ}_{0} , {μ}_{1} , … , {μ}_{k - 1} ) ( \begin{matrix}{g}_{0} \\ {g}_{1} \\ ⋮ \\ ⋮ \\ ⋮ \\ {g}_{k - 1}\end{matrix} )$$

$$where {g}_{i} = ( {g}_{i , 0} , {g}_{i , 1} , {g}_{i , 2} … {g}_{i , n - 1} ) .$$

The generator matrix G for a linear block code can have the form:

$${G}_{k , n} = ( \begin{matrix}{p}_{0 , 0} & {p}_{0 , 1} & ⋯ & {p}_{0 , r - 1} & 1 & 0 & 0 & ⋯ & 0 \\ {p}_{1 , 0} & {p}_{1 , 1} & ⋯ & {p}_{1 , r - 1} & 0 & 1 & 0 & ⋯ & 0 \\ ⋮ & ⋮ & ⋯ & & 0 & 0 & 1 & ⋯ & 0 \\ ⋮ & ⋮ & ⋯ & & ⋮ & ⋮ & ⋮ & ⋯ & ⋮ \\ ⋮ & ⋮ & ⋯ & & ⋮ & ⋮ & ⋮ & ⋯ & ⋮ \\ {p}_{k - 1 , 0} & {p}_{k - 1 , 1} & ⋯ & {p}_{k - 1 , r - 1} & 0 & 0 & 0 & ⋯ & 1\end{matrix} )$$

or, alternatively:

G_{k,n}=[P_{k,r}|I_{k,k}].

Thus, the generator matrix G can be placed into a form of a matrix P augmented with a k by k identity matrix I_{k,k}. A code generated by a generator in this form is referred to as a “systematic code.” When this generator matrix is applied to a word μ, the resulting codeword c has the form:

c=(c₀, c₁, . . . , cᵣ₋₁, μ₀, μ₁, . . . , μₖ₋₁)

where cᵢ=μ₀p_{0,i}+μ₁p_{1,j}, . . . , μₖ₋₁p_{k-1,i}).

Note that, in this discussion, a convention is employed in which the check symbols precede the message symbols. An alternate convention, in which the check symbols follow the message symbols, may also be used, with the parity-check and identity submatrices within the generator matrix interposed to generate codewords conforming to the alternate convention. Thus, in a systematic linear block code, the codewords comprise r parity-check symbols cᵢ followed by the symbols comprising the original word μ. When no errors arise, the original word, or message μ, occurs in clear-text from within, and is easily extracted from, the corresponding codeword. The parity-check symbols turn out to be linear combinations of the symbols of the original message, or word μ.

One form of a second, useful matrix is the parity-check matrix H_{r,n}, defined as:

H_{r,n}=[I_{r,r}|−P^{T}]

or, equivalently,

$${H}_{r , n} = ( \begin{matrix}1 & 0 & 0 & ⋯ & 0 & - {p}_{0 , 0} & - {p}_{1 , 0} & - {p}_{2 , 0} & ⋯ & - {p}_{k - 1 , 0} \\ 0 & 1 & 0 & ⋯ & 0 & - {p}_{0 , 1} & - {p}_{1 , 1} & - {p}_{2 , 1} & ⋯ & - {p}_{k - 1 , 1} \\ 0 & 0 & 1 & ⋯ & 0 & - {p}_{0 , 2} & - {p}_{1 , 2} & - {p}_{2 , 2} & ⋯ & - {p}_{k - 1 , 2} \\ ⋮ & ⋮ & ⋮ & ⋯ & ⋮ & ⋮ & ⋮ & ⋮ & ⋯ & ⋮ \\ 0 & 0 & 0 & ⋯ & 1 & - {p}_{0 , r - 1} & - {p}_{1 , r - 1} & - {p}_{0 , r - 1} & ⋯ & - {p}_{k - 1 , r - 1}\end{matrix} ) .$$

The parity-check matrix can be used for systematic error detection and error correction. Error detection and correction involves computing a syndrome S from an initially received or retrieved message c(r) as follows:

S=(S₀, S₁, . . . , Sᵣ₋₁)=c(r)·H^{T}

where H^{T} is the transpose of the parity-check matrix H_{r,n} expressed as:

$${H}^{T} = ( \begin{matrix}1 & 0 & 0 & ⋯ & 0 \\ 0 & 1 & 0 & ⋯ & 0 \\ 0 & 0 & 1 & ⋯ & 0 \\ ⋮ & ⋮ & ⋮ & ⋯ & 1 \\ - {p}_{0 , 0} & - {p}_{0 , 1} & - {p}_{0 , 2} & ⋯ & - {p}_{0 , r - 1} \\ - {p}_{1 , 0} & - {p}_{0 , 1} & - {p}_{0 , 2} & ⋯ & - {p}_{0 , r - 1} \\ - {p}_{2 , 0} & - {p}_{0 , 1} & - {p}_{0 , 2} & ⋯ & - {p}_{0 , r - 1} \\ ⋮ & ⋮ & ⋮ & ⋯ & ⋮ \\ - {p}_{k - 1 , 0} & - {p}_{k - 1 , 1} & - {p}_{k - 1 , 2} & ⋯ & - {p}_{k - 1 , r - 1}\end{matrix} ) .$$

Note that, when a binary field is employed, x=−x, so the minus signs shown above in H^{T} are generally not shown.

Hamming codes are linear codes created for error-correction purposes. For any positive integer m greater than or equal to 3, there exists a Hamming code having a codeword length n, a message length k, number of parity-check symbols r, and minimum Hamming distance dₘᵢₙ as follows:

n=2^{m} −1

k=2^{m}−m−1

r=n−k=m

dₘᵢₙ=3

The parity-check matrix H for a Hamming Code can be expressed as:

H=[Iₘ|Q]

where Iₘ is an m×m identity matrix and the submatrix Q comprises all 2^{m}−m−1 distinct columns which are m-tuples each having 2 or more non-zero elements. For example, for m=3, a parity-check matrix for a [7,4,3] linear block Hamming code is

$$H = ( \begin{matrix}1 & 0 & 0 & 0 & 1 & 1 & 1 \\ 0 & 1 & 0 & 1 & 1 & 1 & 0 \\ 0 & 0 & 1 & 1 & 0 & 1 & 1\end{matrix} )$$

A generator matrix for a Hamming code is given by:

G=[Q^{T} I₂_{^{m}}₋ₘ₋₁]

where Q^{T} is the transpose of the submartix Q, and I₂_{^{m}}₋ₘ₋is a (2^{m}−m−1)×(2^{m}−m−1) identity matrix. By systematically deleting l columns from the parity-check matrix H, a parity-check matrix H′ for a shortened Hamming code can generally be obtained, with:

n=2^{m}−l−1

k=2^{m}−m−l−1

r=n−k=m

dₘᵢₙ≧3

Method and Systems of the Present Invention

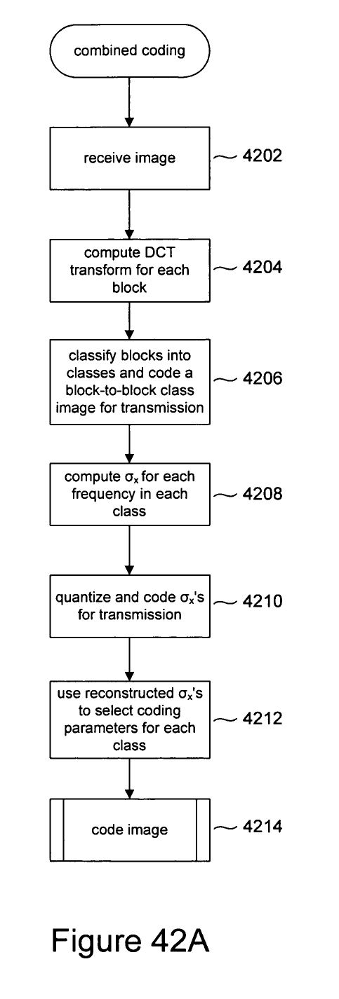

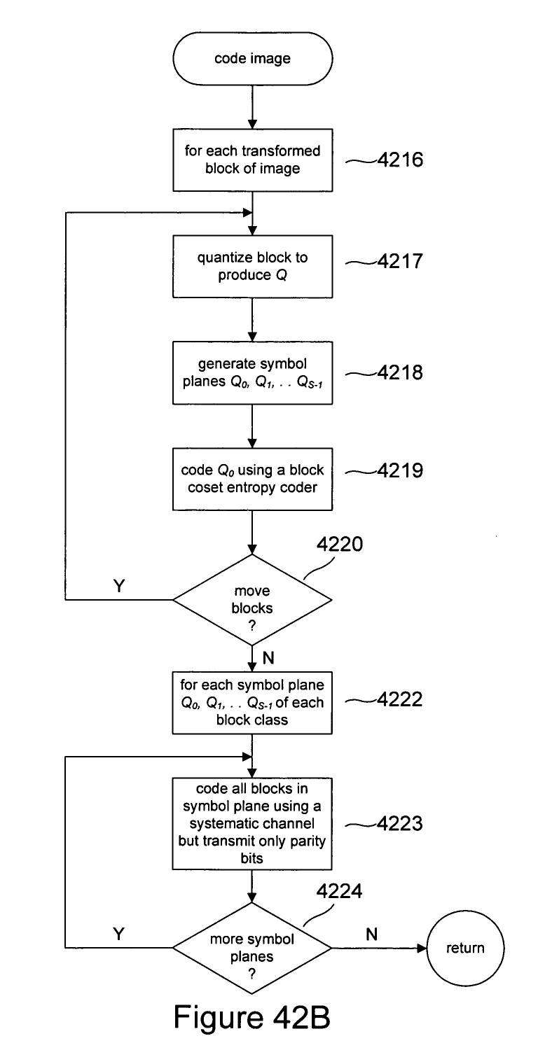

Having covered, in previous subsections, the concepts of source coding, channel coding, memoryless-closet-based coding, and optimal parameter selection for a combined-coding strategy, method and system embodiments of the present invention can now be described. FIGS. 42A-B provide a control-flow diagram for a combined-coding routine that represents one embodiment of the present invention. In step 4202, a next image for coding is received. Note that the image may be the pixel plane of a camera-generated image or may be a computed image, such as a residual image or residual macroblock obtained by a difference operation carried out by a higher-level coding procedure. In step 4204, a DCT transform, discrete Fourier transform, or other spatial-domain-to-frequency-domain transform, is computed for each block in the image. In step 4206, the blocks of the image are partitioned into block classes based on a metric computed for each block related to the energy of the transform coefficients in the DCT or other transform of the block. A block-to-block-class map for all of the blocks of the image is generated and coded for transmission, or output to the coded bitsream. In step 4208, the standard deviation σₓ or variance ax for each frequency, or coefficient, in each class is computed over the blocks contained in each class. The σₓ or σₓ² values for each class are then quantized and encoded using a source-coding method for transmission, or output to a coded bitstream, in step 4210.

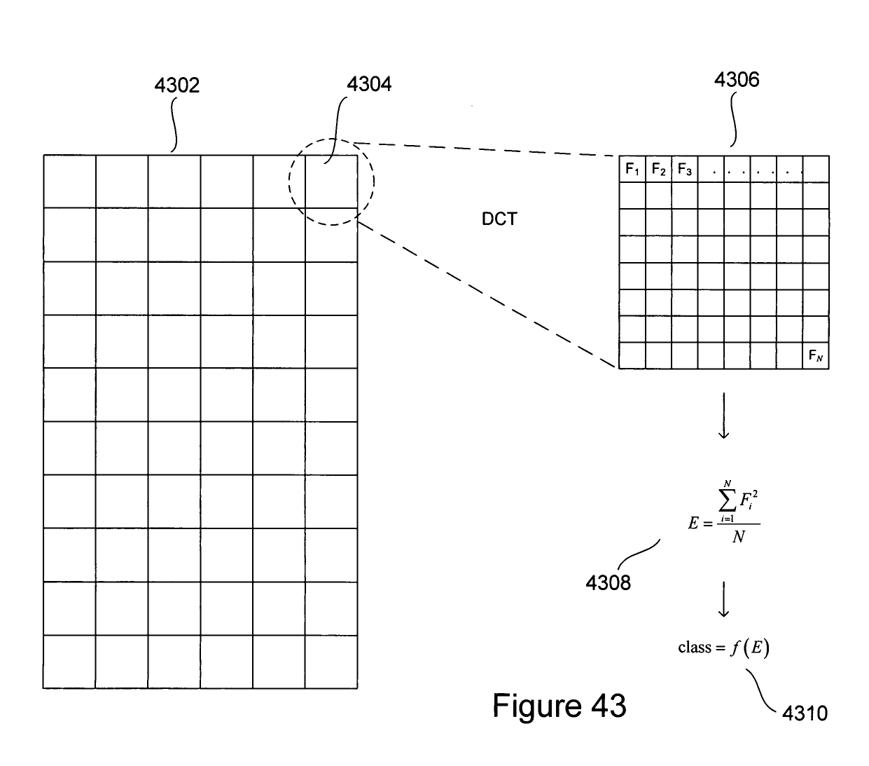

Steps 4202-4210 of FIG. 42A are illustrated in FIGS. 43-45. FIG. 43 illustrates application of a DCT transform to each block in the received image and computing a coefficient-energy metric for each block. In FIG. 43, the image 4302 comprises a two-dimensional tiling of blocks, including block 4304. Each block, such as block 4304, is transformed, using a DCT transform or other transform, into a transformed block 4306 that contains transform coefficients F₁, F₂, . . . , F_{N}. Then, a metric E 4308 is computed for the block based on the absolute energy or average energy of the transform coefficients. A function F(E) 4310 then generates an indication of the class to which the block belongs. For example, the function F(E) may partition the full range of metric E values into sub-ranges, each having an approximately equal number of member blocks.

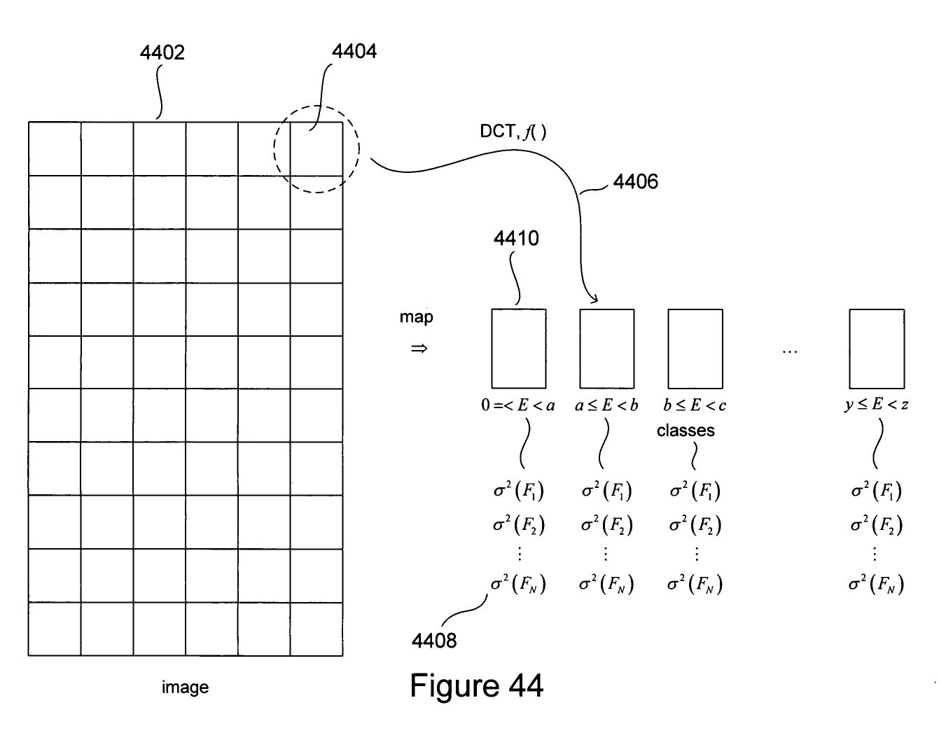

FIG. 44 shows block classification and statistics collection for block classes. As shown in FIG. 44, each block of an image 4402, such as block 4404, is transformed, the metric E computed for the block, and the function F(E) is applied in order to generate an indication of the class to which the block belongs 4406. Once the membership of blocks within classes is determined, then the standard deviation or variance statistics for each of the frequency coefficients in the blocks of each class, such as the variances 4408 for the class 4410, can be determined by statistical analysis.

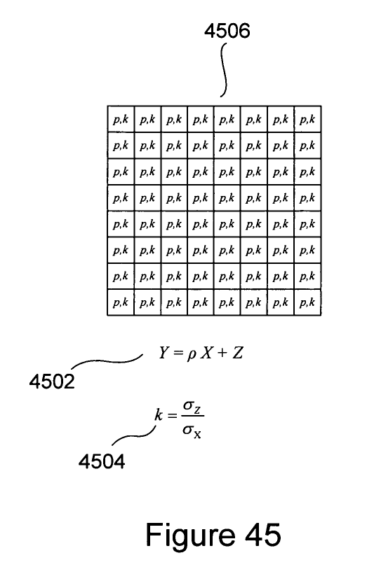

FIG. 45 illustrates additional information known both to an encoder and to a decoder that carry out the currently described methods of the present invention. First, the model for the side information 4502 is:

Y=ρX+Z

where X refers to the transform coefficients and Z refers to noise, generally modeled as Gaussian noise. The parameter ρ is obtained by prior training, and is available both to the encoder and to the decoder. In addition, a parameter k 4504 defined as:

$$k = \frac{{σ}_{Z}}{{σ}_{X}}$$

is available both to the encoder and to the decoder. Parameter k is also obtained by prior training. For each frequency of each class, the encoder and decoder are assumed to have a corresponding pair of parameters ρ and k, as shown by matrix 4506 in FIG. 45.

As discussed in preceding sections, optimal combined-source-and-channel coding parameters can be obtained by an optimization method to which statistical parameters are input. In the described embodiment of the present invention, the parameters σ_{X}, σ_{Z}, and ρ are input to obtain memoryless coding parameters {QP, S, m, r₁, r₂, . . . , r_{S-1}} which define the encoding parameters for each class of blocks in the image. The value QP is the quantization parameter, the value S is the number of closet symbol planes, the value m is the closet modulus for the least-significant closet symbol plane, and the values r₁, r₂, . . . , r_{S-1} are the bit rates for the channel encoder used to encode all but the least-significant closet symbol plane. Note that parameter selection may return parameters with m=1 and S=1, indicating that zero-rate coding is to be used for a particular class of blocks.

Returning to FIG. 42A, the reconstructed σ_{X}'s generated during coding are used, as described above, in step 4212 to select the coding parameters for each block class. Then, in step 4214, the subroutine “code image” is called.

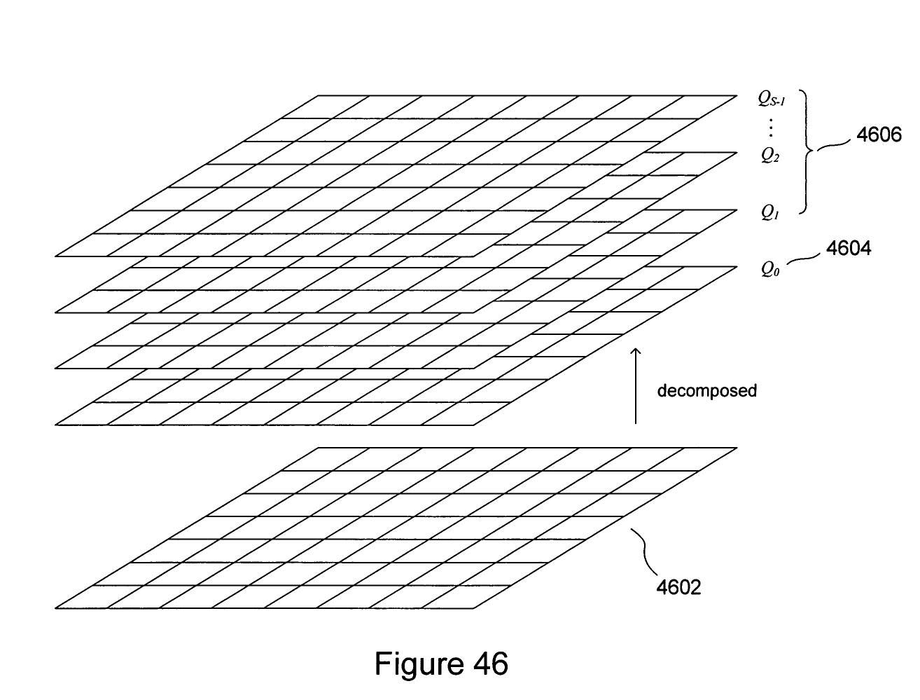

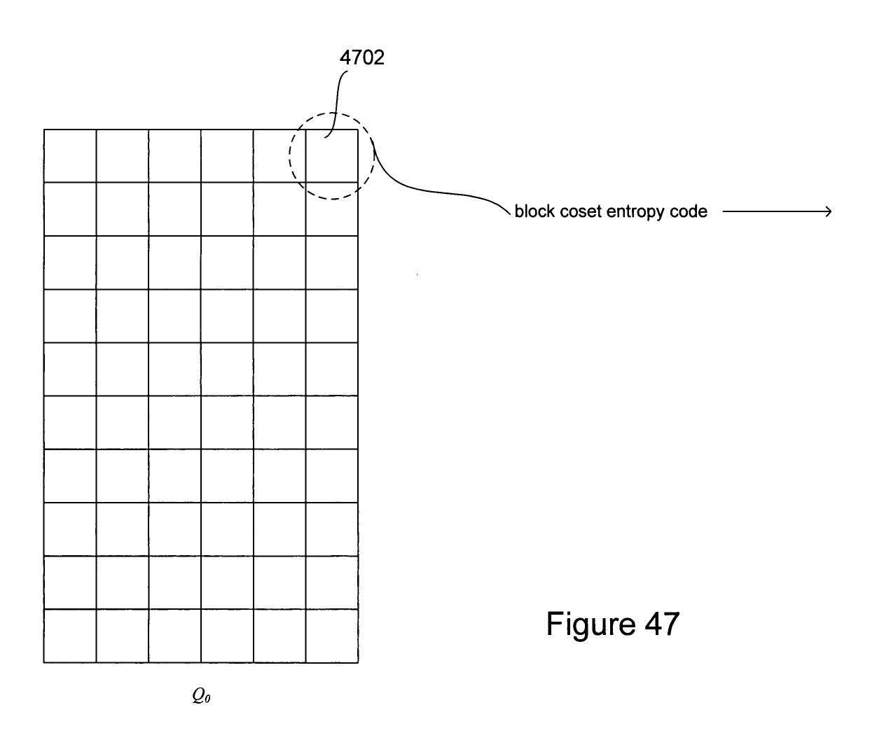

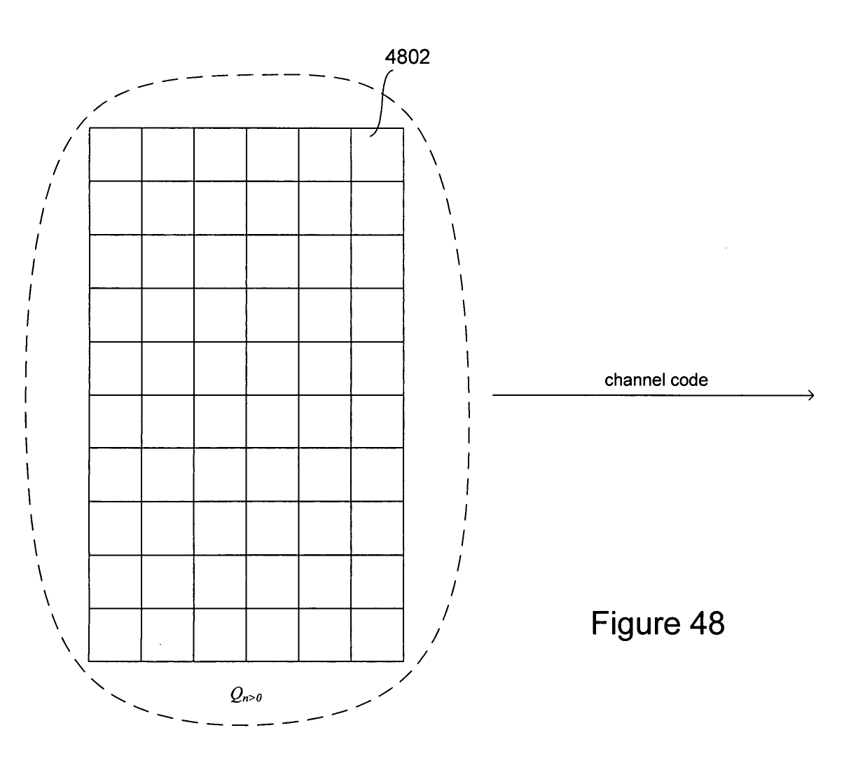

FIG. 42B provides a control-flow diagram for the subroutine “code image,” called in step 4214 in FIG. 42A. In the for-loop of steps 4216-4220, each transformed block of the original received image is quantized, in step 4217 and, for each transformed block, the symbol planes Q₀, Q₁, . . . , Q_{S-1} are generated, as described in a previous subsection, in step 4218 and the least-significant symbol plane Q₀ is coded using a block-closet-entropy coder, in step 4219. FIG. 46 shows the decomposition of the quantized transformed-block coefficients Q into corresponding symbol planes Q₀, Q₁, . . . , Q_{S-1}. Symbol-plane decomposition is discussed, at length, in a preceding subsection. The block of transformed coefficients is quantized to produce a quantized-coefficient block 4602. Then, using the method discussed above in a preceding subsection, the quantized block Q is decomposed into a least-significant symbol plane Q₀ 4604 and a number of additional symbol planes Q₁, . . . , Q_{S-1} 4606. FIG. 47 illustrates step 4219 of FIG. 42B. As discussed with reference to step 4219, above, each block of transformed and quantized coefficients is decomposed into the symbol planes Q₀, Q₁, . . . , Q_{S-1}, according to selected coding parameters for the block class to which the block belongs, and for each block in the least-significant symbol plane Q₀, such as block 4702 in FIG. 47, the block is encoded by a block-closet-entropy code for transmission. Returning to FIG. 42B, in the for-loop of steps 4222-4224, all of the additional symbol planes Q₀, Q₁, . . . . , Q_{S-1} for each block class are coded in their entirety using a systematic channel code, and the parity bits generated by systematic channel coding are transmitted, or output to the bitstream, in step 4223. FIG. 48 illustrates channel coding of the non-least-significant symbol planes Q₁, . . . . , Q_{S-1}. As shown in FIG. 48, all of the blocks in an entire symbol plane for a block class are coded together 4802, using a systematic channel code, rather than being coded using a block-by-block encoding method, as is the case for least-significant-symbol-plane blocks, as shown in FIG. 47.

Thus, the combined source-and-channel coding method described by the control-flow diagrams of FIGS. 42A-B generates a coded block-to-block-class map, in step 4206 of FIG. 42A, coded statistics for block classes, in step 4210 of FIG. 42A, block-closet-entropy-coded blocks for least-significant symbol plane Q₀, in step 4219 of FIG. 42B, and the parity bits generated by a systematic channel coder upon systematic-channel-encoding of each entire non-least-significant symbol plane for each block class.

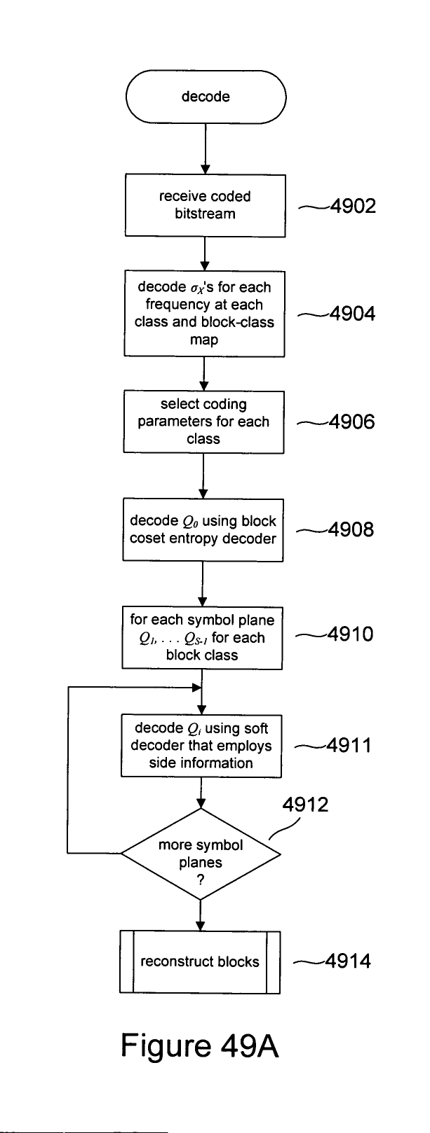

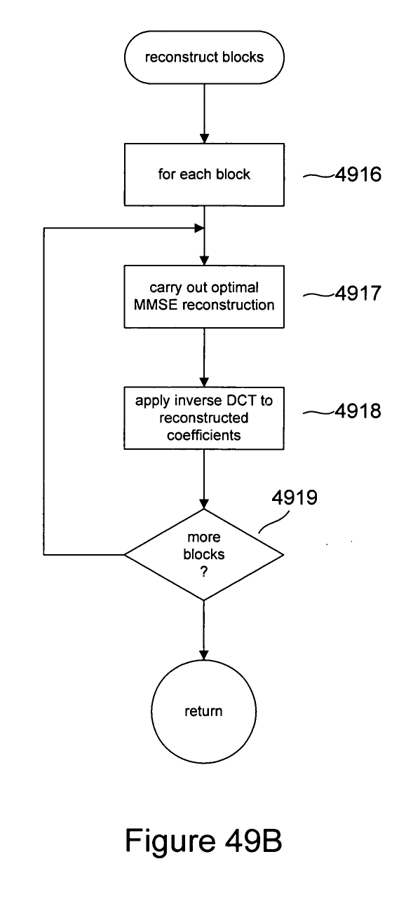

FIGS. 49A-B provide control-flow diagrams for a method for decoding an encoded image that represents one embodiment of the present invention. In step 4902, a coded bit stream, produced by the coding method illustrated in FIGS. 42A-B, is received. In step 4904, the source-coded σₓ or σₓ² values and the map of blocks to block classes is decoded using standard source decoding. Then, in step 4906, as in step 4212 of FIG. 42A, this information, as well as certain of the information discussed above with reference to FIG. 45, is used to select coding parameters for each class. In step 4908, the block-closet-entropy-coded Q₀ blocks are decoded using a block-closet-entropy decoder. Then, in the for-loop of steps 4910-12, each of the coded non-least-significant symbol planes Q₁, Q₂, . . . , Q_{S-1} for each block class are decoded, in step 4911, using a block-closet-entropy decoder. Finally, in step 4914, the subroutine “reconstruct blocks” is called.

FIG. 49B provides a control-flow diagram for the subroutine “reconstruct blocks” called in step 4914 in FIG. 49A. In the for-loop of steps 4916-4919, an optimal MMSE reconstruction method is carried out for each block of the original image, in step 4917, using the decoded symbol-plane blocks corresponding the the block, and then, in step 4918, an inverse transformation method, such as the inverse DCT, is applied to the reconstructed, transform coefficients obtained by MMSE reconstruction to produce a final, decoded block. The decoded blocks are merged together to form a decoded image.

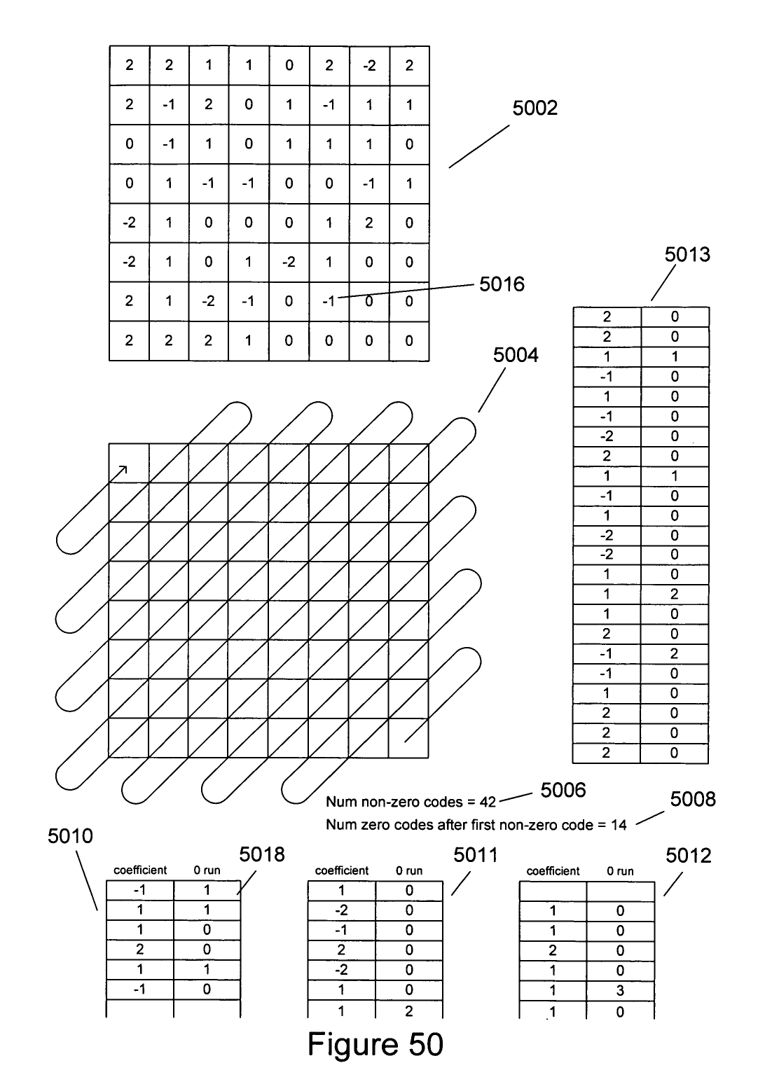

Next, the block-closet-entropy coder, used to code the least-significant-symbol-plane, or Q₀, blocks, in step 4219 of FIG. 42B, is described. FIG. 50 /illustrates principles of the block closet entropy coder that represents one embodiment of the present invention. As shown in FIG. 50, a least-significant symbol plane, or Q₀, block 5002 is generally a square matrix, often an 8×8 matrix, that contains closet values, or coefficients. The block is traversed in reserve zig-zag order, as illustrated by the traversal pattern superimposed over Q₀ block 5004 in FIG. 50. During the traversal, only non-zero-valued cosets are coded. As a result of the traversal, the number of non-zero cosets in the block is determined 5006, the number of non-zero cosets following the first non-zero closet encountered in the reserve-zig-zag traversal is determined 5008, and a table of coefficient/zero-run values shown in four parts 5010-5013 in FIG. 50 is filled with pairs of values, each pair of values including a non-zero closet or coefficient and a number of zero cosets that follow the non-zero closet in the reserve-zig-zag traversal. A reserve-zig-zag traversal of Q₀ block 5002 produces the values in the table shown in FIG. 50 (5010-5013). For example, during the reverse-zig-zag traversal, closet value “−1” 5016 is the first non-zero closet encountered, and that value, along with a value “1” indicating a run of one zero-valued closet following that closet in the reverse-zig-zag traversal, are stored in the table entry 5018 in the first part of the table 5010.

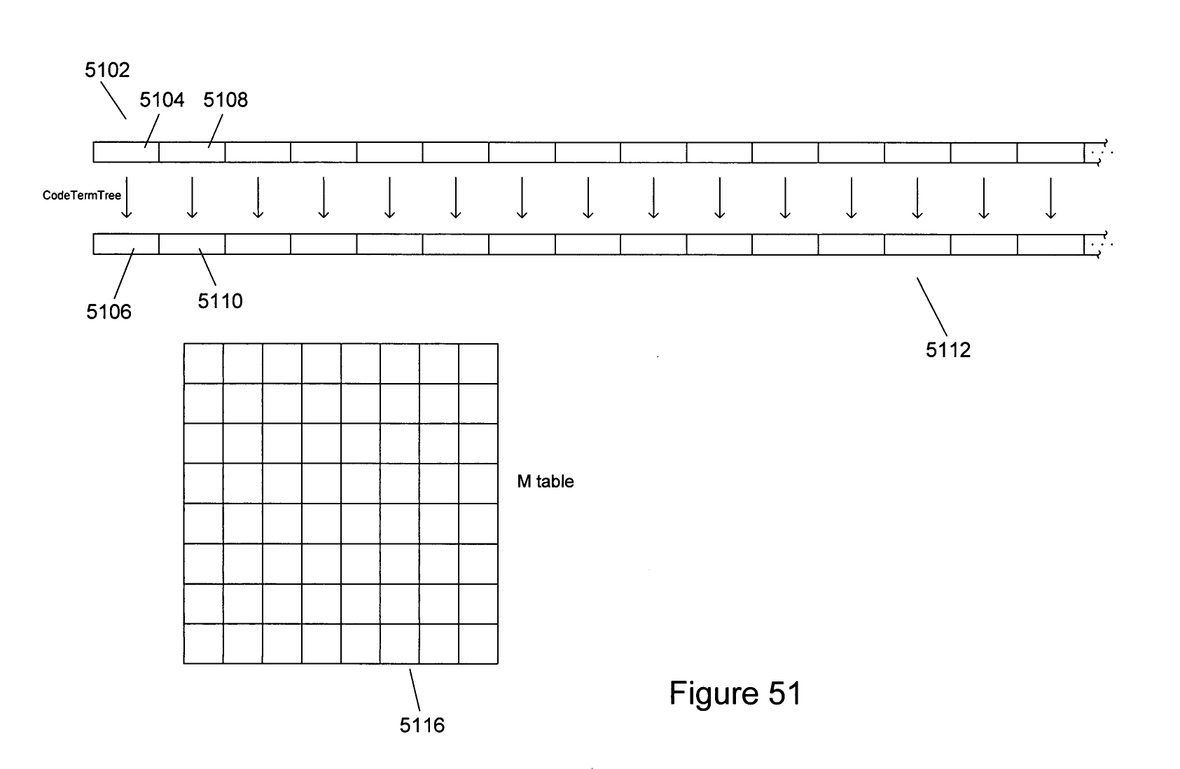

FIG. 51 illustrates additional principals of the block-closet-entropy coder used to code Q₀ closet blocks in step 4219 of FIG. 42B and that represents one embodiment of the present invention. As a result of the traversal of the block, as discussed with reference to FIG. 50, the number of non-zero codes, the number of zero cosets following the first non-zero closet, and the table of coefficient/zero-run pairs have been determined. Output of the block-closet-entropy coder can be viewed as a sequential ordering of the values 5006, 5008, and the coefficient/zero-run values in each entry of the table 5010-5013 5102, which are then entropy coded using a terminated index-remapped exponential-Golomb, sub-exponential code, or other prefix code, as discussed in greater detail below and as embodied in the entropy-coding routine “CodeTermTree,” also discussed below. Thus, for example, value 5104 in the sequence of values 5002 corresponds to the numeric number of non-zero codes in the block (5006 in FIG. 50) and is entropy coded via the routine “CodeTermTree” to produce an encoded value 5106. The next value, the number of zero cosets following the first non-zero closet in the block 5108, is entropy coded to produce a coded value 5110. The coded sequence of values 5112 is output by the block-closet-entropy coder that represents one embodiment of the present invention. Also shown in FIG. 51 is a table M 5116 that is available both to the decoder and coder that implement the combined source-channel coding method that represents one embodiment of the present invention. Table M 5116 includes the maximum closet modulus for each closet in a Q₀ symbol-plane symbol block. In one embodiment of the present invention, the coder and decoder contain a separate table M for each block class.

Next, the entropy coder routine “CodeTermTree” is described. This routine uses several different computed values. The value B(i) is determined by:

B(i)=k+i

where k is a Golomb-code parameter or equivalent parameter for another type of prefix code, and i is a level in a code tree, discussed below. The value 2^{B(i)} is also used in the routine “CodeTermTree.” A table of the values B(i) and 2^{B(i)} for k=2 is provided below:

| | B(i) | 2B(i) | |
|---|---|---|---|
| i = 0 | 2 | 4 | for k = 2 |
| i = 1 | 3 | 8 | |
| i = 2 | 4 | 16 | |
| i = 3 | 5 | 32 | |
| i = 4 | 6 | 64 | |
| i = 5 | 7 | 128 | |

A second computed value, A(i), is computed by:

$$A ( i ) = {\sum }_{j = 0}^{i - 1} 2 B ( j )$$

Representative values of A(i) or k=2 are provided below:

A(0)=0=0

A(1)=4=4

A(2)=4+8=12

A(3)=4+8+16=28

A(4)=4+8+16+32=60

The routine “CodeTermTree” receives an integer value x, a maximum value for x, M, where x ∈ (0, 1, . . . , M−1}, and the exponential-Golomb parameter k, and produces a binary encoding of the integer x:
CodeTermTree(x, M, k)→code for x
   A pseudocode implementation of the routine “CodeTermTree” follows:

```
CodeTermTree (int x, int M, int k)
{
    int i = 0;
    while (true)
    {
        If (M <= A(i) + (3*2^{B(i)}))
        {
            CodeUniform (x − A(i), M−A(i));
            break;
        }
        else if (x ≧A(i) + 2^{B(i)})
        {
            Code Bits (1,1);
            i = i + 1;
        }
        else
        {
            Code Bits (0,1);
            Code Bits (x − A(i), B(i));
            break;
        }
    }
}
CodeUniform (x, M)
}
    int L = ceiling(log₂M);
    int M = 2^{L}−M;
    if (x < M) CodeBits (x, L−1);
    else CodeBits (M + x, L);
}
CodeBits (x, b)
{
    //output b least significant bits of x in high to low order
    output (x, b);
}
```

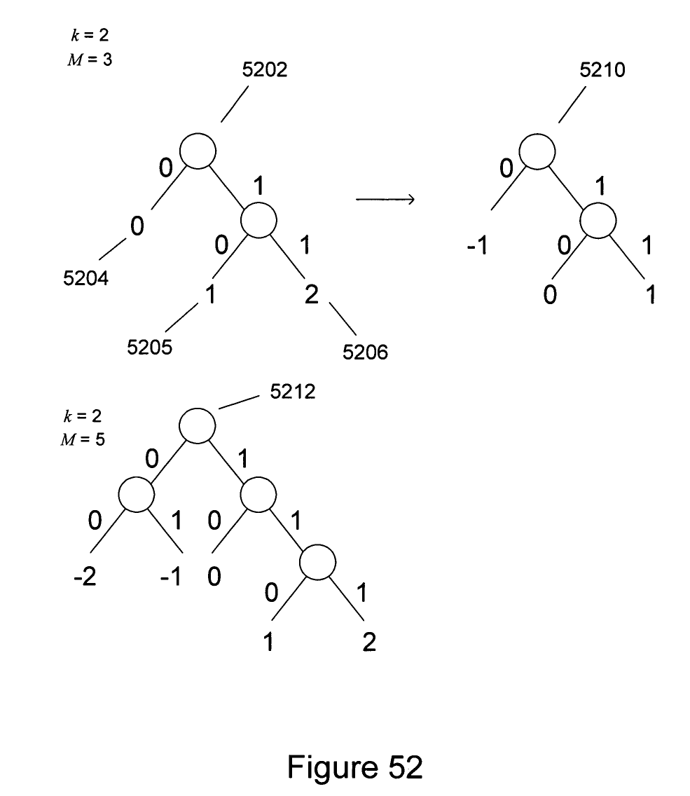

FIG. 52 provides cyclic-graph, or tree, representations of encodings produced by the routine “CodeTermTree” for values of x when k equals 2 and M=3 and 5, according to one embodiment of the present invention. Code tree 5202 is directly produced by the routine “CodeTermTree.” When M is equal to 3, x can have the values 0 5204, 1 5205, and 2 5206. The binary code for these three values used by the routine “CodeTermTree” is read from the labeled branches leading from the root of the tree to each of the three possible values of x. Thus, the encoding for x=0 is “0,” the code for x=1 is “10,” and the code for x=2 is “11.” The codes produced by the routine “CodeTermTree” are prefix codes, which means that no possible code word is a prefix of another code word, and thus, although the code words are of variable lengths, each code word can be parsed ambiguously from a starting position within a string of code words. The symbol-plane values for modulus 3 are generally {−1, 0, 1}. The M=3 code tree 5202 can easily be altered to produce the code tree 5210 for symbol-plane values within ranges centered at 0 and with modulus 3. The code tree for k=2 and M=5 5212 is shown in the lower portion of FIG. 52, with values shifted for zero-centered symbol-plane values {−2, −1, 0, 1, and 2}. The routine “CodeTermTree” generates binary codes for input integers equivalent to codes produced by traversing code trees, such as those shown in FIG. 52.

Next, a pseudocode implementation of the block-closet-entropy coder that represents one embodiment of the present invention is provided. First, a structure definition for table entries is provided:

1 typedef struct pair
2 {
3 int coefficient;
4 int zrun;
5 int m;
6 } Pair;

Each instance of the structure “Pair” contains a symbol-plane coefficient, a length of a zero-valued coefficient run follows the symbol-plane coefficient, and a maximum modulus from the table M, discussed above, with reference to FIG. 51, for the symbol-plane coefficient.

Next, a pseudocode implementation of the block-closet-entropy coder is provided:

```
  1 BCEC (block b, mTable M)
  2 {
  3  int i = maxl;
  4  int j = maxJ;
  5  bool init = true;
  6  int num0AfterFirst = 0;
  7  int num0 = 0;
  8  Pair p[ ];
  9  int cpr = 0;
10  bool up = true;
11  bool more = true;
12  do
13  {
14  if (b[i][j] != 0)
15  {
16  if (init) init = false;
17  else
18  {
19  p[cpr++].zrun = num0;
20  num0AfterFirst += num0;
21  }
22  num0 = 0;
23  p[cpr].coefficient = b[i][j];
24  p[cpr].m = M[i][j];
25  }
26  else
27  {
28  num0++;
29  if (j == 0 && i == 0)
30  {
31  num0AfterFirst += num0;
32  more = false;
33  }
34  }
35  if (up)
36  {
37  if ( j == maxJ)
38  {
39  if (i > 0) i = i − 1;
40  else j= j − 1;
41  up = false;
42  }
43  else if (i == 0)
44  {
45  j = j − 1;
46  up = false;
47  }
48  else
49  {
50  j = j + 1;
51  i = i − 1;
52  }
53  }
54  else
55  {
56  if ( i == maxl)
57  {
58  if (j > 0) j = j− 1;
59  else i= i − 1;
60  up = true;
61  }
62  else if (j == 0)
63  {
64  i = i − 1;
65  up = true;
66  }
67  else
68  {
69  j = j − 1;
70  i = i + 1;
71  }
72  }
73  } while (more);
74  output (CodeTermTree (cpr + 1, (maxl + 1)*(maxJ + 1), k);
75  output (CodeTermTree (num0AfterFirst,
      (maxl + 1)*(maxJ + 1), k);
76  for (i = 0; i < cpr; i++)
77  {
78  output (CodeTermTree (p[i].coefficient, p[i].m, k));
79  output (CodeTermTree (p[i].zrun, (maxl + 1)*(maxJ + 1), k);
80  }
81  output (CodeTermTree (p[i].coefficient, p[i].m, k));
82 }
```

The block-closet-entropy encoder receives a closet block b and the table M as parameters. The variables i and j, declared on lines 3-4, are the indices of a symbol-plane coefficient during a reverse-zig-zag traversal of the block, the Boolean variable “init,” declared on line 5, is used to avoid counting an initial run of zeros, when there is one, when counting the number of zero coefficients that follow the first non-zero coefficient, stored in the integer “num0AfterFirst,” declared on line 6. The integer variable “num0,” declared on line 7, is used to count the number of zero coefficients in a run. The array “p,” declared on line 8, is a table of coefficient, zero-run values, and the integer variable “cpr,” declared on line 9, points to a current entry in the table. The Boolean value “up,” declared on line 10, controls the direction of the zig-zag traversal, and the value of the Boolean value “more,” declared on line 11, controls a do-while loop that executes the reverse-zig-zag traversal of the block.

The do-while loop is implemented in lines 12-73. When the next coefficient in the block is non-zero, as determined on line 14, then, when the non-zero coefficient is not the first non-zero coefficient, any zeros preceding the coefficient are entered in the table entry for the previous coefficient, on line 19, and the variable “num0AfterFirst” is updated, on line 20. The coefficient is stored in the table of coefficient/zero-run values on line 23, along with the modulus value for the coefficient contained in the table M, on line 24. Otherwise, when the currently considered coefficient is a zero-value coefficient, the variable “num0” is incremented, on line 28 and, when the last coefficient in the block is being considered, the variable “num0AfterFirst” may be incremented and the Boolean variable “more” is set to FALSE. The traversal variables i and j are updated on lines 35-71. Finally, on lines 74-81, the entropy-encoded values are output to a bit stream.

In alternate embodiments of the block-closet-entropy coder, the block-closet-entropy coder determines the maximum zero-run length in the block and includes that encoded value in the coded bit stream along with the number of non-zero cosets and the number of zero cosets following the first non-zero closet. This allows the block-closet-entropy encoder to provide a smaller modulus for the routine “CodeTermTree” for an entropy encoding to zero-run-length values on line 79 of the above pseudocode.

The coding process, illustrated in the above pseudocode, is reversed for the block-closet-entropy decoder, called in step 4908 in FIG. 49A. As discussed above, the decoder has access to the table M and the entropy-coder parameter k, and, in addition, includes an inverse entropy encoder that parses variable-length entropy codes and generates the integer values originally encoded by entropy coding from them.

In certain applications of distributed coding, the source frame or image may not be zero-mean. For instance, when the source is a regular image as opposed to a residual, the i.i.d. Laplacian distribution model for the dc coefficient is not appropriate. A Markov model is more suitable. Besides, there is substantial energy in the dc coefficient that takes up a significant rate to encode. In such cases, it is better to handle the dc coefficient separately. One approach would be to code the dc values predictively as in JPEG. But that may be too expensive in rate and does not exploit the side-information in any way. An approached used in embodiments of the present invention is to first compute cosets on the quantized dc value with modulus m. Next, cosets from the neighboring causal cosets are predicted using a standard predictor (like average, Martucci, etc.) but where each closet is converted to an unwrapped form in a manner such that the unwrapped predictor elements are closest to each other. Once the prediction in the unwrapped domain has been obtained using a standard predictor, cosets are predicted to obtain the final closet prediction. The prediction error is computed in a circular fashion before encoding. The decoder can duplicate the prediction and add the prediction error in a circular fashion to obtain the original cosets. Thereafter, optimal reconstruction, or decision making may be conducted based on the side-information to obtain the final reconstructed coefficient or the final decoded quantization index respectively. In addition to the predictively coded closet layer, additional channel coded layers can be transmitted similar to the AC coefficients.

Although the present invention has been described in terms of particular embodiments, it is not intended that the invention be limited to these embodiments. Modifications within the spirit of the invention will be apparent to those skilled in the art. For example, any of a large number of different memoryless-closet-based, source coding, and channel coding techniques can be used for the combined coding-technique methods that represent embodiments of the present invention. Method embodiments of the present invention can be implemented in any number of different programming languages, using an essentially limitless number of different programming parameters, such as control structures, data structures, modular organizations, variables, and other such parameters. Methods of the present invention may be implemented in software, in a combination of software and firmware, and even in firmware and hardware, depending on the hardware and computing environments in which the encoding and decoding techniques are practiced.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A system for coding images, the system comprising:
an image-receiving component that receives a next image for coding; and
an image-coding component that
transforms blocks within the image;
classifies each block as belonging to a block class;
computes coefficient statistics for each block class, codes the coefficient statistics, and outputs the coded coefficient statistics to a coded bitstream, along with a coded block-to-block-class map;
selects coding parameters for each block class;
computes S symbol planes Q₀, Q₁, . . . , Q_{S-1} by memoryless closet encoding of each block class according to the selected coding parameters for the block class;
codes each block of the Q₀ plane for each block class by a block closet entropy coder and outputs the entropy-coded blocks to the coded bitsream; and
codes symbol planes Q₁, . . . , Q_{S-1} for each block class aggregated over all blocks in the image and outputs the channel-coded symbol plane to the coded bitstream.

2. The system of claim 1 wherein the coefficient statistics include the variance of each coefficient for each block class.

3. The system of claim 1 wherein the coefficient statistics include the standard deviation of each coefficient for each block class.

4. The system of claim 1 wherein the image-coding component transforms blocks using one of a discrete cosine transform, discrete Fourier transform, and another transform that transforms the block from a spatial domain to a frequency domain.

5. The system of claim 1 wherein the image-coding component selects coding parameters for each block class by optimizing memoryless closet encoding over parameters {QP, S, m, r₁, r₂, . . . , r_{S-1}}, where QP is the quantization parameter, S is the number of symbol planes, m is the modulus used for closet generation, and r₁, r₂, . . . , r_{S-1} are the bit rates for channel coding of symbol planes Q₁, . . . , Q_{S-1}.

6. The system of claim 1 wherein the block closet entropy coder codes a block of symbol-plane coefficients by:
traversing the block in reverse-zig-zag order, computing, for each of the non-zero symbol-plane coefficients, an entropy encoding of the non-zero symbol-plane coefficient and an entropy-encoded length of a following run of zero-valued coefficients; and
outputting, to the coded bitstream,
an entropy-coding of a number of non-zero symbol-plane coefficients in the block,
an entropy coding of the number of zero-valued symbol-plane coefficients preceding the first non-zero symbol-plane coefficient in the block,
for each of the non-zero symbol-plane coefficients except for the final non-zero symbol-plane coefficient, the entropy encoding of the non-zero symbol-plane coefficient and the entropy-encoded length of a following run of zero-valued coefficients, and
for the final non-zero symbol-plane coefficient, the entropy encoding of the non-zero symbol-plane coefficient.

7. The system of claim 6 wherein entropy-coding is carried out by a prefix entropy coder, such as an exponential Golomb coder.

8. A system for decoding a coded image, the system comprising:
a coded-image receiving component that receives a coded bitstream; and
an image-decoding component that
decodes coded coefficient statistics from the coded bitstream;
decodes a coded block-to-block-class map from the coded bitstream;
selects decoding parameters for each block class;
decodes, for each block class, each coded Q₀ least significant symbol-plane block using a block closet entropy decoder from the bitstream;
decodes from the bitstream, for each block class, symbol planes Q₁, . . . , Q_{S-1} for all blocks aggregated over the image; and
for each block of the image,
reconstructs a transformed block from corresponding Q₀, Q₁, . . . , Q_{S-1} symbol-plane blocks by optimal memoryless closet encoding reconstruction, and
applies a reverse transform to the reconstructed transformed block.

9. The system of claim 8 wherein the coefficient statistics include the variance of each coefficient for each block class.

10. The system of claim 8 wherein the coefficient statistics include the standard deviation of each coefficient for each block class.

11. The system of claim 8 wherein the image-decoding component applies, to the reconstructed transformed block, one of an inverse discrete cosine transform, inverse discrete Fourier transform, and another inverse transform that transforms the block from a frequency domain to a spatial domain .

12. The system of claim 8 wherein the image-decoding component selects decoding parameters for each block class by optimizing memoryless closet encoding over parameters {QP, S, m, r₁, r₂, . . . , r_{S-1}}, where QP is the quantization parameter, S is the number of symbol planes, m is the modulus used for closet generation, and r₁, r₂, . . . , r_{S-1} are the bit rates for channel coding of symbol planes Q₁, . . . , Q_{S-1}.
